(19) United States
(12) Patent Application Publication
(10) Pub. No.: US 2024/0191698 A1
(43) Pub. Date: Jun. 13, 2024

(54) SYSTEM, DEVICE AND METHOD FOR PERFORMING MAINTENANCE OF AT LEAST PART OF AN OBJECT

(71) Applicant: LEBO ROBOTICS, INC., Tokyo (JP)

(72) Inventors: Keitaro HAMAMURA, Tokyo (JP); Masayuki MURAKAMI, Tokyo (JP); Yuichi SUGIYAMA, Tokyo (JP); Hiroki SEKI, Tokyo (JP); Hiroto KAWABATA, Tokyo (JP); Toshinobu TAKEI, Hirosaki-shi, Aomori (JP)

(73) Assignee: LEBO ROBOTICS, INC., Tokyo (JP)

(21) Appl. No.: 18/550,794

(22) PCT Filed: Mar. 18, 2022
(86) PCT No.: PCT/JP2022/012790

§ 371 Date: Sep. 15, 2023

(30) Foreign Application Priority Data
Mar. 19, 2021 (JP) 2021-046642
Apr. 26, 2021 (JP) 2021-074188
Oct. 22, 2021 (JP) 2021-173157

(51) Int. Cl. F03D 80/50; B23P 6/00

(52) U.S. Cl. CPC F03D 80/502; B23P 6/002; F05B 2230/10; F05B 2230/80

(57) ABSTRACT

This system, for performing maintenance of at least one part of an object, is provided with: at least one rope holding device which is configured to move up to said at least one part of said object and to hold at least one rope at said at least one part of said object; and a maintenance device which, configured to perform the maintenance of said at least one part of said object, is configured to move on the aforementioned at least one rope, held by the at least one rope holding device, to said at least one part of said object and to move on said at least one part of said object.

### TECHNICAL FIELD

The present invention relates to a system, device, and method for performing maintenance on at least a part of an object.

### BACKGROUND ART

A large wind power generator has a nacelle with a height of about 100 m. The peripheral speed of a wing tip of a blade of a large wind power generator is about 100 to 120 m/s, and a leading edge (front edge) of a blade, which is an edge cutting through the air, is worn away at a rate of about 20 μm per year. Further, a blade of a large wind power generator is subject to lightning damage. Thus, a blade is equipped with a lightning receiving portion (receptor) for making lightning stroke current flow to the ground as lightning resistant measures. However, when the lightning receiving portion has conduction failure due to a breakdown, the blade cannot make lightning stroke current due to lightning flow to the ground and would be seriously damaged. Therefore, a blade of a large wind power generator requires regular maintenance.

There are three representative methods for performing maintenance on a blade of an existing large wind power generator. The first method is a method in which a large crane is used to remove a blade and put it down on the ground, and then maintenance is performed. The second method is a method in which a gondola is suspended from the tip of a large crane, and a worker riding the gondola performs maintenance. The third method is a method in which a worker moves on a blade along a rope stretched over the blade and performs maintenance.

Since the first method and the second method use a large crane, said methods require much cost and labor. Especially, the first method requires enormous cost and a long construction period due to a step of removing a blade and a step of attaching the blade. The second method and the third method are dangerous because said methods require a worker to work at a high place.

Patent Literature 1 discloses a method for performing maintenance on a blade of a large wind power generator without using a large crane. The maintenance method of Patent Literature 1 still requires a worker to work at a high place.

### CITATION LIST

### Patent Literature

[PTL 1] Japanese Laid-Open Publication No. 2012-7525

### SUMMARY OF INVENTION

### Technical Problem

One of the objectives of the present invention is to provide a system, device, and method for safely and easily performing maintenance on at least a part of an object. Furthermore, one of the objectives of the present invention is to provide a system or the like for safely and easily performing maintenance on at least a part of an object even in a place where it is relatively difficult to access the object (e.g., on the sea).

### Solution to Problem

For example, the present invention provides the following items.

### (Item 1)

A system for performing maintenance on at least a part of an object, the system comprising:
at least one rope holding device configured to move to the at least a part of the object and hold at least one rope at the at least a part of the object; and
a maintenance device configured to perform maintenance on the at least a part of the object, the maintenance device being configured to move to the at least a part of the object on the at least one rope held by the at least one rope holding device and to move on the at least a part of the object.

### (Item 2)

The system of item 1, wherein the at least one rope holding device is configured to move to the at least a part of the object on the at least one rope placed on the object.

### (Item 3)

The system of item 1 or 2, wherein the at least one rope holding device is configured to hold at least two ropes at the at least a part of the object, the at least two ropes comprising a first rope group comprising at least one rope and a second rope group comprising at least one rope, and
wherein the at least one rope holding device holds the first rope group on a first side of the at least a part of the object and holds the second rope group on a second side of the at least a part of the object.

### (Item 4)

The system of item 3, wherein the at least one rope holding device is one rope holding device,
wherein the rope holding device is configured to engage with the first rope group, and
wherein the rope holding device has an aperture through which the second rope group passes.

### (Item 5)

The system of item 4, wherein the aperture is formed of a member configured to be able to transition between a first state where the second rope group is restrained in the aperture and a second state where the second rope group is released from the aperture.

### (Item 6)

The system of item 5, wherein the rope holding device further comprises a communicating means and a controlling means, and
wherein the controlling means is configured to transition the member from the first state to the second state in response to an instruction received by the communicating means.

### (Item 7)

The system of any one of items 1 to 6, wherein a weight of the rope holding device is less than a weight of the maintenance device.

### (Item 8)

The system of any one of items 1 to 7, wherein a weight of the rope holding device is less than a weight of one rope of the at least one rope.

### (Item 9)

The system of any one of items 1 to 8, wherein the object is a wind turbine, and the at least a part of the object is a blade of the wind turbine.

### (Item 10)

A method for performing maintenance on at least a part of an object, the method comprising:
moving at least one rope holding device to the at least a part of the object;
holding, by the at least one rope holding device, the at least one rope at the at least a part of the object;
connecting the at least one rope held by the at least one rope holding device to a maintenance device;
moving the maintenance device to the at least a part of the object on the at least one rope held by the at least one rope holding device;
moving the maintenance device on the at least a part of the object; and
causing the maintenance device to perform maintenance on the at least a part of the object during movement of the maintenance device on the at least a part of the object.

### (Item 11)

The method of item 10, wherein moving the at least one rope holding device to the at least a part of the object comprises:
placing the at least one rope on the object; and
moving the at least one rope holding device to the at least a part of the object on the at least one rope.

### (Item 12)

The method of item 10 or 11, wherein moving the at least one rope holding device to the at least a part of the object comprises controlling a spatial position of the at least one rope holding device.

### (Item 13)

The method of any one of items 10 to 12, wherein placing the at least one rope comprises placing at least two ropes on the object, the at least two ropes comprising a first rope group comprising at least one rope and a second rope group comprising at least one rope, and
wherein holding the at least two ropes at the at least a part of the object comprises disposing the rope holding device on the at least a part of the object so that the first rope group extends from a first side of the at least a part of the object and the second rope group extends from a second side of the at least a part of the object.

### (Item 14)

The method of item 13, wherein the at least one rope holding device is one rope holding device,
wherein the rope holding device engages with the first rope group and restrains the second rope group, and
wherein the method further comprises releasing the second rope group from the rope holding device after moving the maintenance device to the at least a part of the object.

### (Item 15)

The method of any one of items 10 to 14, wherein the object is a wind turbine, and the at least a part of the object is a blade of the wind turbine.

### (Item 16)

A maintenance device for performing maintenance on at least a part of an object, the maintenance device comprising:
a moving means for moving on the at least a part of the object;
a plurality of maintenance means configured to perform mutually different maintenances, the plurality of
maintenance means being mounted on a mounting portion; and a controlling means which selects at least one maintenance means of the plurality of maintenance means and controls the plurality of maintenance means so that maintenance by the selected at least one maintenance means is executed.

### (Item 17)

The maintenance device of item 16, wherein the mounting portion is configured to be rotatable around an axis, and
wherein the controlling means changes a position of the plurality of maintenance means by rotating the mounting portion around the axis.

### (Item 18)

The maintenance device of item 16 or 17, wherein the mounting portion is configured to be translatable in a predetermined direction, and
wherein the controlling means changes a position of the plurality of maintenance means by translating the mounting portion.

### (Item 19)

The maintenance device of any one of items 16 to 18, wherein one of the plurality of maintenance means is an applying means for applying a material.

### (Item 20)

The maintenance device of item 19, wherein one of the plurality of maintenance means is a flattening means, the flattening means comprising a spatula for flattening a material applied by the applying means and an abutting portion for abutting on the at least a part of the object to separate the spatula from the at least a part of the object.

### (Item 21)

The maintenance device of item 20, wherein the flattening means further comprises a wire net for cleaning the spatula.

### (Item 22)

The maintenance device of any one of items 19 to 21, wherein the applying means comprises a caulking gun for ejecting a material, the caulking gun being configured so that an ejected amount of the material is adjusted by intermittent control of air pressure and/or control by an electropneumatic regulator.

### (Item 23)

The maintenance device of any one of items 19 to 22, wherein the applying means is configured to stick a sheet or a film on the at least a part of the object.

### (Item 24)

The maintenance device of any one of items 16 to 23, wherein one of the plurality of maintenance means is a grinding means for grinding a surface of the at least a part of the object.

### (Item 25)

The maintenance device of item 24, wherein the grinding means comprises a leutor.

### (Item 26)

The maintenance device of item 25, wherein the leutor is configured to be pushed against the surface so that a rotational axis of the leutor is perpendicular to the surface.

### (Item 27)

The maintenance device of any one of items 24 to 26, wherein the grinding means comprises a belt sander, the belt sander being configured so that a moving direction of a grinding surface of the belt sander is inclined relative to a direction in which the surface extends and the belt sander is pushed against the surface.

### (Item 28)

The maintenance device of any one of items 16 to 27, wherein the plurality of maintenance means are configured to:
grind a surface of the at least a part of the object;
wash the grinded surface;
apply a material to the washed surface;
flatten at least a part of the applied material;
cure the flattened material;
grind the cured material;
wash the grinded material; and
paint the washed material.

For example, the present invention further provides the following items.

### (Item A1)

A system for performing maintenance on at least a part of an object, the system comprising:
at least one attaching device configured to be attached to a predetermined position on the object, wherein a part of at least one rope is fixed to the at least one attaching device, the at least one rope extending from the at least one attaching device;
at least one rope holding device configured to receive the at least one rope extending from the at least one attaching device and hold the at least one rope in any position on the at least a part of the object, the at least one rope holding device being able to move on the at least a part of the object; and
a maintenance device configured to perform maintenance on the at least a part of the object, the maintenance device being configured to move to the at least a part of the object on the at least one rope held by the at least one rope holding device and to move on the at least a part of the object.

### (Item A2)

The system of item A1, further comprising a moving means for moving the at least one attaching device and the at least one rope holding device together to the predetermined position.

### (Item A3)

The system of item A2, wherein the moving means is a device that is able to fly.

### (Item A4)

The system of any one of items A1 to 3, further comprising a controlling means for controlling a position of the at least one rope holding device on the at least a part of the object,
wherein the controlling means controls the position of the at least one rope holding device so that a spatial position of the maintenance device of when the maintenance device moves to the at least a part of the object on the at least one rope and the position of the at least one rope holding device are in concert with each other.

### (Item A5)

The system of any one of items A1 to 4, wherein a conductive wire extends inside the at least a part of the object,
wherein the at least one rope holding device can dispose a reference conductive wire approximately in parallel to the conductive wire from the at least one attaching device, and
wherein the maintenance device comprises an examining means for examining disconnection of the conductive wire,
   the examining means examining disconnection of the conductive wire by:
      supplying a pulse signal to the conductive wire and the reference conductive wire; and
      detecting a reflected waveform of the pulse signal.

### (Item A6)

The system of item A5, wherein the examining means detects a disconnected portion of the conductive wire based on the reflected waveform.

### (Item A7)

The system of any one of items A1 to 4, wherein a conductive wire extends inside the at least a part of the object,
wherein the maintenance device comprises a means for supplying a radio wave for examining disconnection of the conductive wire to the conductive wire, and
wherein the at least one rope holding device comprises a detecting means which detects a signal depending on a radio wave propagated in the conductive wire.

### (Item A8)

The system of any one of items A1 to 7, wherein the object is a wind turbine on the sea, and the at least a part of the object is a blade of the wind turbine.

### (Item A9)

The system of any one of items A1 to 8, wherein the predetermined position is a position on a narrowed portion of a blade of a wind turbine.

### (Item A10)

A system for performing maintenance on at least a part of an object, the system comprising:
at least one attaching device configured to be attached to a predetermined position on the object, wherein a part of at least one rope is fixed to the at least one attaching device, the at least one rope extending from the at least one attaching device; and
a maintenance device configured to perform maintenance on the at least a part of the object, the maintenance device being configured to move to the at least a part of the object on the at least one rope extending from the at least one attaching device and to move on the at least a part of the object.

### (Item A11)

A system for supporting maintenance on at least a part of an object, the system comprising:
at least one attaching device configured to be attached to a predetermined position on the object, wherein a part of at least one rope is fixed to the at least one attaching device, the at least one rope extending from the at least one attaching device; and
at least one rope holding device configured to receive the at least one rope extending from the at least one attaching device and hold the at least one rope in any position on the at least a part of the object, the at least one rope holding device being able to move on the at least a part of the object.

### (Item A12)

A method for performing maintenance on at least a part of an object, the method comprising:
moving at least one attaching device to a predetermined position on the object;
attaching the at least one attaching device to the predetermined position, wherein a part of at least one rope is fixed to the at least one attaching device, the at least one rope extending from the at least one attaching device to at least one rope holding device;
moving the at least one rope holding device to any position on the at least a part of the object;
holding, by the at least one rope holding device, the at least one rope in the any position on the at least a part of the object;
connecting the at least one rope held by the at least one rope holding device to a maintenance device; moving the maintenance device to the at least a part of the object on the at least one rope held by the at least one rope holding device;
moving the maintenance device on the at least a part of the object; and
performing maintenance on the at least a part of the object during movement of the maintenance device on the at least a part of the object.

### (Item A13)

The method of item A9, wherein moving the at least one attaching device comprises moving the at least one attaching device to the predetermined position along with the at least one rope holding device, and
wherein moving the at least one rope holding device comprises moving the at least one rope holding device from the predetermined position to the any position.

### (Item A14)

The method of item A12 or A13, wherein moving the maintenance device to the at least a part of the object comprises:
controlling the position of the at least one rope holding device so that a spatial position of the maintenance device of when the maintenance device moves to the at least a part of the object on the at least one rope and the position of the at least one rope holding device are in concert with each other.

### (Item A15)

The method of any one of items A12 to 14, further comprising retrieving the maintenance device from the at least a part of the object by moving the maintenance device from the at least a part of the object on the at least one rope,
wherein retrieving the maintenance device comprises:
controlling the position of the at least one rope holding device so that a spatial position of the maintenance device of when the maintenance device moves from the at least a part of the object on the at least one rope and the position of the at least one rope holding device are in concert with each other.

### (Item A16)

The method of any one of items A12 to 15, wherein a conductive wire extends inside the at least a part of the object,
wherein performing maintenance on the at least a part of the object comprises examining disconnection of the conductive wire by:
disposing a reference conductive wire approximately in parallel to the conductive wire between the at least one attaching device and the at least one rope holding device by moving the at least one rope holding device;
supplying, by the maintenance device, a pulse signal to the conductive wire and the reference conductive wire; and
detecting, by the maintenance device, a reflected waveform of the pulse signal.

### (Item A17)

The method of item A16, wherein examining disconnection of the conductive wire comprises detecting a disconnected portion of the conductive wire based on the reflected waveform.

### (Item A18)

The method of any one of items A12 to 15, wherein a conductive wire extends inside the at least a part of the object,
wherein performing maintenance on the at least a part of the object comprises:
supplying, by the maintenance device, a radio wave for examining disconnection of the conductive wire to the conductive wire; and
detecting, by the at least one rope holding device, a signal depending on a radio wave propagated in the conductive wire during movement of the at least one rope holding device on the at least a part of the object.

### (Item A19)

The method of any one of items A12 to 18, wherein the object is a wind turbine on the sea, and the at least a part of the object is a blade of the wind turbine.

### (Item A20)

The method of any one of items A12 to 19, wherein the predetermined position is a position on a narrowed portion of a blade of a wind turbine.

### Advantageous Effects of Invention

The present invention can provide a system, device, and method for safely and easily performing maintenance on at least a part of an object. The present invention can also safely and easily perform maintenance on at least a part of an object even in a place where it is relatively difficult to access the object (e.g., on the sea).

### BRIEF DESCRIPTION OF DRAWINGS

FIG. 1A A figure explaining a procedure of performing maintenance on a blade of a wind turbine.

FIG. 1B A figure explaining a procedure of performing maintenance on a blade of a wind turbine.

FIG. 1C A figure explaining a procedure of performing maintenance on a blade of a wind turbine.

FIG. 1D A figure explaining a procedure of performing maintenance on a blade of a wind turbine.

FIG. 1E A figure explaining a procedure of performing maintenance on a blade of a wind turbine.

FIG. 1F A figure explaining a procedure of performing maintenance on a blade of a wind turbine.

FIG. 1G A figure explaining a procedure of performing maintenance on a blade of a wind turbine.

FIG. 2 An enlarged view of the region indicated by a broken-line circle in FIG. 1B.

FIG. 3 A figure showing the state of a rope holding device 200 disposed on a blade 11.

FIG. 4 A figure showing a state in which the rope holding device 200 releases a rope 20₂.

FIG. 5A A figure showing one example of a configuration of a maintenance device 100′ in one embodiment.

FIG. 5B A figure showing an example of implementation of the maintenance device 100′.

FIG. 5C A figure showing one example of a configuration of the rope holding device 200.

FIG. 6 A flowchart showing one example of a procedure (procedure 600) of a method for performing maintenance on a blade of a wind turbine by using the system of the present invention.

FIG. 7 A flowchart showing one example of a procedure at step S601.

FIG. 8 A flowchart showing one example of a maintenance method of when step S606 is performed by the maintenance device 100′.

FIG. 9 A figure showing a state before a flattening means 124 comprising a spatula 1241 and an abutting portion 1242 flattens a material applied on a recessed portion on a leading edge (L.E) of the blade 11.

FIG. 10A A figure showing one example of a mounting portion 140A in one embodiment.

FIG. 10B A figure showing one example of a mounting portion 140B in one embodiment.

FIG. 10C A figure showing one example of a mounting portion 140C in one embodiment.

FIG. 10D A figure showing one example of a mounting portion 140D in one embodiment.

FIG. 10E A figure showing one example of a mounting portion 140E in one embodiment.

FIG. 11A A figure explaining a procedure of performing maintenance on a blade of a wind turbine by using the system of the present invention.

FIG. 11B A figure explaining a procedure of performing maintenance on a blade of a wind turbine by using the system of the present invention.

FIG. 11C A figure explaining a procedure of performing maintenance on a blade of a wind turbine by using the system of the present invention.

FIG. 11D A figure explaining a procedure of performing maintenance on a blade of a wind turbine by using the system of the present invention.

FIG. 11E A figure explaining a procedure of performing maintenance on a blade of a wind turbine by using the system of the present invention.

FIG. 11F A figure explaining a procedure of performing maintenance on a blade of a wind turbine by using the system of the present invention.

FIG. 11G A figure explaining a procedure of performing maintenance on a blade of a wind turbine by using the system of the present invention.

FIG. 11H A figure explaining a procedure of performing maintenance on a blade of a wind turbine by using the system of the present invention.

FIG. 11I A figure explaining a procedure of performing maintenance on a blade of a wind turbine by using the system of the present invention.

FIG. 11J A figure explaining a procedure of performing maintenance on a blade of a wind turbine by using the system of the present invention.

FIG. 11K A figure explaining a procedure of performing maintenance on a blade of a wind turbine by using the system of the present invention.

FIG. 11L A figure explaining a procedure of performing maintenance on a blade of a wind turbine by using the system of the present invention.

FIG. 11M A figure explaining a procedure of performing maintenance on a blade of a wind turbine by using the system of the present invention.

FIG. 11N A figure explaining a procedure of performing maintenance on a blade of a wind turbine by using the system of the present invention.

FIG. 11O A figure explaining a procedure of performing maintenance on a blade of a wind turbine by using the system of the present invention.

FIG. 11P A figure explaining a procedure of performing maintenance on a blade of a wind turbine by using the system of the present invention.

FIG. 11Q A figure explaining a procedure of performing maintenance on a blade of a wind turbine by using the system of the present invention.

FIG. 11R A figure explaining a procedure of performing maintenance on a blade of a wind turbine by using the system of the present invention.

FIG. 12 A figure showing an example of attaching a rope to a predetermined position on a tower 1017 of a wind turbine 1010 by using an attaching device 1300′ in an alternative embodiment.

FIG. 13 A figure schematically showing a configuration of an attaching device 1300 in one example.

FIG. 14 A figure showing a detail of the portion surrounded by a dashed-line circle in FIG. 11E.

FIG. 15 A figure showing one example of a procedure (procedure 1500) of a method for performing maintenance on a blade of a wind turbine by using the system of the present invention.

FIG. 16A A figure showing one example of a specific flow which is performed in a step of performing maintenance on a blade at step S1508.

FIG. 16B A figure showing another example of a specific flow which is performed in a step of performing maintenance on a blade at step S1508.

### DESCRIPTION OF EMBODIMENTS

The embodiments of the present invention are hereinafter explained while referring to the drawings.

As used herein, “about” means±10% of the subsequent numerical value.

### 1. Maintenance on a Blade of a Wind Turbine (First Aspect)

The first aspect of the present invention is explained below.

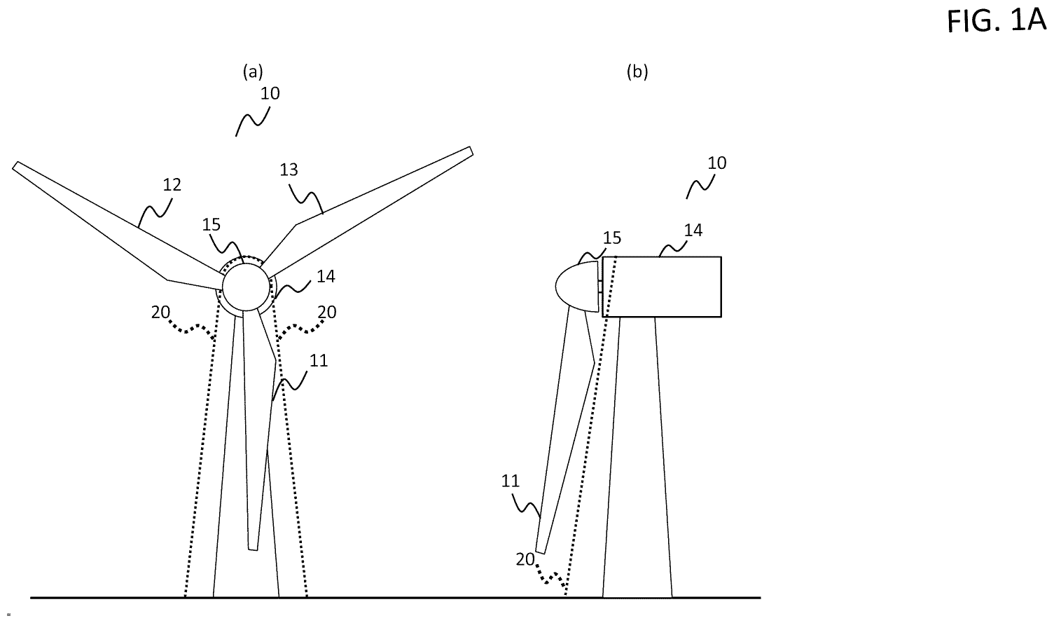

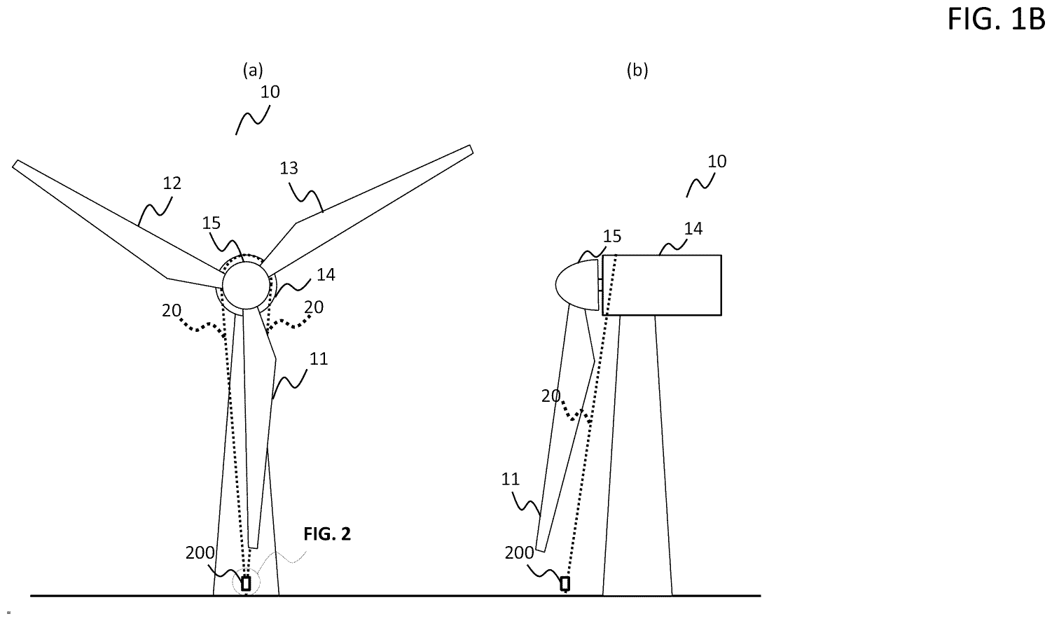

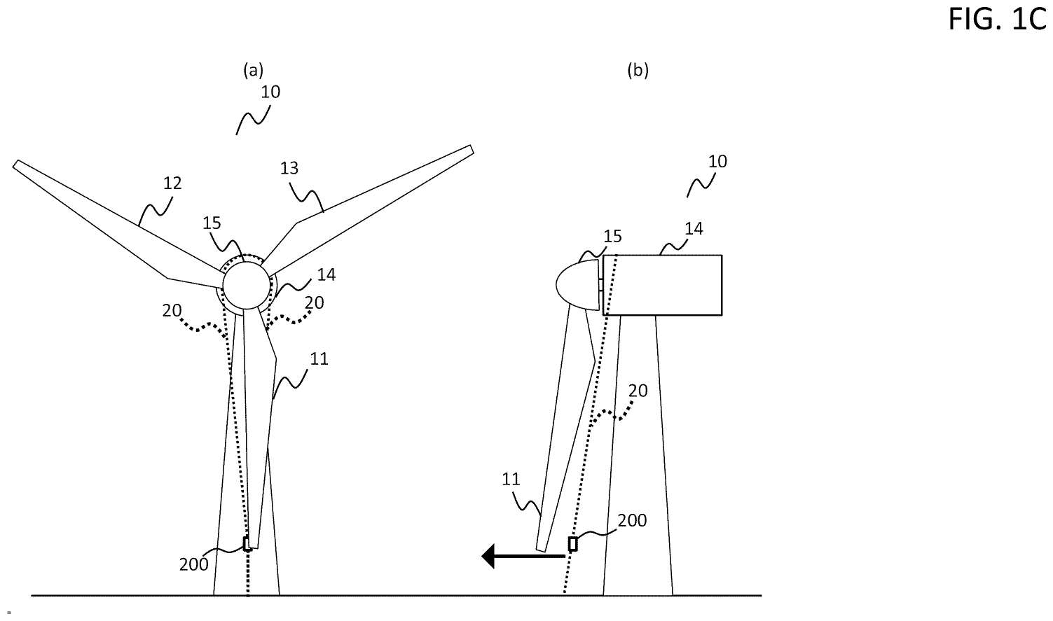

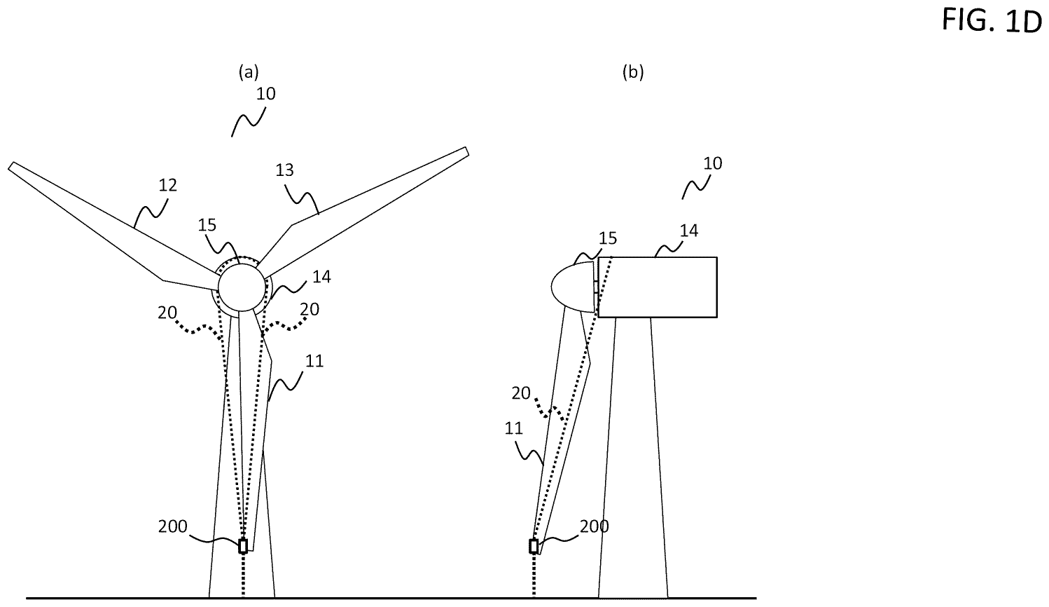

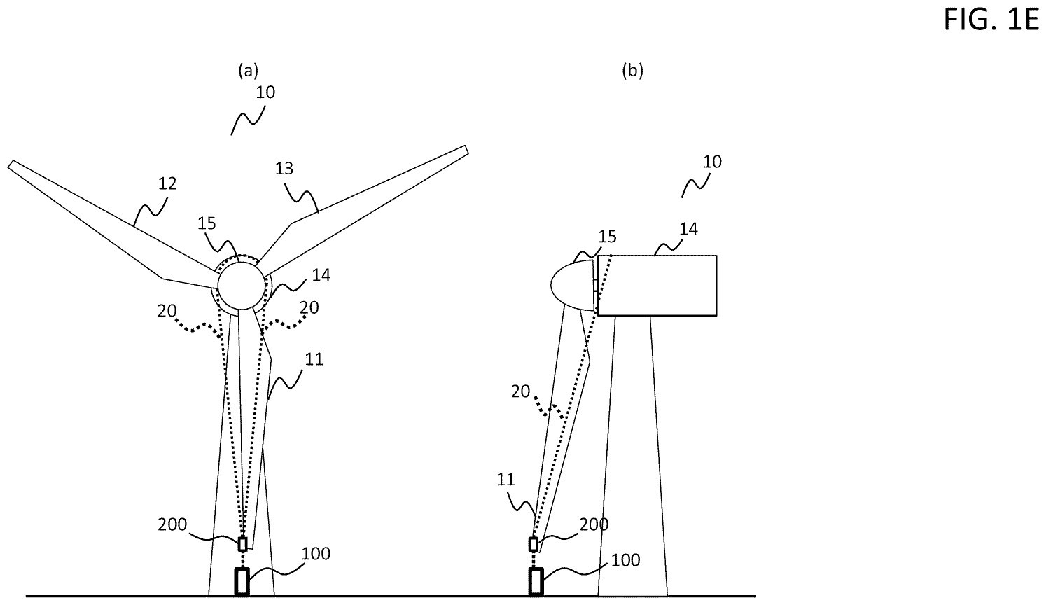

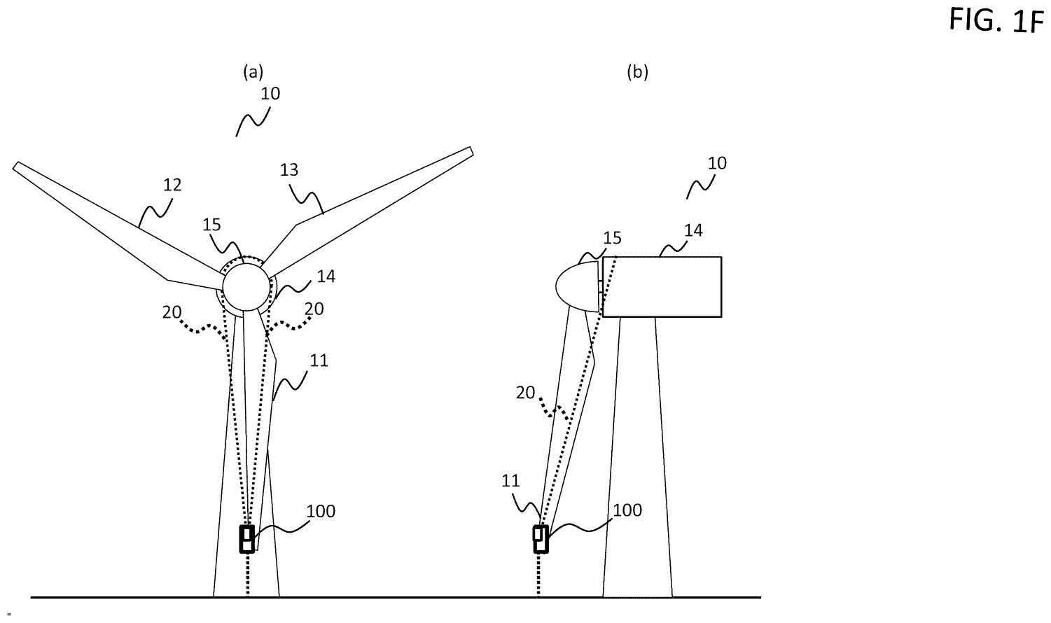

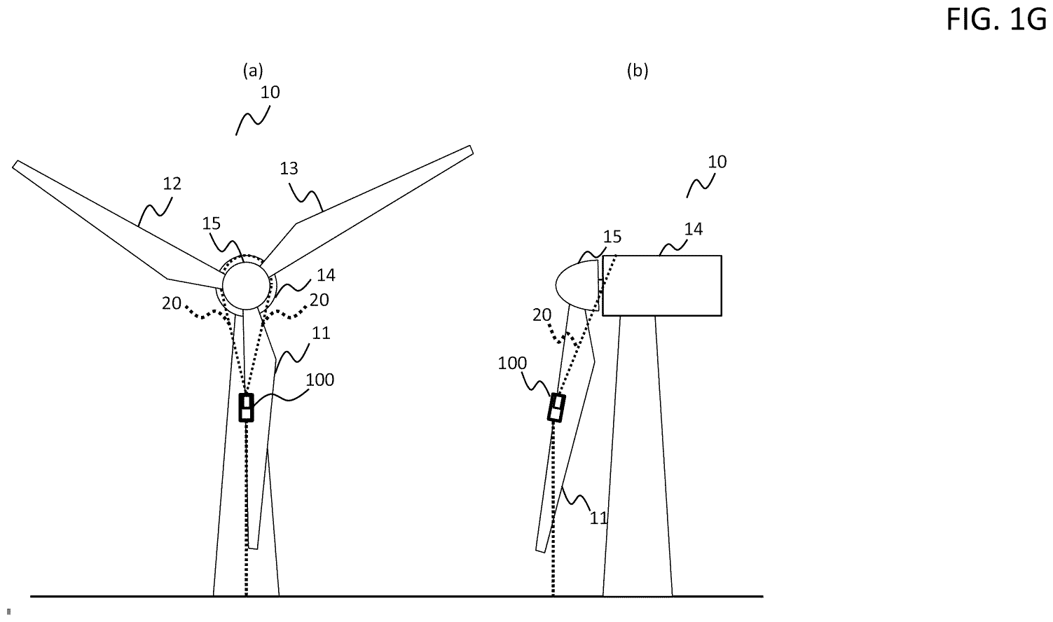

Referring to FIGS. 1A to 1G, a procedure of performing maintenance on a blade of a wind turbine by using the system of the present invention is explained. FIGS. 1A to 1G, (a) shows the front of a wind turbine 10 while FIGS. 1A to 1G, (b) shows the right side of the wind turbine 10. FIGS. 1A to 1G, (b) shows only a blade 11 that is the subject of maintenance and omits the other two blades 12 and 13. The wind turbine shown in FIGS. 1A to 1G, (a) is a wind turbine which rotates clockwise on the drawings, in which a linear edge of each blade is a leading edge (front edge).

As used herein, “wind turbine” refers to a device that obtains motive power by the wind. One example of a wind turbine is a wind power generator.

As used herein, “maintenance” refers to inspection or conservation of an object. One example of maintenance is imaging the surface of an object, examining the conduction of a lightning receiving portion of an object, washing the surface of an object, grinding and/or polishing the surface of an object, applying paint to the surface of an object, applying a material such as putty, adhesive, or sealant to the surface of an object, or the like.

The system of the present invention comprises a maintenance device 100 and a rope holding device 200.

FIG. 1A shows the state of a preparation stage before attaching the system of the present invention to the blade 11 of the wind turbine 10.

Maintenance on the blade 11 is performed while the blade 11 is positioned so that the blade 11 extends vertically downwards. Since this is the same state as the state of a blade in a conventional method in which a worker moves on a blade along a rope stretched over the blade and performs maintenance, this state is readily accepted in existing work sites. When the blade 11 is positioned so as to extend vertically downwards, the leading edge is inclined by about 5 degrees relative to the vertical direction as shown in FIG. 1A, (b).

A rope 20 is placed on the wind turbine 10 in a preparation stage before attaching the device 100 to the blade 11 of the wind turbine 10. In this regard, the rope 20 is placed on the wind turbine 10 in any manner. The rope 20 can be placed in any position on the wind turbine 10 by any approach.

In one example, the rope 20 is fixed to a nacelle 14 of the wind turbine 10. The nacelle 14 is a case housing a generator, a gear box or the like. The rope 20 can be fixed to, for example, a hatch of the nacelle 14. For example, the rope 20 can be fixed to the nacelle 14 by using a specialized fixing tool. In this case, for example, the rope 20 can be carried to the nacelle 14 of the wind turbine 10 by a device which is able to fly such as a drone.

In another example, the rope 20 is fixed to a narrow portion which is present near the base of the blade 11. For example, the rope 20 can be fixed to a narrow portion by using a specialized fixing tool. For example, the fixing tool may be configured to be fixed to a narrow portion by mechanical force, may be configured to be fixed to a narrow portion by magnetic force, or may be configured to be fixed to a narrow portion by electric power. In this case, for example, the rope 20 can be carried to the narrow portion of the blade 11 by a device which is able to fly such as a drone.

In another example, the rope 20 is hooked on the blades 12 and 13. For example, the rope 20 goes around the blades 12 and 13, and one end of the rope extends to the ground and is fixed while the other end extends to the blade 11. In this case, the rope 20 can be carried to above the blades 12 and 13 by a device which is able to fly such as a drone and hooked on the blades 12 and 13.

In another example, the rope 20 is fixed to a tower of the wind turbine 10. For example, the rope 20 can be fixed to a tower by using a specialized fixing tool. For example, the fixing tool may be configured to be fixed to a tower by mechanical force, may be configured to be fixed to a tower by magnetic force, or may be configured to be fixed to a tower by electric power. In this case, for example, the rope 20 can be carried to the top of the tower by a device which is able to fly such as a drone. Alternatively, the rope 20 can be fixed to the tower by using a robot which rises along the tower.

Hereinafter, examples where two ropes 20 are fixed to the nacelle 14 of the wind turbine 10 are explained. Each of the two ropes 20 extends from the nacelle 14 of the wind turbine 10 to the ground while passing near a hub 15. The hub 15 is a member which rotatably couples the blades 11, 12, and 13 and the nacelle 14.

FIGS. 1B to 1D show the state of a stage in which the rope holding device 200 is disposed on the blade 11 of the wind turbine 10.

The two ropes 20 extend from the nacelle 14 of the wind turbine 10 to the rope holding device 200. The rope holding device 200 can engage with one of the two ropes 20 and releasably restrain the other rope. The rope holding device 200 is able to move upwards along the rope with which the rope holding device engages.

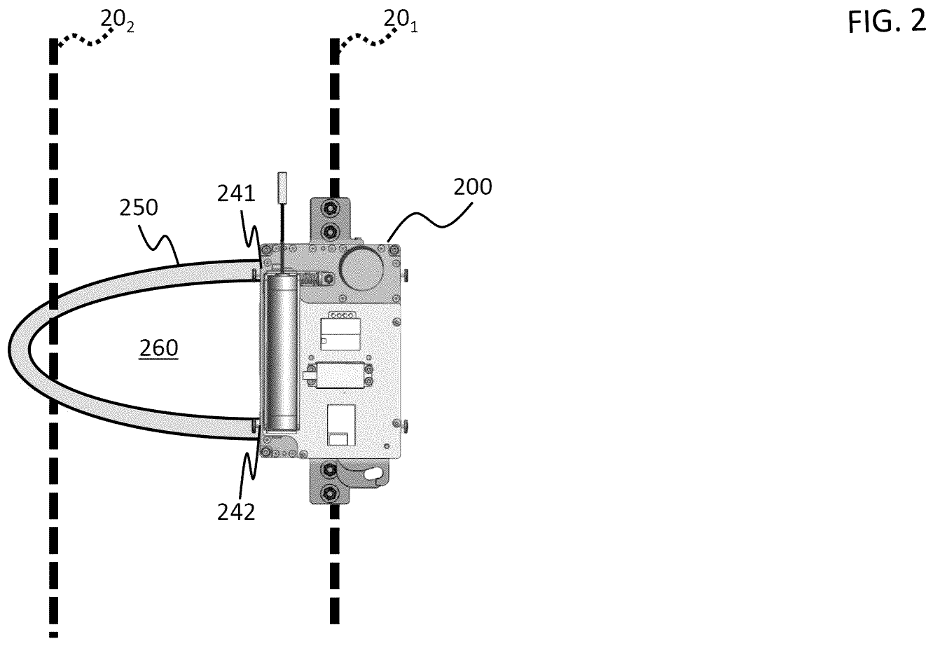

FIG. 2 is an enlarged view of the region indicated by a broken-line circle in FIG. 1B. FIG. 2 shows a state in which the rope holding device 200 engages with one rope 20₁ of the two ropes 20 and releasably restrains the other rope 20₂.

The rope 20₁ is engaged by an engaging portion (invisible) on the bottom face side of the rope holding device 200. The engaging portion engages with the rope 20₁ and applies force to the rope 20₁ in a direction in which the rope 20₁ extends, which enables the rope holding device 200 to move along the rope 20₁. This enables the rope holding device 200 to rise to near the blade 11.

The rope holding device 200 has a member 250, which extends from a first attaching portion 241 and a second attaching portion 242 of the body of the rope holding device 200, whereby an aperture 260 is formed by the body of the rope holding device 200 and the member 250. The rope 20₂ passes through the aperture 260, whereby the rope 20₂ is restrained by the body of the rope holding device 200 and the member 250. The rope holding device 200 moves to the blade 11 along the rope 20₁ while restraining the rope 20₂, which enables the rope holding device 200 to hold the two ropes 20₁ and 20₂ on the blade 11 while keeping the two ropes close to each other.

The rope holding device 200 can have a minimum configuration which can realize a function for moving on the rope 20₁ and releasably restraining the rope 20₂. This can reduce the weight of the rope holding device 200.

When the rope holding device 200 rises along the ropes 20 and reaches approximately the same height as the tip of the blade 11 as illustrated in FIG. 1C, the spatial position of the rope holding device 200 is controlled in the direction indicated by the arrow in FIG. 1C, (b). This is for disposing the rope holding device 200 on the surface of the blade 11.

The spatial position of the rope holding device 200 can be controlled by any approach. For example, the spatial position may be controlled by pulling one of the two ropes 20, the spatial position may be controlled by pulling both of the two ropes 20, or the spatial position may be controlled by connecting at least one rope different from the two ropes 20 to the rope holding device 200 and pulling the at least one rope. For example, these ropes may be configured to be pulled by a worker or a robot on the ground, may be configured to be pulled by a worker or a robot on or in the water, or may be configured to be pulled by a worker or a robot in the air. Pulling a rope by a worker or a robot on or in the water or a worker or a robot in the air is preferred when, for example, maintenance is performed on a wind turbine on the sea or along the coast.

Preferably, the spatial position of the rope holding device 200 is controlled by pulling one or both of the two ropes 20 from the ground because this can safely control the spatial position of the rope holding device 200 from the ground without requiring an additional facility.

The control of the spatial position is not limited to control via a rope. For example, the spatial position may be controlled by control via a position controlling device that the rope holding device 200 may comprise instead of the control via a rope or in addition to the control via a rope. The position controlling device can be a device capable of generating propulsive force to control the position of the rope holding device 200. For example, the position controlling device can be a propeller attached to the rope holding device 200 or a device which is able to fly such as a drone attached to the rope holding device 200.

Since the rope holding device 200 has a reduced weight as described above, the spatial position thereof can be easily controlled.

Furthermore, although it was explained in the above-described example that the spatial position of the rope holding device 200 is controlled after the rope holding device 200 reaches approximately the same height as the tip of the blade 11, the timing at which the spatial position is controlled is not limited thereto. For example, the spatial position of the rope holding device 200 may be controlled while the rope holding device 200 is being raised.

The spatial position of the rope holding device 200 is controlled, whereby the rope holding device reaches the blade 11 as shown in FIG. 1D. This enables the rope holding device 200 to be disposed on the blade 11.

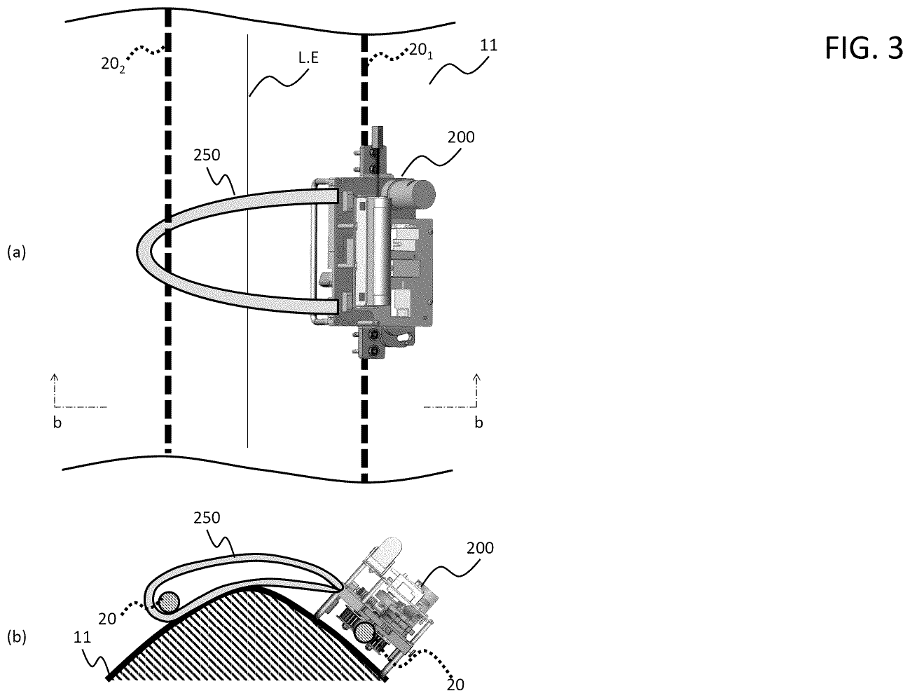

FIG. 3 shows the state of the rope holding device 200 disposed on the blade 11. FIG. 3, (a) is a figure of a leading edge (L.E) of the blade 11 viewed from right above while FIG. 3, (b) is a cross sectional view along b-b line shown in FIG. 3, (a).

Since the rope holding device 200 engages with the rope 20₁ and restrains the rope 20₂, the two ropes 20₁ and 20₂ would be held on the blade 11 by disposing the rope holding device 200 on the blade 11.

As shown in FIG. 3, the two ropes 20 are located on both sides of when the blade 11 is divided into two by the leading edge. Specifically, the rope 20₁ is located on the right side from the leading edge shown in FIG. 3, (a) while the rope 20₂ is located on the left side from the leading edge shown in FIG. 3, (a). As a result, the two ropes would extend from both sides of the blade 11.

In this case, each of the two ropes 20₁ and 20₂ extends from the nacelle 14 of the wind turbine 10 and has a significant length. Thus, each rope also has a significant weight. Since the rope holding device 200 has a reduced weight as described above, the rope holding device can be lighter than each of the ropes. Thus, the rope holding device 200 can be stably disposed on the blade 11 by the weight of the two ropes 20₁ and 20₂ located on both sides of the leading edge of the blade 11 and the friction between the rope holding device 200 and the blade 11.

FIGS. 1E to 1F show the state of a stage in which the maintenance device 100 is moved onto the blade 11 of the wind turbine 10.

The maintenance device 100 comprises a moving means for moving along the two ropes 20. For example, the moving means is a winch. For example, the maintenance device 100 comprises two winches, wherein one rope is connected to one of the two winches while the other rope is connected to the other of the two winches. For example, one end of the ropes 20 is fixed to the ground by a weight or the like. The maintenance device 100 can rise along the ropes 20 by winding the ropes 20 using a winch.

Since the ropes 20 vertically extend from the rope holding device 200 disposed on the blade 11, the maintenance device 100 can rise to the blade 11 without a need for control of the posture or spatial position thereof. Further, since the rope holding device 200 holds the two ropes in proximity to each other, the ropes along which the maintenance device 100 rises would be also in proximity to each other. This enables the maintenance device 100 to effectively utilize the two ropes 20 for rising. For example, rising along two or more ropes enables safer and more stable rising as compared to rising along one rope.

The maintenance device 100 rises along the ropes 20 to reach the blade 11 as shown in FIG. 1F. This enables the maintenance device 100 to be disposed on the blade 11.

The maintenance device 100 which has reached the blade 11 can attach to the blade 11 by any mechanism. For example, the maintenance device 100 may be configured to attach the blade 11 by mechanical force, may be configured to attach to the blade 11 by magnetic force, may be configured to attach to the blade 11 by electric power, or may be configured to attach to the blade 11 by pressure. A mechanism for attaching to the blade 11 by mechanical force can be, for example, a pair of frames that are biased to hold the blade 11 therebetween. A mechanism for attaching to the blade 11 by pressure can be, for example, a mechanism which generates negative pressure to be stuck to the blade 11.

When the maintenance device 100 reaches the blade 11, the role played by the rope holding device 200 is complete. The rope holding device 200 no longer needs to restrain the rope 20₂. Thus, the rope holding device 200 can release the rope 20₂.

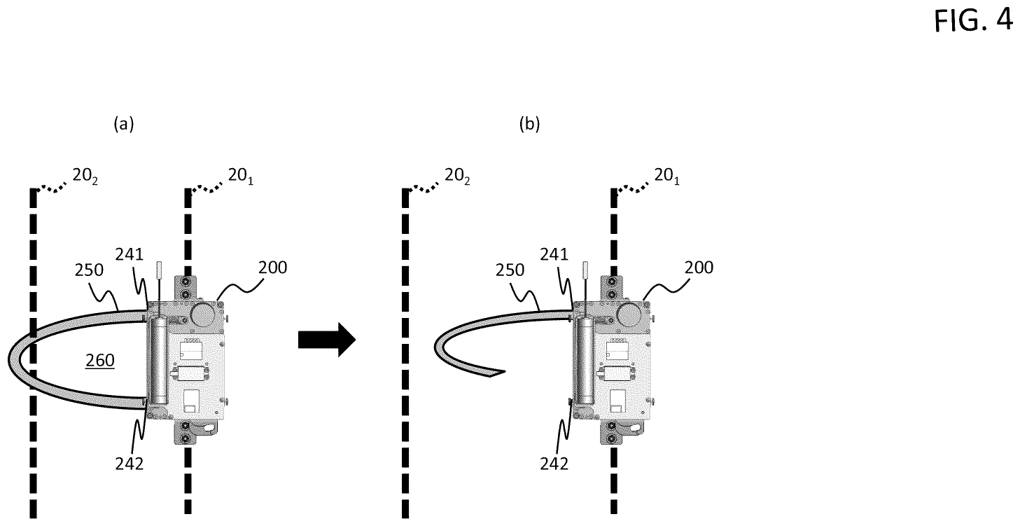

FIG. 4 shows a state in which the rope holding device 200 releases the rope 20₂.

As shown in FIG. 4, (a), the rope holding device 200 engages with the rope 20₁ and restrains the rope 20₂ in the aperture 260. The member 250 is attached to the first attaching portion 241 and the second attaching portion 242 of the body of the rope holding device 200. One end of the member 250 is fixedly attached to the first attaching portion 241 while the other end of the member 250 is releasably attached to the second attaching portion 242.

The rope holding device 200 can release the end portion of the member 250 attached to the second attaching portion 242 as shown in FIG. 4, (b), whereby the aperture 260 can be opened and the rope 20₂ can be released.

The rope holding device 200 can release the end portion of the member 250 at any timing. For example, the rope holding device 200 can release the end portion of the member 250 in response to receiving an instruction from outside. Alternatively, for example, the rope holding device 200 can release the end portion of the member 250 in response to sensing, by the maintenance device 100, an approach or a contact of the rope holding device 200.

In this manner, the member 250 can transition from a first state where the rope 20₂ is restrained to a second state where the rope 20₂ is released.

The rope holding device 200 may be configured to release the engagement with the rope 20₁ when the maintenance device 100 reaches the blade 11. Specifically, the rope holding device 200 can be put into a state in which the rope holding device 200 is still connected to the rope 20₁ but cannot exert force on the rope 20₁. This enables the rope holding device 200 to move along the rope 20₁ in accordance with the movement of the maintenance device 100 so that the movement of the maintenance device 100 is not hindered. Since the rope holding device 200 is still connected to the rope 20₁, the rope holding device 200 does not fall from the blade 11.

FIG. 1G shows a state in which the maintenance device 100 moves on the leading edge of the blade 11 along the ropes 20.

When the maintenance device 100 moves along the leading edge, the maintenance device 100 can maintain a state in which the maintenance device attaches to the blade 11, which enables the maintenance device 100 to move on the leading edge of the blade 11 without floating up. Further, since the leading edge of the blade 11 is inclined by about 5 degrees (inclined by about 1 degree to about 10 degrees in some cases) relative to the vertical direction as described above, the gravity exerted on the maintenance device 100 acts so as to push the maintenance device 100 against the leading edge of the blade 11, thereby preventing the maintenance device 100 from floating up.

The maintenance device 100 performs maintenance on the blade 11 while moving on the leading edge of the blade 11. For example, the maintenance device 100 images the surface of the leading edge by using a camera while moving on the leading edge of the blade 11. For example, the maintenance device 100 examines the conduction of a lightning receiving portion by using a probe while moving on the leading edge of the blade 11. For example, the maintenance device 100 washes the surface of the leading edge by using a washing device while moving on the leading edge of the blade 11. For example, the maintenance device 100 polishes the surface of the leading edge by using a sander while moving on the leading edge of the blade 11. For example, the maintenance device 100 applies paint to the surface of the leading edge by using a paint applying device while moving on the leading edge of the blade 11. For example, the maintenance device 100 applies a material such as putty, adhesive, or sealant to the surface of the leading edge by using an electric gun while moving on the leading edge of the blade 11. A hole made on the blade 11 can be filled with an applied material. The objective of filling a hole is to cover the hole to prevent water from entering the blade 11 and the like. Aesthetics or perfection do not need to be required.

By controlling winding and delivering by a winch, the maintenance device 100 can move on the leading edge of the blade 11 in a direction in which the ropes 20 extend, for example, in a direction from the tip of the blade toward the base of the blade and a direction from the base of the blade toward the tip of the blade. This enables the maintenance device 100 to perform maintenance while reciprocatively moving on the leading edge of the blade 11. Further, even if the maintenance device 100 comes off the blade 11, the ropes 20 to which the winch of the maintenance device 100 is connected serve as a lifeline, which can prevent the maintenance device 100 from falling down.

Although it was explained that maintenance is performed on a blade of a wind turbine by using one maintenance device 100 in the above-described examples, it is also possible to perform maintenance on a blade of a wind turbine by using a plurality of maintenance devices 100.

Although it was explained that one rope holding device 200 is used in the above-described examples, the number of rope holding devices 200 can be any number that is 1 or greater. For example, two rope holding devices 200, three rope holding devices 200, or four or more rope holding devices 200 can be used. Furthermore, although it was explained that two ropes 20 are used in the above-described examples, the present invention is not limited thereto. The present invention can perform maintenance on a blade of a wind turbine by using at least one rope.

For example, when maintenance is performed on a blade of a wind turbine by using one rope holding device 200 and one rope, the member 250 can be omitted from the above-described rope holding device 200. The rope holding device 200 and the maintenance device 200 would rise along one rope and move on the blade.

For example, when maintenance is performed on a blade of a wind turbine by using one rope holding device 200 and three or more ropes, the three or more ropes are divided into a first rope group comprising at least one rope and a second rope group comprising at least one rope. The first rope group is treated in the same manner as the above-described rope 20₁ while the second rope group is treated in the same manner as the above-described rope 20₂. For example, the rope holding device 200 engages with the first rope group, and the second rope group passes through an aperture formed by the body of the rope holding device 200 and the member 250, whereby the second rope group is restrained. Further, after the rope holding device 200 is disposed on the blade, the first rope group would extend from the first side of the blade while the second rope group would extend from the second side of the blade. The ratio of the number of ropes comprised in the first rope group and the number of ropes comprised in the second rope group can be any value.

For example, when maintenance is performed on a blade of a wind turbine by using two rope holding devices 200 and two ropes, the member 250 can be omitted in each rope holding device 200 of the two rope holding devices 200. Each rope holding device 200 would rise onto the blade along the respective one rope. For example, the two rope holding devices 200 may be configured to independently move to the blade, or may be configured to move to the blade in synchronization. The maintenance device would rise to the blade along the two ropes held by the two rope holding devices 200 and move on the blade.

For example, when maintenance is performed on a blade of a wind turbine by using one rope holding device 200 and two ropes, the one rope holding device 200 may be configured to engage with both of the two ropes. In this case, the rope holding device 200 has two engaging portions, wherein the first engaging portion engages with the first rope while the second engaging portion engages with the second rope. The first engaging portion and the second engaging portion apply force to the respective rope, which enables the rope holding device 200 to move along the ropes. For example, the two engaging portions can move on the ropes in synchronization. After moving onto the blade, the first rope may be separated from the second rope by, for example, separating the rope holding device 200 into a first portion having the first engaging portion and a second portion having the second engaging portion. Such a rope holding device 200 can be constructed as, for example, a symmetrical structure.

For example, when maintenance is performed on a blade of a wind turbine by using two rope holding devices 200 and three or more ropes, the three or more ropes are divided into a first rope group comprising at least one rope, a second rope group comprising at least one rope, and a third rope group comprising at least one rope. The first rope group is treated in the same manner as the above-described rope 20₁ while the second rope group is treated in the same manner as the above-described rope 20₂, and these rope groups are connected to a first rope holding device 200 of the two rope holding devices 200. For example, the first rope holding device 200 would engage with the first rope group and restrain the second rope group in an aperture formed by the body of the rope holding device 200 and the member 250. The third rope group is connected to a second rope holding device 200 of the two rope holding devices 200. For example, the second rope holding device 200 can engage with the third rope group. Alternatively, the third rope group may be further divided into two rope groups, wherein the second rope holding device 200 can engage with one of the rope groups resulting from the division and restrain the other of the rope groups resulting from the division. The ratio of the number of ropes comprised in the first rope group, the number of ropes comprised in the second rope group, and the number of ropes comprised in the third rope group can be any value.

For example, when maintenance is performed on a blade of a wind turbine by using three or more rope holding devices 200 and three or more ropes, the three or more ropes are divided into at least three rope groups, and each of the three or more rope holding devices 200 is connected to at least one rope group. Those skilled in the art should understand that it is possible to perform maintenance on a blade of a wind turbine by using any number of rope holding devices 200 and any number of ropes within a range expected from the scope of the present disclosure.

According to the maintenance method explained while referring to FIGS. 1A to 1G, the maintenance device 100 can be easily disposed on the blade 11. The maintenance device 100 can reach the blade 11 and land on the blade 11 only by following a rope held by the rope holding device 200. In this case, when landing on the blade 11, the posture of the maintenance device 100 does not need to be finely controlled. This is because the maintenance device 100 can be guided to a suitable landing position on the blade 11 by the rope held by the rope holding device 200. This can simplify or omit a mechanism for landing that the maintenance device 100 should have. Further, since landing is easy, manpower upon landing can be reduced. Furthermore, since it is not necessary to finely control the posture upon landing, even when the weight of the maintenance device is increased, the difficulty in landing would be less affected. Thus, it is possible to install many functions on the maintenance device to cause the maintenance device to perform many types of maintenance at once. This leads to more efficient maintenance.

According to the maintenance method explained while referring to FIGS. 1A to 1G, the maintenance device 100 can be easily moved to the blade 11. For example, when the maintenance device 100 is moved to the blade 11 without using the rope holding device 200, it is necessary to control the spatial position of the maintenance device 100 after moving the maintenance device 100 to approximately the same height as the tip of the blade 11 or while moving the maintenance device 100 to approximately the same height as the tip of the blade 11 as shown in FIG. 1B. The maintenance device 100, which is installed with various mechanisms for performing various types of maintenance, generally has a weight of about 40 to 100 kg. It is not easy to control the spatial position of such a heavy device, and a skilled technique may be required. On the other hand, the rope holding device 200 is light and the spatial position thereof is easy to control. The rope holding device 200, which is lighter than the maintenance device 100 and whose spatial position is easily controlled, is disposed on the blade 11 in advance and the maintenance device 100 is moved along a rope held by the rope holding device 200, whereby the maintenance device 100 can be easily moved to the blade 11 without a need for a skilled technique.

### 2. Configuration of a System for Performing Maintenance on a Blade of a Wind Turbine

The system for performing maintenance on a blade of a wind turbine of the present invention comprises a maintenance device 100 and a rope holding device 200. The system can comprise any number of maintenance devices 100 and any number of rope holding devices 200.

The maintenance device 100 can have any configuration as long as it is configured to perform maintenance on a blade of a wind turbine, move to the blade on a rope, and move on the blade.

The maintenance device 100 can comprise any means for performing maintenance. For example, the means for performing maintenance can comprise at least one of an imaging means, a conduction examining means, a washing means, a polishing means, a grinding means, and an applying means.

The imaging means can be any camera that is able to image a still picture or movie of an object.

The conduction examining means can be any means that is able to examine whether current flows in a conducting portion. For example, the conduction examining means comprises a probe that is able to examine whether current flows in a lightning receiving portion provided to a blade of a wind turbine.

The washing means can be any means that is able to wash an object. For example, the washing means may be a mechanism that uses washing liquid and rag to wipe off dirt. When such a mechanism is used to wash the blade 11 of the wind turbine 10 while moving on the blade 11 of the wind turbine 10 as shown in FIG. 1G, washing is performed by the maintenance device 100 moving on the blade while pushing the rag against the blade.

The polishing means can be any means that is able to polish an object. For example, the polishing means may be a mechanism that uses a sandpaper, a grinder, a disk grinder or the like to perform polishing. When a sandpaper, a grinder, or a disk grinder is used to polish the blade 11 of the wind turbine 10 while moving on the blade 11 of the wind turbine 10 as shown in FIG. 1G, polishing is performed by the maintenance device 100 moving on the blade while pushing the sandpaper or rotating grinder against the blade.

The grinding means can be any means that is able to grind an object. For example, the grinding means may be a mechanism that uses a leutor (or hand grinder or precision grinder), a belt sander or the like to perform grinding. For example, the grinding means can grind the surface of the blade 11 by pushing a leutor or belt sander against the blade 11 of the wind turbine 10.

The applying means can be any means that is able to apply a material to an object. Examples of the material applied by the applying means include paint, putty, adhesive, and sealant. For example, the applying means may be a spraying device that is able to spray paint. When such a spraying device is used to apply paint to the blade 11 of the wind turbine 10 while moving on the blade 11 of the wind turbine 10 as shown in FIG. 1G, the paint is applied by the maintenance device 100 moving on the blade while spraying the paint from the spraying device. For example, the applying means may be a caulking gun that is able to extrude putty, adhesive, sealant, or the like. When such a caulking gun is used to apply a material such as putty, adhesive, or sealant to the blade 11 of the wind turbine 10 while moving on the blade 11 of the wind turbine 10 as shown in FIG. 1G, the material is applied by identifying a portion to which the material should be applied with the imaging means or the like in advance, moving the maintenance device 100 on the blade 11, and extruding the material when the maintenance device reaches the portion to which the material should be applied.

It should be noted that the means for performing maintenance are not limited to the imaging means, the conduction examining means, the washing means, the polishing means, the grinding means, and the applying means. The maintenance device 100 may comprise another means for performing maintenance instead of or in addition to the above-described means.

For example, the maintenance device 100 can comprise a communicating means. It is thereby possible to receive a signal from the outside of the maintenance device 100 and transmit a signal to the outside of the maintenance device 100. The communication means may receive a signal from the outside of the maintenance device 100 wirelessly or by wire. The communication means may transmit a signal to the outside of the maintenance device 100 wirelessly or by wire. For example, the communicating means can receive a signal for controlling each action of the maintenance device 100 from the outside of the maintenance device 100 (e.g., a terminal for operation used by an operator). For example, the communicating means can transmit image data obtained by the imaging means to the outside of the maintenance device 100 (e.g., a terminal for operation used by an operator).

Although it was explained that each action of the maintenance device 100 is controlled in accordance with a signal from the outside of the maintenance device 100, the present invention is not limited thereto. For example, a program for realizing a series of actions for performing maintenance on a blade may be stored in a memory of the maintenance device 100. A processor of the maintenance device 100 can read out and execute the program to cause the maintenance device 100 to function as a device automatically performing maintenance on a blade.

The maintenance device 100 comprises a moving means that enables the maintenance device 100 to move along a rope. The moving means also enables the maintenance device 100 to move on a blade. For example, the moving means comprises a winch that enables the maintenance device 100 to move along a rope. For example, the moving means comprises a wheel that enables the maintenance device 100 to move on a blade. While the wheel can be a non-driving wheel, the wheel may be a driving wheel driven by a power source. For example, the maintenance device 100 may be configured to move on a blade by using a winch and a non-driving wheel, or may be configured to move on a blade by using a driving wheel without utilizing a winch (and a rope).

Although an example in which the maintenance device 100 can comprise a means for performing maintenance, a communicating means, a memory, a processor, and a moving means was explained in the above-described examples, the present invention is not limited thereto. A system in which at least one of the components of the maintenance device 100 is positioned outside the body of the maintenance device 100 is also within the scope of the present invention. For example, the nacelle 14 of a wind turbine may comprise a winch instead of the maintenance device 100 comprising a winch. In this case, the maintenance device 100 may be configured so that a rope extending from the winch of the nacelle 14 of the wind turbine is fixed to the maintenance device 100 and the winch of the nacelle 14 of the wind turbine winds or delivers the rope, whereby the maintenance device 100 moves to the blade 11 or on the blade 11.

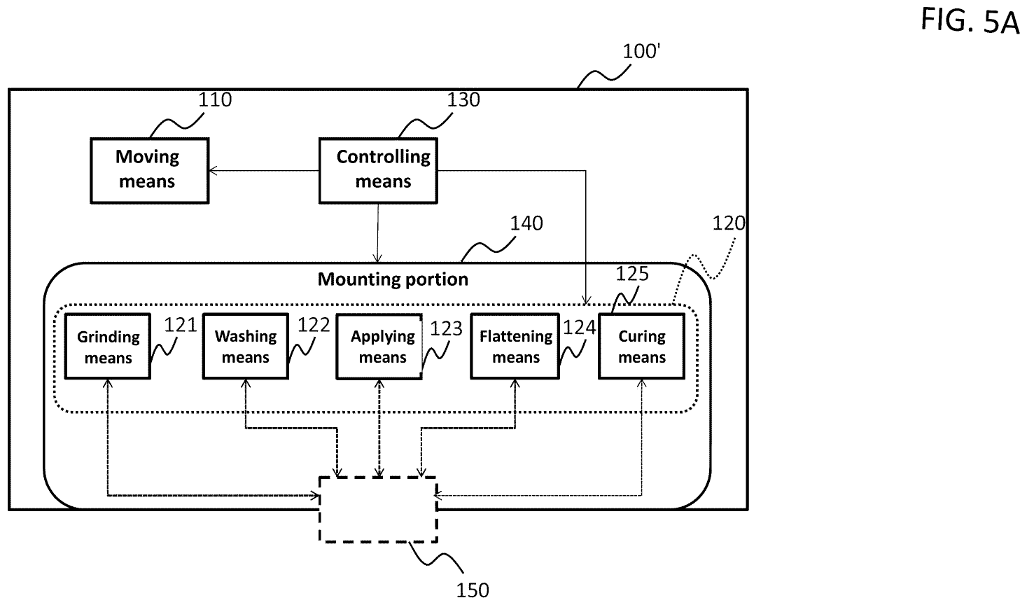

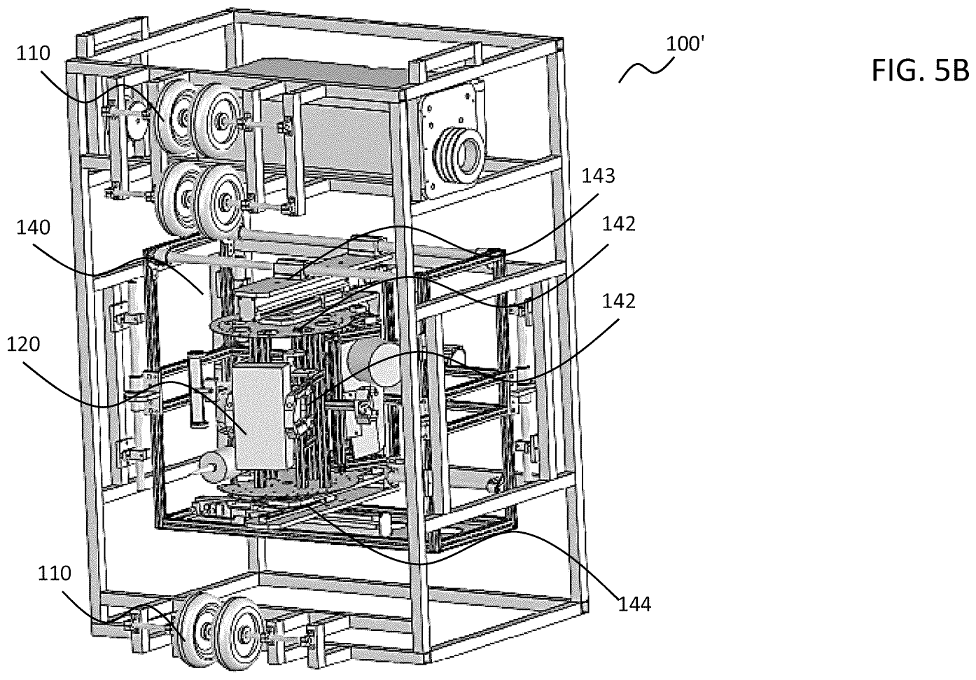

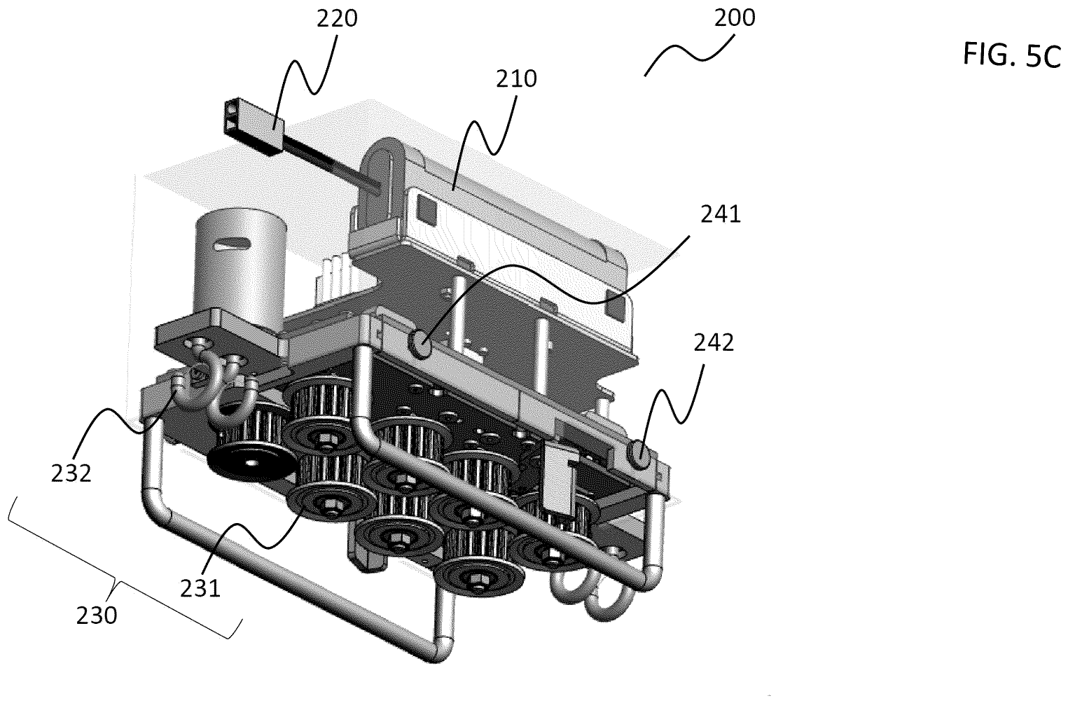

FIG. 5A shows one example of a configuration of a maintenance device 100′, which is an alternative embodiment of the maintenance device 100.

The maintenance device 100′ comprises a moving means 110, a plurality of maintenance means 120, and a controlling means 130. The plurality of maintenance means 120 are mounted on a mounting portion 140.

The moving means 110 is configured to enable the maintenance device 100′ to move on a blade of a wind turbine. For example, the moving means 110 comprises a winch that enables the maintenance device 100′ to move along a rope placed on a wind turbine. For example, the maintenance device 100′ can also move to a blade of a wind turbine by utilizing a rope and a winch placed on the wind turbine. For example, the moving means 110 comprises a wheel that enables the maintenance device 100′ to move on a blade. While the wheel can be a non-driving wheel, the wheel may be a driving wheel driven by a power source. For example, the maintenance device 100′ may be configured to move on a blade by using a winch and a non-driving wheel, or may be configured to move on a blade by using a driving wheel without utilizing a winch (and a rope).

For example, the rope may pass through the winch or may not pass through the winch. When the rope passes through the winch, for example, the rope would extend from the wind turbine to the maintenance device 100′, and from the maintenance device 100′ to the ground. When the rope does not pass through the winch, the rope enters from one end of the winch but does not exit from the other end, and the rope does not extend between the maintenance device 100′ and the ground. For example, the maintenance device 100′ can move to a direction toward the wind turbine by the winch winding a rope extending from the wind turbine to the maintenance device 100′, and the maintenance device can move to a direction away from the wind turbine by the winch delivering a rope extending from the wind turbine to the maintenance device 100′.

Furthermore, the moving means 110 is not limited to a winch or wheel described above. The maintenance device 100′ may comprise another means that enables the maintenance device 100′ to move on an object as the moving means 110 instead of or in addition to the above-described means.

The plurality of maintenance means 120 are configured to perform mutually different maintenances. For example, the plurality of maintenance means 120 comprise a grinding means 121, a washing means 122, an applying means 123, a flattening means 124, and a curing means 125.

The grinding means 121 can be any means that is able to grind an object. The grinding means 121 is configured to grind the surface of a blade of a wind turbine. For example, the grinding means 121 can be a mechanism that uses a leutor (or hand grinder or precision grinder), a belt sander or the like to perform grinding. A leutor can grind an object by, for example, rotating a grinding body at a high speed and pushing the grinding body rotating at a high speed against the object. For example, the grinding body can be a spherical or ellipse body. The grinding body has a rotational axis. The portion farthest from the rotational axis (e.g., equator portion) has the greatest rotation speed and the highest grinding ability. A belt sander can grind an object by causing a ring-shaped sanding belt with a grinding surface to rotate and move around a plurality of rollers and pushing the rotating and moving grinding surface against the object. The position on the object which is grinded by the grinding means 121 can be adjusted by, for example, moving the grinding means 121 up and down, from side to side, and back and forward by a translation mechanism described below which the mounting portion 140 can comprise.

In one example, the grinding means 121 comprises a leutor. For example, a rotating grinding body is moved along the surface of an object while being pushed against the surface of the object, thereby enabling a leutor to grind a desired range on the surface of the object. A leutor is configured to be pushed against the surface of an object so that the rotational axis of the grinding body of the leutor is perpendicular to the surface of the object, so that the rotational axis of the grinding body of the leutor is inclined relative to the surface of the object, or so that the rotational axis of the grinding body of the leutor is parallel to the surface of the object. Preferably, a leutor can be configured to be pushed against the surface of an object so that the rotational axis of the grinding body of the leutor is perpendicular to the surface of an object. For example, a leutor can be placed on the maintenance device 100′ so that the rotational axis of the grinding body is perpendicular to the surface of an object, or a leutor can be controlled so that the rotational axis of the grinding body is perpendicular to the surface of an object. For example, the rotational axis of the grinding body can be perpendicular to the surface of a leading edge of a blade. Grinding by a leutor can be controlled by, for example, adjusting force with which the leutor is pushed against the surface of an object or a relative position of the leutor and the surface of an object.

For example, a dust-proof covering can be attached around a grinding body of a leutor. This can prevent powder or dust generated from grinding by the leutor from spreading.

In one example, the grinding means 121 comprises a belt sander. For example, a rotating and moving grinding surface is moved along the surface of an object while being pushed against the object, thereby enabling a belt sander to grind a desired range on the surface of the object. A belt sander is configured so that a moving direction of a grinding surface of the belt sander is inclined relative to a direction in which the surface of an object extends and the belt sander is pushed against the surface of the object. For example, a belt sander can be placed on the maintenance device 100′ so that a moving direction of a grinding surface of the belt sander is inclined relative to a direction in which the surface of an object extends, or a belt sander can be controlled so that a moving direction of a grinding surface of the belt sander is inclined relative to a direction in which the surface of an object extends. For example, a moving direction of a grinding surface of a belt sander can be inclined relative to a direction in which a leading edge of a blade extends. This can release the grinding force of the belt sander well and prevent excessive grinding by the belt sander. Grinding by a belt sander can be controlled by, for example, adjusting force with which the belt sander is pushed against the surface of an object or a relative position of the belt sander and the surface of an object.

The washing means 122 can be any means that is able to wash an object. The washing means 122 is configured to wash the surface of a blade of a wind turbine. For example, the washing means 122 can wash the surface of a blade grinded by the grinding means 121. Alternatively, for example, the washing means 122 can wash the surface of an applied material (e.g., putty) grinded by the grinding means 121. For example, the washing means 122 may be a mechanism that uses washing liquid and rag to wipe off dirt, or may be a mechanism that uses an ion spraying mechanism to remove static electricity. The position on an object which is washed by the washing means 122 can be adjusted by, for example, moving the washing means 122 up and down, from side to side, and back and forward by a translation mechanism described below which the mounting portion 140 can comprise.

In one example, the washing means 122 can comprise, for example: rag; and a washing liquid feeding mechanism for feeding washing liquid to the rag. As a result, the washing liquid feeding mechanism feeds the washing liquid to the rag and the rag fed with the washing liquid moves on an object, whereby the object can be washed.

Washing liquid can be any liquid with detergency. Washing liquid is preferably an organic solvent, and more preferably thinner. This can remove oil (e.g., insects or the like that collided with a blade) and powder (e.g., powder generated from grinding) on a blade.

A washing liquid feeding mechanism can be any mechanism as long as it can feed washing liquid. Preferably, a washing liquid feeding mechanism can be a mechanism that prevents volatilization of volatile washing liquid. More preferably, a washing liquid feeding mechanism can be a mechanism that is able to feed an adjusted amount of washing liquid. For example, a washing liquid feeding mechanism can have a ball-type nozzle as used for a nozzle for supplying water to a pet. A ball-type nozzle makes it possible to feed washing liquid by a small amount while preventing volatilization of the washing liquid.

The applying means 123 can be any means that is able to apply a material to an object. The applying means 123 is configured to apply a material to the surface of a blade of a wind turbine. For example, the applying means 123 can apply a material to the surface of a blade grinded by the grinding means 121 and washed by the washing means 122. For example, the applying means 123 can further apply a material (e.g., paint) to a material (e.g., putty) applied by the applying material 123. Examples of the material applied by the applying means 123 include paint, putty, adhesive, and sealant. For example, the applying means 123 may be a spraying device that is able to spray paint. For example, the applying means may be a caulking gun that is able to eject putty, adhesive, sealant or the like. The position on an object to which a material is applied by the applying means 123 can be adjusted by, for example, moving the applying means 123 up and down, from side to side, and back and forward by a translation mechanism described below which the mounting portion 140 can comprise.

For example, the applying means 123 can be configured to eject an amount of material to be ejected which is pre-estimated based on the shape of a portion to which the material should be applied, for example, a recessed shape grinded by the grinding means 121. The amount of material to be ejected can be pre-estimated by, for example, the controlling means 130.

In one example, the applying means 123 comprises a caulking gun for ejecting a material. Ejection of a material by a caulking gun can be controlled by, for example, air pressure. In this case, ejection of the material is preferably adjusted by intermittent control of air pressure. This is because it is possible to precisely control the amount of ejected material by utilizing intermittent control of air pressure even when ejection of the material is remotely controlled. Alternatively, ejection of the material is preferably adjusted by control by an electropneumatic regulator in addition to intermittent control of air pressure or instead of intermittent control of air pressure. This is because it is possible to precisely control the amount of ejected material by utilizing control by an electropneumatic regulator even when ejection of the material is remotely controlled.

The applying means 123 can comprise a mechanism that applies paint in addition to the above-described mechanism that ejects a material or instead of the mechanism that ejects a material. For example, the applying means 123 can apply paint by using a roller. In this case, a wheel as the moving means 110 may be utilized as the roller, in other words, the roller may be used by both the moving means 110 and the applying means 123, or a different roller from the wheel as the moving means 110 may be utilized. For example, the applying means 123 can be configured to stick a paint sheet or a paint film on a part of an object in order to apply paint. A paint sheet is a sheet that retains certain amount of liquid or gel paint while a paint film is a film that retains certain amount of liquid or gel paint. Sheets and films are classified by, for example, their thickness. Those having a thickness less than a predetermined thickness (e.g., about 0.25 mm as specified by JIS) can be classified as films while those having a thickness of or greater than the predetermined thickness can be classified as sheets. Certain amount of paint can be applied by sticking a paint sheet and then peeling off the sheet. This can prevent excessive application of paint.

The flattening means 124 can be any means that is able to flatten a material. The flattening means 124 can be configured to flatten a material applied by the applying means 123. For example, the flattening means 124 can comprise a spatula. For example, the spatula can have a tip with an acute angle. It is possible to level a material by bringing a spatula into contact with the material and moving the spatula on the material. The position on a material which is flattened by the flattening material 124 can be adjusted by, for example, moving the flattening means 124 up and down, from side to side, and back and forward by a translation mechanism described below which the mounting portion 140 can comprise.

For flattening of a material by the flattening means 124, it is ideal to flatten the material so that the material would be flush with the surface of a blade. However, moving the flattening means 124 so that the material would be flush with the surface of a blade requires precise control by a translation mechanism. In addition, there is a risk that the flattening means 124 comes into contact with the blade. Thus, in one example, the flattening means 124 can intentionally flatten a material so that the material would not be flush with the surface of a blade. To this end, the flattening means 124 can further comprise a means for separating the spatula of the flattening means 124 from the surface of the blade.

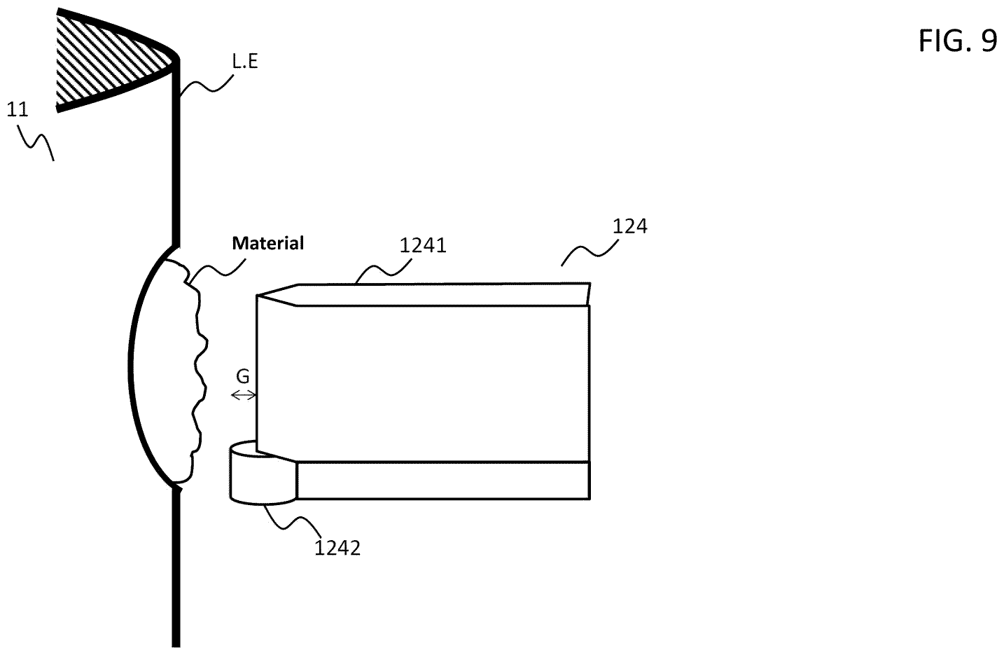

For example, the flattening means 124 can comprise a spatula 1241 and an abutting portion 1242 for separating the spatula from a blade as shown in FIG. 9.

FIG. 9 shows a state before the flattening means 124, which comprises the spatula 1241 and the abutting portion 1242, flattens a material applied to a recessed portion on a leading edge (L.E) of the blade 11. The abutting portion 1242 is disposed to abut on the blade 11 to separate the spatula 1241 from the blade. In other words, the abutting portion 1242 is disposed to project from the tip of the spatula 1241 by a distance G. This enables the abutting portion 1242 to abut on the blade 11, whereby a gap with a size G is formed between the spatula 1241 and the blade 11. The spatula 1241 flattens the material in a state in which the abutting portion 1242 abuts on the blade 11, whereby the material would be flattened in a state in which the material rises by the gap. In this case, control of the movement of the flattening means 124 does not require precise control and there is no risk that the flattening means 124 comes into contact with the blade. For example, the material flattened in a rising state can be grinded by the grinding means 121 (e.g., belt sander) until the material becomes flush with the surface of the blade.

In one example, the flattening means 124 further comprises a means for cleaning a spatula. A material remaining after the flattening operation can be removed by cleaning a spatula. This is preferable in that it is possible to prevent a material used for maintenance on a certain portion from being mixed into a material for use in maintenance on another portion. This is because since a material can be applied by the applying means 123 only at an amount which is estimated based on the shape of a portion to which the material should be applied, if a material used for maintenance on a certain portion is mixed into a material for use in maintenance on another portion, there would be a surplus of material and it is likely that suitable maintenance cannot be performed.

For example, a means for cleaning a spatula can be a wire net. If a spatula with a material adhered thereto is rubbed against a first side of a wire net, the material adhered to the spatula passes through the holes of the wire net to move to a second side opposite to the first side. The material that has moved to the second side of the wire net falls in the gravity direction due to the viscosity of the material and the gravity and does not return to the first side of the wire net. In this manner, being able to remove the material adhered to the spatula only by rubbing the spatula against the wire net is an effect that is unexpectedly obtained.

Preferably, each hole of a wire net can be a hole with a surface area of about 5 mm² to about 25 mm², and more preferably, each hole of a wire net can be a hole with a surface area of about 10 mm². In this case, the viscosity of a material can be about 35,000 mPa·s to about 45,000 mPa·s at a room temperature of 25° C., and can be preferably about 40,000 mPa·s. The shape of each hole of a wire net can be any shape, but can be preferably a rhombus shape.

Referring to FIG. 5A again, the curing means 125 can be any means that is able to cure a curable material. The curing means 125 can be configured to cure a material applied by the applying means 123 and/or a material flattened by the flattening means 124. For example, the curing means 125 can be a light source for curing a photocurable material. For example, the light source can be a UV light source. The position on a material which is cured by the curing means 125 can be adjusted by, for example, moving the curing means 125 up and down, from side to side, and back and forward by a translation mechanism described below which the mounting portion 140 can comprise.

Each of the plurality of maintenance means 120 described above can have a distance measuring function. It is thereby possible to control a relative distance between each maintenance means 120 and an object based on the measured distance from the object to perform suitable maintenance on the object. For example, a distance measuring function can be achieved by a contact sensor. For example, a distance between each maintenance means 120 and an object can be recognized by grasping space based on the position in which a contact sensor comes into contact with the object.

In a preferred example, one of the plurality of maintenance means 120 is the applying means 123. It is thereby possible to apply a material to a site requiring maintenance as maintenance. In a more preferred example, one of the plurality of maintenance means 120 is the grinding means 121 while another one is the applying means 123. It is thereby possible to grind a site requiring maintenance and apply a material to the grinded portion as maintenance. In a further preferred example, one of the plurality of maintenance means 120 is the grinding means 121, another one is the washing means 122, and yet another one is the applying means 123. It is thereby possible to grind a site requiring maintenance, wash the grinded portion, and then apply a material thereto as maintenance. In a further preferred example, one of the plurality of maintenance means 120 is the grinding means 121, another one is the washing means 122, yet another one is the applying means 123, and yet another one is the flattening means 124. It is thereby possible to grind a site requiring maintenance, wash the grinded portion, apply a material thereto, flatten the applied material, and perform further grinding, washing, and application for the flattened material as maintenance.

Note that the plurality of maintenance means 120 are not limited to the above-described means. The maintenance device 100 may be configured to comprise other means for performing maintenance instead of the above-described means or in addition to the above-described means.

The controlling means 130 controls the overall action of the maintenance device 100′. For example, the controlling means 130 can control the action of the plurality of maintenance means 120. Each action for performing maintenance on an object is thereby executed. For example, the controlling means 130 can select at least one maintenance means of the plurality of maintenance means 120 as a maintenance performing means 150. For example, the controlling means 130 can select at least one maintenance means as the maintenance performing means 150 based on the current position of the maintenance device 100′, the maintenance that the maintenance device 100′ already performed, the state of an object, or the like. The controlling means 130 can control the plurality of maintenance means 120 so that maintenance by the at least one maintenance means selected would be executed.

The controlling means 130 can control the action of the mounting portion 140. For example, the controlling means 130 can rotate the mounting portion 140 by controlling a rotation mechanism that the mounting portion 140 can comprise. This can change the position of the plurality of maintenance means 120 mounted on the mounting portion 140. For example, the controlling means 130 can translate the mounting portion 140 by controlling a translation mechanism that the mounting portion 140 can comprise. This can change the position of the plurality of maintenance means mounted on the mounting portion 140. Rotation and/or translation of the mounting portion 140 can be executed before, while, or after at least one maintenance means selected by the controlling means as the maintenance performing means 150 performs maintenance.

For example, the controlling means 130 can control the action of the moving means 110. This can move the maintenance device 100′ on a blade of a wind turbine.

The controlling means 130 can control the action of the moving means 110, the plurality of maintenance means 120, and/or the mounting portion 140 in accordance with a control signal received by a communicating means that the maintenance device 100′ can comprise. Alternatively, the controlling means 130 can read out a program stored in a memory that the maintenance device 100′ can comprise and control the action of the moving means 110, the plurality of maintenance means 120, and/or the mounting portion 140 in accordance with the program. In other words, the maintenance device 100′ may be a remotely controlled device or may be an autonomously operating device.

The controlling means 130 can be implemented by one or more processors.

The mounting portion 140 is mounted with the plurality of maintenance means 120 so that at least one maintenance means of the plurality of maintenance means 120 is selected and maintenance can be performed on at least a part of an object by using the at least one maintenance means selected. For example, the mounting portion 140 is mounted with the grinding means 121, the washing means 122, the applying means 123, the flattening means 124, and the curing means 125, the controlling means 130 selects at least one means of the grinding means 121, the washing means 122, the applying means 123, the flattening means 124, and the curing means 125 as the maintenance performing means 150, and the selected means executes maintenance.

For example, first, the controlling means 130 selects the grinding means 121 as the maintenance performing means 150 and controls the grinding means 121 so that grinding of a site requiring maintenance by the grinding means 121 is executed. This can be performed after the controlling means 130 controls the mounting portion 140 to change the position of the grinding means 121 so that maintenance by the grinding means 121 can be executed. Next, the controlling means 130 selects the washing means 122 as the maintenance performing means 150 and controls the washing means 122 so that washing of a site requiring maintenance by the washing means 122 is executed. This can be performed after the controlling means 130 controls the mounting portion 140 to change the position of the washing means 122 so that maintenance by the washing means 122 can be executed. Next, the controlling means 130 selects the applying means 123 as the maintenance performing means 150 and controls the applying means 123 so that application of a material to a site requiring maintenance by the applying means 123 is executed. This can be performed after the controlling means 130 controls the mounting portion 140 to change the position of the applying means 123 so that maintenance by the applying means 123 can be executed. Next, the controlling means 130 selects the flattening means 124 as the maintenance performing means 150 and controls the flattening means 124 so that flattening of a material at a site requiring maintenance by the flattening means 124 is executed. This can be performed after the controlling means 130 controls the mounting portion 140 to change the position of the flattening means 124 so that maintenance by the flattening means 124 can be executed. Next, the controlling means 130 selects the curing means 125 as the maintenance performing means 150 and controls the curing means 125 so that curing of a material at a site requiring maintenance by the curing means 125 is executed. This can be performed after the controlling means 130 controls the mounting portion 140 to change the position of the curing means 125 so that maintenance by the curing means 125 can be executed. In this manner, a means for maintenance to be performed is selected from the plurality of maintenance means 120 mounted on the mounting portion 140 as the maintenance performing means 150, and the selected means would perform maintenance. The plurality of maintenance means 120 are collectively mounted on the mounting portion 140, whereby the size of the maintenance device 100′ can be reduced.

For example, the mounting portion 140 can comprise a mounting body and an attaching portion on the mounting body to which a plurality of maintenance means are attached. The mounting portion 140 can further comprise a translation mechanism which translates the mounting body. The translation mechanism translates the mounting body in a predetermined direction, e.g., moves the mounting body up and down, from side to side, and/or back and forward, whereby the plurality of maintenance means attached to the mounting body would be also moved in the predetermined direction, e.g., up and down, from side to side, and/or back and forward. This can change the position of the plurality of maintenance means. The position of the plurality of maintenance means is changed by the translation mechanism, which enables the plurality of maintenance means to perform maintenance on a blade in a suitable position. Further, since the position of the plurality of maintenance means mounted on the mounting portion 140 can be changed by the translation mechanism at a single time, it is not necessary to provide a mechanism which controls a position to each of the plurality of maintenance means. This further promotes reduction in size of the maintenance device 100′.

The maintenance device 100′ may be configured to further comprise at least one of the above-described features of the maintenance device 100.

### (Revolver Form)

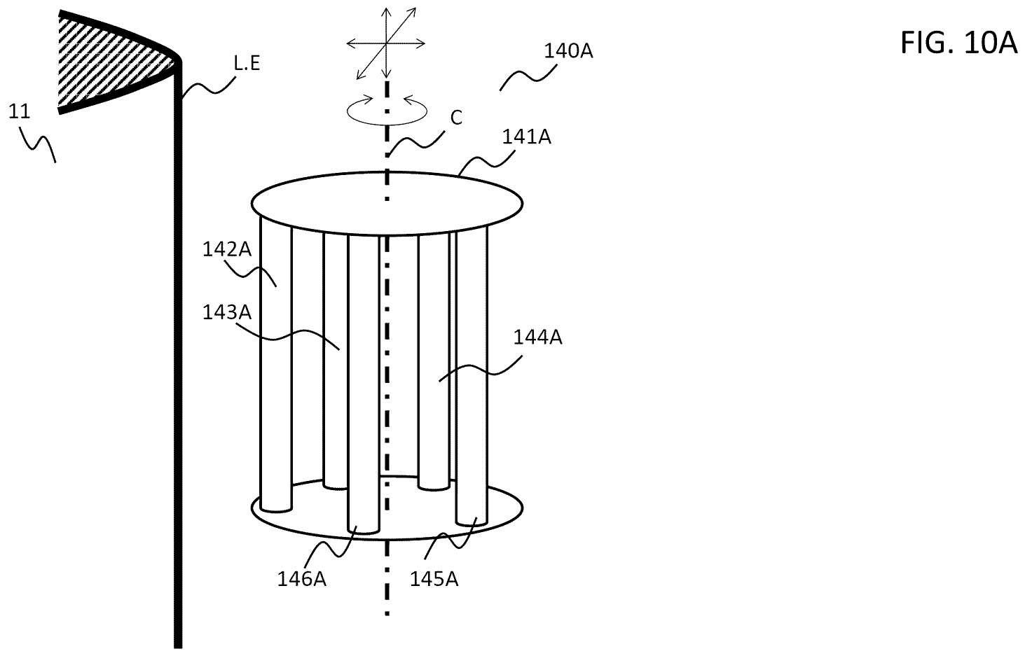

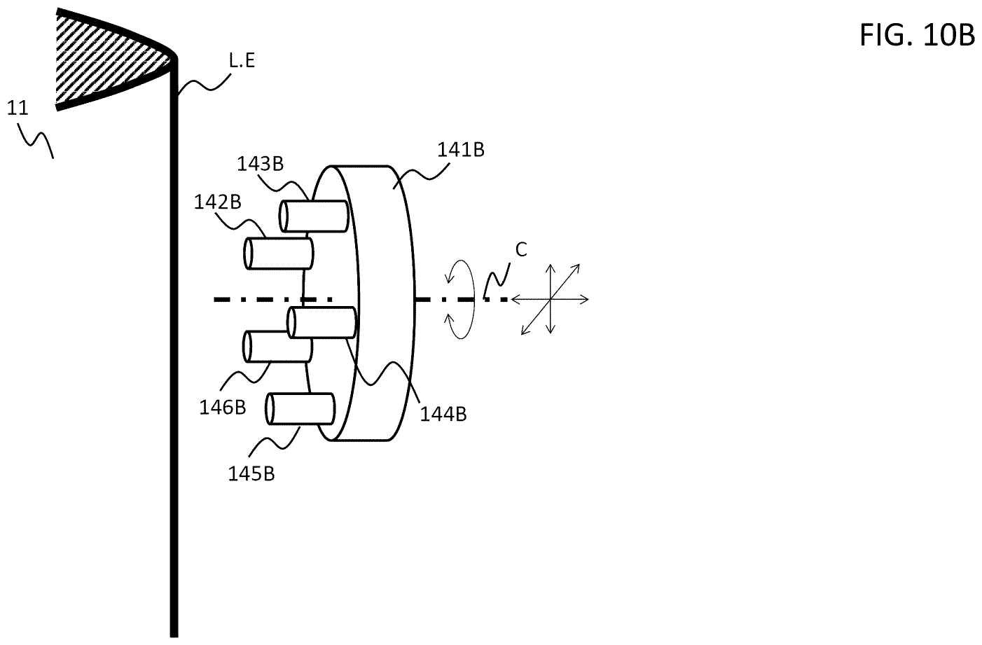

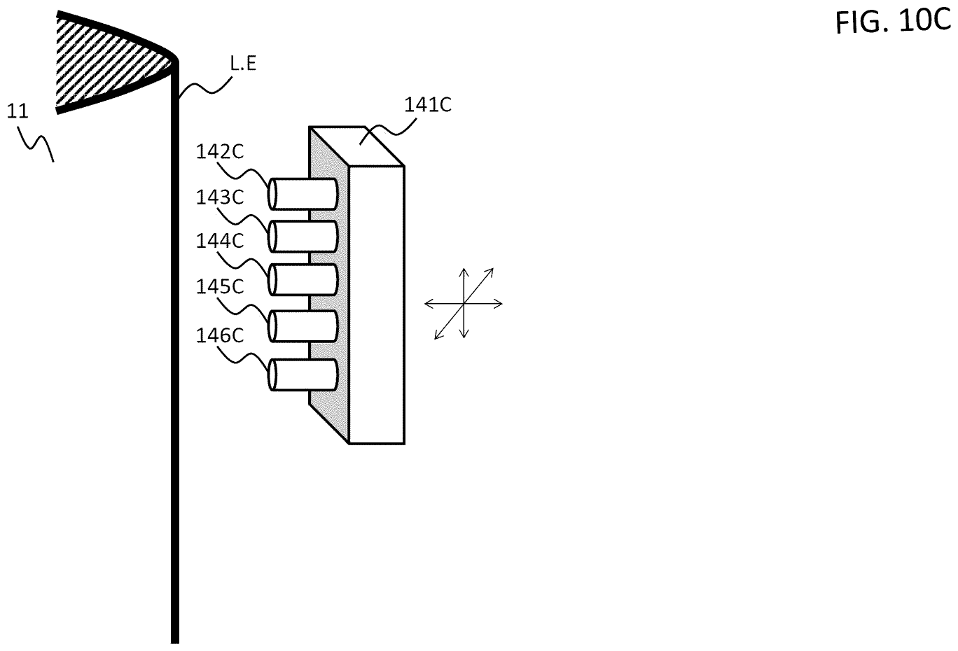

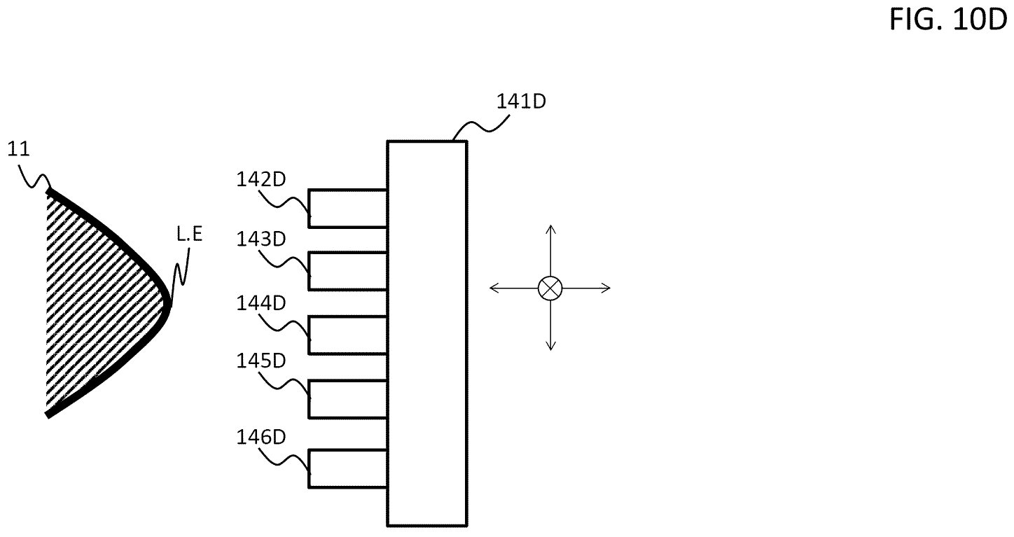

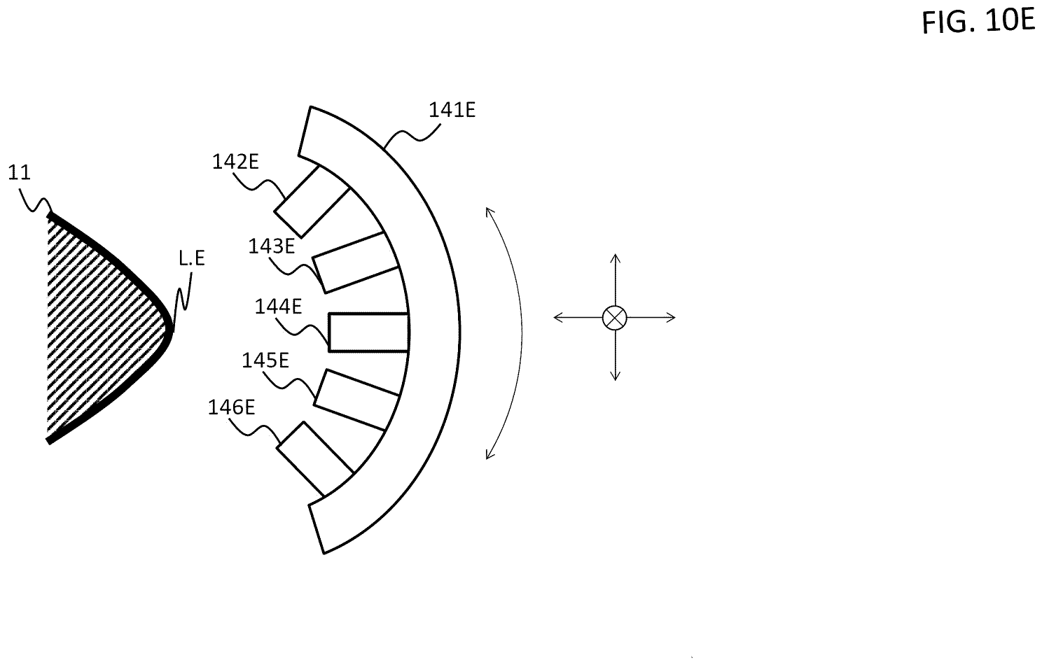

FIG. 10A shows one example of a mounting portion 140A in one embodiment. In FIG. 10A, illustration of the plurality of maintenance means 120 mounted on the mounting portion 140A is omitted. FIG. 10A depicts a perspective view and a cross section of the blade 11.

The mounting portion 140A comprises a mounting body 141A and attaching portions 142A, 143A, 144A, 145A, and 146A. To each attaching portion, respective one of the plurality of maintenance means 120 can be attached. The mounting body 141A has a columnar shape having a top face that can face the blade, a bottom face opposite to the top face, and a side face between the top face and the bottom face, wherein the plurality of maintenance means 120 are configured to be attached to the side face. For example, the plurality of maintenance means 120 can be attached around the mounting body 141A. Although FIG. 10A shows five attaching portions, the number of attaching portions is not limited thereto. The mounting portion 140A can comprise any number of attaching portions depending on the number of maintenance means to be mounted.

The mounting body 141A has an axis C, and the mounting body 141A can be rotated around the axis C by a rotation mechanism (not shown) (in the direction of the curved arrow shown in FIG. 10A). For example, the mounting body 141A can be rotated around the axis C so that a means for maintenance to be performed among the plurality of maintenance means 120 attached to the side face of the mounting body 141A approaches a site requiring maintenance on the blade 11 (e.g., leading edge (L.E)). In the example shown in FIG. 10A, the attaching portion 142A approaches the blade 11 most and maintenance would be performed by a maintenance means attached to the attaching portion 142A.

The mounting body 141A can be translated by a translation mechanism (not shown). For example, the mounting body 141A can be moved up and down, from side to side, and back and forward in the direction of the straight-line arrow shown in FIG. 10A by a translation mechanism, and can be positioned relative to the leading edge (L.E) of the blade 11.

A rotation mechanism and a translation mechanism enable a means for maintenance to be performed to approach a blade and to be positioned in the right place. Further, the position of the maintenance means can be also controlled by the translation mechanism during the performance of the maintenance. Since the same rotation mechanism and translation mechanism can be used for a plurality of maintenance means to control the position of each of the plurality of maintenance means, it is not necessary to provide a mechanism which controls a position to each of the plurality of maintenance means. This further promotes reduction in size of the maintenance device 100′.

### (Revolver Form 2)

FIG. 10B shows one example of a mounting portion 140B in one embodiment. In FIG. 10B, illustration of the plurality of maintenance means 120 mounted on the mounting portion 140B is omitted. FIG. 10B depicts a perspective view and a cross section of the blade 11.

The mounting portion 140B comprises a mounting body 141B and attaching portions 142B, 143B, 144B, 145B, and 146B. To each attaching portion, respective one of the plurality of maintenance means can be attached. The mounting body 141B has a columnar shape having a top face that can face the blade, a bottom face opposite to the top face, and a side face between the top face and the bottom face, wherein the plurality of maintenance means 120 are configured to be attached to the top face. For example, the plurality of maintenance means 120 can be attached around the mounting body 141B. Although FIG. 10B shows five attaching portions, the number of attaching portions is not limited thereto. The mounting portion 140B can comprise any number of attaching portions depending on the number of maintenance means to be mounted.

The mounting body 141B has an axis C, and the mounting body 141B can be rotated around the axis C by a rotation mechanism (not shown) (in the direction of the curved arrow shown in FIG. 10B). For example, the mounting body 141B can be rotated around the axis C so that a means for maintenance to be performed among the plurality of maintenance means 120 attached to the side face of the mounting body 141B approaches a site requiring maintenance on the blade 11. The attaching portions 142B, 143B, 144B, 145B, and 146B can be each configured to extend in the axis C direction, in other words, toward the blade 11. This enables a means for maintenance to be performed to approach the blade 11.

The mounting body 141B can be translated by a translation mechanism (not shown). For example, the mounting body 141B can be moved up and down, from side to side, and back and forward in the direction of the straight-line arrow shown in FIG. 10B by a translation mechanism, and can be positioned relative to the leading edge (L.E) of the blade 11.

A rotation mechanism, a translation mechanism, and extension of an attaching portion enable a means for maintenance to be performed to approach the blade 11 and to be positioned in the right place. Further, the position of the maintenance means can be also controlled by the rotation mechanism and/or the translation mechanism during the performance of the maintenance. Since the same rotation mechanism and translation mechanism can be used for a plurality of maintenance means to control the position of each of the plurality of maintenance means, it is not necessary to provide a mechanism which controls a position to each of the plurality of maintenance means. This further promotes reduction in size of the maintenance device 100′.

### (Slide Form)

FIG. 10C shows one example of a mounting portion 140C in one embodiment. In FIG. 10C, illustration of the plurality of maintenance means 120 mounted on the mounting portion 140C is omitted. FIG. 10C depicts a perspective view and a cross section of the blade 11.

The mounting portion 140C comprises a mounting body 141C and attaching portions 142C, 143C, 144C, 145C, and 146C. To each attaching portion, respective one of the plurality of maintenance means can be attached. The mounting body 141C has a three-dimensional shape having a top face that can face the blade, a bottom face opposite to the top face, and a side face between the top face and the bottom face, wherein the plurality of maintenance means 120 are configured to be attached to the top face facing the blade 11. The plurality of attaching portions are juxtaposed in a direction in which the leading edge of the blade 11 extends, whereby the plurality of maintenance means are juxtaposed along the leading edge of the blade. Although FIG. 10C shows five attaching portions, the number of attaching portions is not limited thereto. The mounting portion 140C can comprise any number of attaching portions depending on the number of maintenance means to be mounted.

The attaching portions 142C, 143C, 144C, 145C, and 146C can be each configured to extend toward the blade 11 in a direction approaching the blade 11 (the left direction in the figure). This enables a means for maintenance to be performed to approach a site requiring maintenance on the blade 11.

The mounting body 141C can be translated by a translation mechanism (not shown). For example, the mounting body 141C can be moved up and down, from side to side, and back and forward in the direction of the straight-line arrow shown in FIG. 10C by a translation mechanism, and can be positioned relative to the leading edge (L.E) of the blade 11.

Extension of an attaching portion and a translation mechanism enable a means for maintenance to be performed to approach the blade 11 and to be positioned in the right place. Further, the position of the maintenance means can be also controlled by extension of the attaching portion and the translation mechanism during the performance of the maintenance. Since the same translation mechanism can be used for a plurality of maintenance means to control the position of each of the plurality of maintenance means, it is not necessary to provide a mechanism which controls a position to each of the plurality of maintenance means. This further promotes reduction in size of the maintenance device 100′.

### (Slide Form 2)

FIG. 10D shows one example of a mounting portion 140D in one embodiment. In FIG. 10D, illustration of the plurality of maintenance means 120 mounted on the mounting portion 140D is omitted. FIG. 10D depicts a cross section of the blade 11.

The mounting portion 140D comprises a mounting body 141D and attaching portions 142D, 143D, 144D, 145D, and 146D. To each attaching portion, respective one of the plurality of maintenance means can be attached. The mounting body 141D has a three-dimensional shape having a top face that can face the blade, a bottom face opposite to the top face, and a side face between the top face and the bottom face, wherein the plurality of maintenance means 120 are configured to be attached to the top face facing the blade 11. The plurality of attaching portions are juxtaposed vertically to a direction in which the leading edge of the blade 11 extends, whereby the plurality of maintenance means are juxtaposed vertically to the direction in which the leading edge of the blade 11 extends. Although FIG. 10D shows five attaching portions, the number of attaching portions is not limited thereto. The mounting portion 140D can comprise any number of attaching portions depending on the number of maintenance means to be mounted.

The attaching portions 142D, 143D, 144D, 145D, and 146D can be each configured to extend toward the blade 11 in a direction approaching the blade 11 (the left direction in the figure). This enables a means for maintenance to be performed to approach a site requiring maintenance on the blade 11.

The mounting body 141D can be translated by a translation mechanism (not shown). For example, the mounting body 141D can be moved up and down, from side to side, and back and forward in the direction of the straight-line arrow shown in FIG. 10D by a translation mechanism, and can be positioned relative to the leading edge (L.E) of the blade 11.

Extension of an attaching portion and a translation mechanism enable a means for maintenance to be performed to approach the blade 11 and to be positioned in the right place. Further, the position of the maintenance means can be also controlled by extension of the attaching portion and the translation mechanism during the performance of the maintenance. Since the same translation mechanism can be used for a plurality of maintenance means to control the position of each of the plurality of maintenance means, it is not necessary to provide a mechanism which controls a position to each of the plurality of maintenance means. This further promotes reduction in size of the maintenance device 100′.

### (Slide Form 3)

FIG. 10E shows one example of a mounting portion 140E in one embodiment. In FIG. 10E, illustration of the plurality of maintenance means 120 mounted on the mounting portion 140E is omitted. FIG. 10E depicts a cross section of the blade 11.

The mounting portion 140E comprises a mounting body 141E and attaching portions 142E, 143E, 144E, 145E, and 146E. To each attaching portion, respective one of the plurality of maintenance means can be attached. The mounting body 141E has a curved body having a top face that can face the blade, a bottom face opposite to the top face, and a side face between the top face and the bottom face, wherein the plurality of maintenance means 120 are configured to be attached to the top face. The plurality of attaching portions are juxtaposed along the curved face of the curved body vertically to a direction in which the leading edge of the blade 11 extends, whereby the plurality of maintenance means are juxtaposed along the curved face of the blade. Although FIG. 10E shows five attaching portions, the number of attaching portions is not limited thereto. The mounting portion 140E can comprise any number of attaching portions depending on the number of maintenance means to be mounted.

The attaching portions 142E, 143E, 144E, 145E, and 146E can be each configured to extend toward the blade 11 in a direction approaching the blade 11 (the left direction in the figure). This enables a means for maintenance to be performed to approach a site requiring maintenance on the blade 11.

The mounting body 141E can be pivoted around the blade 11 by a pivoting mechanism (not shown) (in the direction of the curved arrow shown in FIG. 10E). For example, the mounting body 141E can be pivoted so that a means for maintenance to be performed among the plurality of maintenance means 120 attached to the top face of the mounting body 141E approaches a site requiring maintenance on the blade 11. The attaching portions 142E, 143E, 144E, 145E, and 146E can be each configured to extend vertically to the top face, in other words, toward the blade 11. This enables a means for maintenance to be performed to approach a site requiring maintenance on the blade 11.

The mounting body 141E can be translated by a translation mechanism (not shown). For example, the mounting body 141E can be moved up and down, from side to side, and back and forward in the direction of the straight-line arrow shown in FIG. 10E by a translation mechanism, and can be positioned relative to the leading edge (L.E) of the blade 11.

A rotation mechanism, a translation mechanism, and extension of an attaching portion enable a means for maintenance to be performed to approach the blade 11 and to be positioned in the right place. Further, the position of the maintenance means can be also controlled by the rotation mechanism, the translation mechanism, and extension of the attaching portion during the performance of the maintenance. Since the same rotation mechanism and translation mechanism can be used for a plurality of maintenance means to control the position of each of the plurality of maintenance means, it is not necessary to provide a mechanism which controls a position to each of the plurality of maintenance means. This further promotes reduction in size of the maintenance device 100′.

FIG. 5B shows an example of implementation of the maintenance device 100′.

The maintenance device 100′ comprises wheels as the moving means 110. The wheels are provided on the front side and the rear side of the maintenance device 100′. The wheels enable the maintenance device 100′ to move on a blade of a wind turbine.

As the mounting portion 140, the maintenance device 100′ comprises a mounting portion in the revolver form described above while referring to FIG. 10A. The mounting portion 140 comprises a mounting body 141, an attaching portion 142, a rotation mechanism 143, and a translation mechanism 144.

The mounting body 141 and the attaching portion 142 on the mounting body 141 are rotated around the axis by the rotation mechanism 143, which consequently also rotates the plurality of mechanism means 120. As a result, at least one maintenance means (maintenance performing means 150) of the plurality of maintenance means 120 can be directed to the blade of the wind turbine so that said means can perform maintenance.

The mounting body 141 and the attaching portion 142 on the mounting body 141 are moved up and down, from side to side, and back and forward by the translation mechanism 144, which consequently also moves the plurality of mechanism means 120 up and down, from side to side, and back and forward. As a result, the position of at least one maintenance means (maintenance performing means 150) of the plurality of maintenance means 120 relative to the blade of the wind turbine can be adjusted so that said means performs maintenance.

Although not shown in FIG. 5B, the maintenance device 100′ can comprise a bumper for preventing damage to the blade when the maintenance device 100′ lands on the blade of the wind turbine. For example, a bumper can be made of a foamed body (e.g., styrene foam). For example, a bumper can also have a shape which enables the blade to guide when the maintenance device 100′ lands on the blade of the wind turbine. This can stabilize the maintenance device 100′ when it lands on the blade of the wind turbine.

Note that the above-described maintenance device 100′ may be used along with the rope holding device 200, or the maintenance device 100′ may be used alone. For example, an approach for disposing the maintenance device 100′ on a blade of a wind turbine is not limited to those disclosed herein, but can be any other known approach or an approach which can be known in the future.

FIG. 5C shows one example of a configuration of the rope holding device 200.

The rope holding device 200 comprises a controlling unit 210, a communicating unit 220, a rope connecting portion 230, and a member 250. In the example shown in FIG. 5C, the member 250 is omitted. Instead, the first attaching portion 241 and the second attaching portion 242, by which the member 250 is attached to the body of the rope holding device 200, are shown.

The controlling unit 210 is configured to control the overall action of the rope holding device 200. For example, the controlling unit 210 can control the components of the rope holding device 200 in accordance with a control signal received by the communicating unit 220. For example, it is possible to drive the rope connecting portion 230 and move along a connected rope in accordance with a control signal received by the communicating unit 220. For example, it is possible to transition the member 250 from a first state where an aperture is formed to a second state where the aperture is opened in accordance with a control signal received by the communicating unit 220. Specifically, it is possible to release the member 250 from the second attaching portion 242 by using a releasing mechanism that the rope holding device 200 can comprise.

For example, the controlling unit 210 can be implemented by any controlling means such as one or more processors.

Although it was explained that each component of the rope holding device 200 is controlled in accordance with a signal from the outside of the rope holding device 200, the present invention is not limited thereto. For example, a program for realizing a series of actions of each component of the rope holding device 200 may be stored in a memory that the rope holding device 200 can comprise. The controlling unit 210 can read out and execute the program to cause the rope holding device 200 to function as an autonomous device.

The communicating unit 220 can receive a signal from the outside of the rope holding device 200. In addition, the communicating unit 220 may be also configured to transmit a signal to the outside of the rope holding device 200. The communicating unit 220 may receive a signal from the outside of the rope holding device 200 wirelessly or by wire. The communicating unit 220 may transmit a signal to the outside of the rope holding device 200 wirelessly or by wire. For example, the communicating unit 220 can receive a control signal for controlling each component of the rope holding device 200 from the outside of the rope holding device 200 (e.g., a terminal for operation used by an operator). For example, the communicating unit 220 can be implemented by any communicating means such as an antenna.

The rope connecting portion 230 comprises an engaging portion 231 which engages with a rope and a guiding portion 232 which guides the rope.

As shown in FIG. 5C, the engaging portion 231 can comprise a plurality of engaging rollers and a driving portion which drives the plurality of engaging rollers. Force for delivering a rope forward or backward can be exerted on the rope by driving the plurality of engaging rollers in a state where the rope is held between the plurality of engaging rollers. This enables the rope holding device 200 to move along the rope. The engaging portion 231 can be implemented by any other mechanism as long as it can achieve a similar function.

The guiding portion 232 is any mechanism which guides a rope to the engaging portion 231. In FIG. 5C, the guiding portion is shown as a hook. The presence of the guiding portion 232 enables the rope holding device 200 to be kept connected to the rope even when the engaging portion 231 releases engagement with the rope. The guiding portion 232 can be implemented by any other mechanism as long as it can achieve a similar function.

The member 250 can be any member which is able to form an aperture along with the body of the rope holding device 200 by being attached to the first attaching portion 241 and the second attaching portion 242. Any material can form the member 250. For example, the member 250 may be formed of a hard material or may be formed of a soft material. Preferably, the member 250 can be formed of a durable rope, for example, a climbing rope for climbing. The material of the member 250 is preferably hard enough to retain the shape of the member 250. This enables the member 250 to restrain a rope without slacking to interfere with the rope.

Although it was explained in the above-described example that release of the member 250 from the second attaching portion 242 enables said member to transition from the first state where the member forms an aperture along with the body of the rope holding device 200 to the second state where the aperture is opened, the manner in which the member 250 transitions is not limited thereto. The member 250 can transition from the first state to the second state in any other manner. For example, the member 250 can be configured to be dividable into at least two portions. The member 250 is divided into at least two portions, whereby said member can transition from the first state to the second state.

In this manner, the rope holding device 200 can have a minimum configuration which can realize a function for moving on a rope and releasably restraining the rope. This can reduce the weight of the rope holding device 200. For example, the rope holding device 200 may have a weight of about 2 kg or less, may have a weight of about 1.5 kg or less, or may have a weight of about 1 kg or less. It is preferable to reduce the weight of the rope holding device 200 as much as possible by mounting bare minimum components.

Although it was explained that the rope holding device 200 has a configuration for moving on a rope in the above-described example, the means for the rope holding device 200 to move onto a blade is not limited thereto. The rope holding device 200 can be configured to be able to move onto a blade by using any other moving means. For example, the rope holding device 200 can be configured to comprise a flying function and can move onto a blade by using the flying function. For example, the rope holding device 200 can be configured to be connected to a flying device having a flying function (e.g., drone) and can move onto a blade by the flying device connected to the rope holding device 200. For example, the rope holding device 200 can be configured to be connected to another device having an expandable and contractable structure (e.g., ladder truck) and can move onto a blade by the another device connected to the rope holding device 200. In this manner, the rope holding device 200 is able to move onto a blade of a wind turbine without using a rope placed on the wind turbine. Since the rope holding device 200 has a bare minimum configuration and has a reduced weight, it is easy to transfer said device by a flying device or another device. When moving onto a blade of a wind turbine without using a rope placed on the wind turbine, the rope holding device 200 may be configured to hold a different rope from the rope placed on the wind turbine on the blade of the wind turbine, or may be configured to hold the rope placed on the wind turbine on the blade of the wind turbine.

For example, the weight of the rope holding device 200 is preferably less than at least one rope stretched over a blade. For example, since at least one rope stretched over a blade has a weight of about 5 kg, the rope holding device 200 preferably has a weight of less than about 5 kg, for example, a weight of about 2 kg.

The weight of the rope holding device 200 is less than the weight of the maintenance device 100 (or maintenance device 100′). For example, the ratio of the weight of the rope holding device 200 to the weight of the maintenance device 100 (or maintenance device 100′) can be about 1:10, about 1:20, about 1:50, about 1:100 or the like. Preferably, the ratio of the weight of the rope holding device 200 to the weight of the maintenance device 100 (or maintenance device 100′) can be about 1:20 to about 1:50.

For example, the rope holding device 200 preferably has a small size. For example, the rope holding device 200 can have a volume of less than about 30000 cm³, a volume of less than about 25000 cm³, a volume of less than about 20000 cm³, a volume of less than about 15000 cm³, a volume of less than about 10000 cm³, a volume of less than about 5000 cm³, a volume of less than about 3000 cm³, or a volume of less than about 1000 cm³. Preferably, the rope holding device 200 can have a volume of about 2000 cm³ to about 4000 cm³.

For example, the ratio of the size (volume) of the rope holding device 200 to the size (volume) of the maintenance device 100 (or maintenance device 100′) can be about 1:10, about 1:20, about 1:50, about 1:60, about 1:100, about 1:150, about 1:200, about 1:220 or the like. Preferably, the ratio of the size of the rope holding device 200 to the size of the maintenance device 100 (or maintenance device 100′) can be about 1:60 to about 1:220.

### 3. Method for Performing Maintenance on a Blade of a Wind Turbine

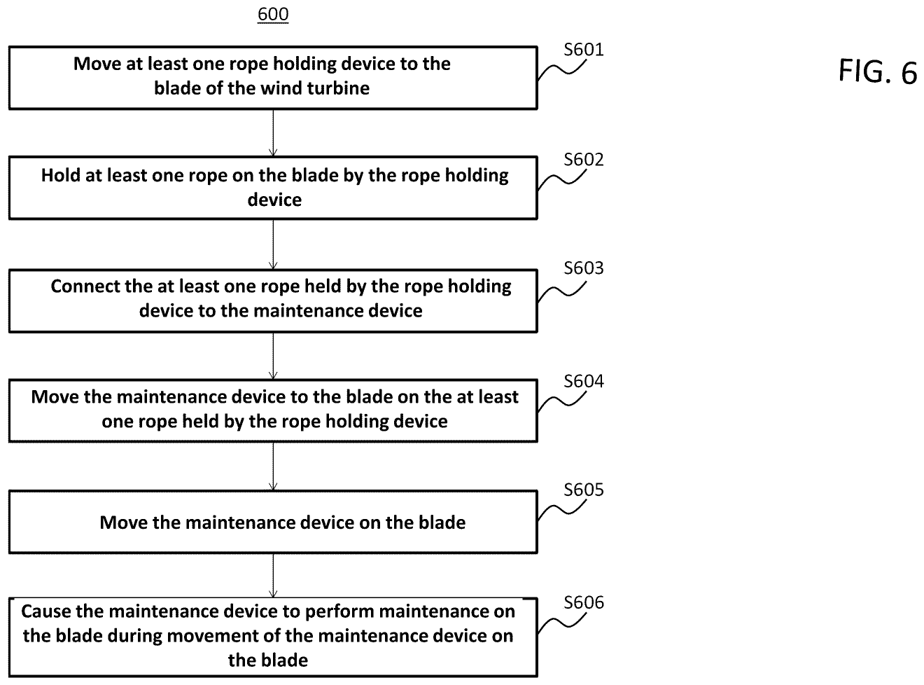

FIG. 6 shows one example of a procedure (procedure 600) of a method for performing maintenance on a blade of a wind turbine by using the system of the present invention. While an example utilizing the maintenance device 100 is explained below, it is understood that the maintenance device 100′ is also utilized in the same manner.

Step S601 is a step of moving the rope holding device 200 to the blade 11 of the wind turbine 10. In this case, the rope holding device 200 is moved to the blade 11 in any manner. The movement may be active movement by the rope holding device 200 or may be passive movement by the rope holding device 200.

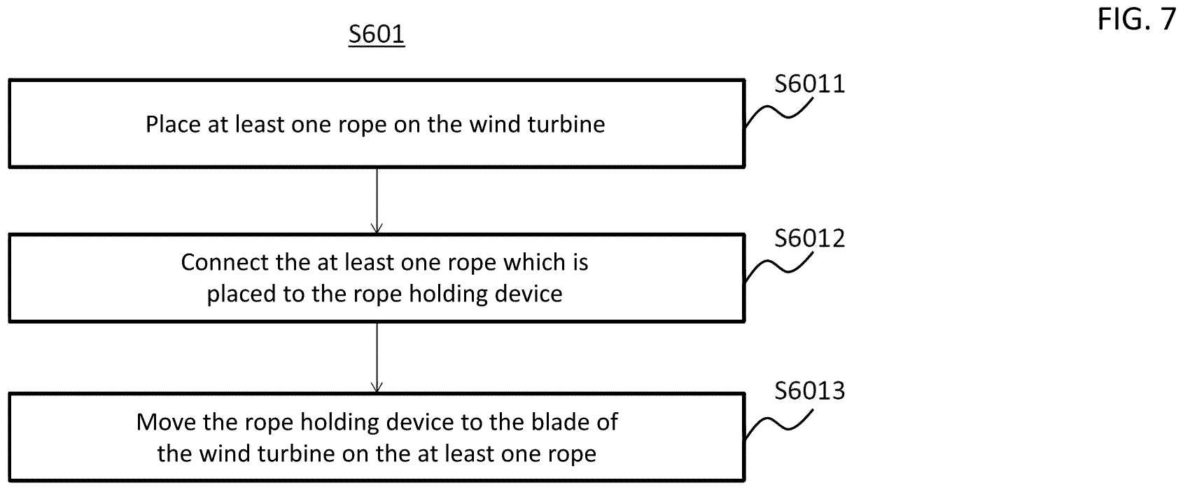

In one embodiment, the rope holding device 200 can be moved to the blade 11 of the wind turbine on a rope placed on the wind turbine. In this embodiment, for example, steps S6011 to S6013 shown in FIG. 7 can be performed.

Step S6011 is a step of placing at least one rope on the wind turbine. For example, while the blade 11 is positioned so that the blade 11 extends vertically downwards as shown in FIG. 1A, at least one rope 20 is fixed to the nacelle 14 of the wind turbine 10 and extends from the nacelle 14 of the wind turbine 10 to the ground. At least one rope to be placed does not need to be applied with tension to be pulled. For example, said rope may be configured to extend from the nacelle 14 to the ground only by the gravity. Furthermore, at least one rope is placed on the wind turbine in any manner. At least one rope can be placed in any position on the wind turbine by any approach.

Step S6011 may be manually performed by a worker, or may be automatically performed by a robot. When the step is automatically performed by a robot, at least one rope may be placed on the wind turbine by, for example, a device that is able to fly such as a drone.

Step S6012 is a step of connecting the at least one rope placed at step S6011 to the rope holding device 200. For example, the rope holding device 200 engages with the at least one rope by the engaging portion 231, whereby the at least one rope is connected to the rope holding device 200. When at least two ropes are utilized, the rope holding device 200 can engage with a first rope group comprising at least one rope by the engaging portion 231 and restrain a second rope group comprising at least one rope by the body and the member 250.

For example, step S6012 can be manually performed by a worker.

Step S6013 is a step of moving the rope holding device 200 to the blade 11 of the wind turbine 10 on the at least one rope. For example, the rope holding device 200 is moved to the blade 11 on the at least one rope as shown in FIGS. 1B to 1D.

Step S6013 involves a step of controlling the spatial position of the rope holding device 200 after the rope holding device 200 moves on the at least one rope and reaches approximately the same height as the blade 11 or during movement of the rope holding device 200 on the at least one rope. The step of controlling the spatial position can be performed by pulling the at least one rope extending from the rope holding device 200. The step of controlling the spatial position may be manually performed by a worker, or may be automatically performed by a robot.

Although the rope holding device 200 was moved to the blade 11 along the at least one rope extending from the wind turbine in the above-described example, the manner of movement of the rope holding device 200 is not limited thereto. For example, the rope holding device 200 may be lifted to the nacelle of the wind turbine in advance and lowered to the blade along the rope from the nacelle of the wind turbine, and the rope holding device 200 may be disposed on the blade.

In another embodiment, for example, the rope holding device 200 can be moved onto the blade by a flying function that the rope holding device 200 can comprise. In other embodiments, for example, a flying device having a flying function (e.g., drone) is connected to the rope holding device 200 and the rope holding device 200 can be moved onto the blade by the flying device. In other embodiments, for example, another device having an expandable and contractable structure (e.g., ladder truck) is connected to the rope holding device 200 and the rope holding device 200 can be moved onto the blade by the another device having an expandable and contractable structure. In this manner, it is possible to move the rope holding device 200 onto the blade of the wind turbine without using a rope placed on the wind turbine. When moving onto the blade of the wind turbine without using a rope placed on the wind turbine, the rope placed on the wind turbine may be connected to the rope holding device 200, the rope placed on the wind turbine is not connected and a different rope from the rope placed on the wind turbine may be connected instead, or a rope does not need to be connected in the first place.

Step S602 is a step of holding at least one rope on the blade 11 by the rope holding device 200. The at least one rope to be held on the blade 11 may be the at least one rope connected to the rope holding device 200 at step S601 or may be at least one rope different from said rope.

For example, as shown in FIGS. 1B to 1D, as a result of moving the rope holding device 200 to the blade 11 on the at least one rope and disposing the rope holding device 200 on the blade 11, the at least one rope connected to the rope holding device 200 is held on the blade 11. In other words, the at least one rope connected to the rope holding device 200 would be held on the blade 11 by the rope holding device 200. When at least two ropes are held on the blade, a first rope group comprising at least one rope would extend from the first side of the blade and a second rope group comprising at least one rope would extend from the second side of the blade as the at least two ropes held on the blade as shown in FIG. 3.

For example, as a result of moving the rope holding device 200 to which at least one rope is connected onto the blade of the wind turbine without using the rope placed on the wind turbine and disposing the rope holding device 200 on the blade 11, the at least one rope connected to the rope holding device 200 is held on the blade 11. In other words, the at least one rope connected to the rope holding device 200 would be held on the blade 11 by the rope holding device 200. When at least two ropes are held on the blade, a first rope group comprising at least one rope would extend from the first side of the blade and a second rope group comprising at least one rope would extend from the second side of the blade as the at least two ropes held on the blade as shown in FIG. 3.

For example, at least one rope may be held on the blade 11 by the rope holding device 200 by moving the rope holding device 200 to the blade 11 and disposing the rope holding device 200 on the blade 11, followed by carrying the rope to the rope holding device 200 by another device (e.g., drone) and connecting (e.g., hooking) the rope to the rope holding device 200.

Step S603 is a step of connecting the at least one rope held on the blade by the rope holding device 200 at step S602 to the maintenance device 100. For example, the at least one rope is connected to the maintenance device 100 by connecting the at least one rope to a winch of the maintenance device 100.

For example, step S603 can be manually performed by a worker.

At step S604, the maintenance device 100 is moved to the blade on the at least one rope held by the rope holding device 200 in a state where the rope holding device 200 holds the at least one rope on the blade. For example, as shown in FIGS. 1E to 1F, the maintenance device 100 is moved to the blade 11. The maintenance device 100 can move to the blade along the at least one rope held by the rope holding device 200.

After the maintenance device 100 moves to the blade, the rope holding device 200 may be configured to release the restrained rope as shown in FIG. 4. Furthermore, the rope holding device 200 may release the engagement with the rope with which the rope holding device engages. This enables the rope holding device 200 to move along with the maintenance device 100 without interfering with the movement of the maintenance device 100.

Step S605 is a step of moving the maintenance device 100 on the blade after the maintenance device 100 moves to the blade. In this case, the maintenance device 100 is moved on the blade 11 in any manner.

For example, the maintenance device 100 can be moved on the blade 11 along the at least one rope 20 placed at step S6011 as shown in FIG. 1G. In another example, the maintenance device 100 can be moved on the blade 11 by utilizing a driving wheel that the maintenance device 100 can comprise. In another example, the maintenance device 100 can be moved on the blade 11 by utilizing a different rope from the at least one rope with which the maintenance device 100 moved onto the blade. As a specific example, after the maintenance device 100 is moved to the blade 11 on at least one rope held by the rope holding device 200, which is different from the rope placed on the wind turbine, in a state where the rope placed on the wind turbine is connected to the maintenance device 100 in advance, the maintenance device 100 can be moved on the blade 11 by utilizing the rope placed on the wind turbine.

In doing so, the maintenance device 100 can fixedly attach to the blade 11 via any attaching means. This enables the maintenance device 100 to move on the leading edge of the blade 11 without floating up. Further, since the leading edge of the blade 11 is inclined by about 5 degrees relative to the vertical direction, the gravity exerted on the maintenance device 100 acts so as to push the maintenance device 100 against the leading edge of the blade 11, thereby preventing the maintenance device 100 from floating up. For example, step S605 may be performed in response to transmission of a control signal to the maintenance device 100 by a worker using a terminal for operation, or may be performed in response to transmission of a control signal to the maintenance device 100 by a robot. Alternatively, the maintenance device 100 may be configured to autonomously perform step S605.

The step of moving the maintenance device 100 at step S605 may comprise: moving the maintenance device 100 on the blade in a first direction of the directions in which the at least one rope extends; and moving the maintenance device 100 on the blade in a second direction of the directions in which the at least one rope extends. For example, the first direction is a direction from the tip of the blade to the root of the blade while the second direction is a direction from the root of the blade to the tip of the blade. The maintenance device 100 can move in the first direction or the second direction by controlling the winding or delivery by a winch.

Step S606 is a step of causing the maintenance device 100 to perform maintenance on the blade during movement of the maintenance device 100 on the blade. For example, as shown in FIG. 1G, the maintenance device 100 is caused to perform maintenance on the blade 11 during movement of the maintenance device 100 on the leading edge of the blade 11. In doing so, the maintenance device 100 fixedly attaches to the blade 11 via any attaching means. This enables the maintenance device 100 to push a maintenance means such as a washing means or polishing means against the leading edge of the blade 11 without floating up. Further, since the leading edge of the blade 11 is inclined by about 5 degrees relative to the vertical direction, the gravity exerted on the maintenance device 100 acts so as to push the maintenance device 100 against the leading edge of the blade 11, thereby preventing the maintenance device 100 from floating up. For example, step S606 may be performed in response to transmission of a control signal to the maintenance device 100 by a worker using a terminal for operation, or may be performed in response to transmission of a control signal to the maintenance device 100 by a robot. Alternatively, the maintenance device 100 may be configured to autonomously perform step S606.

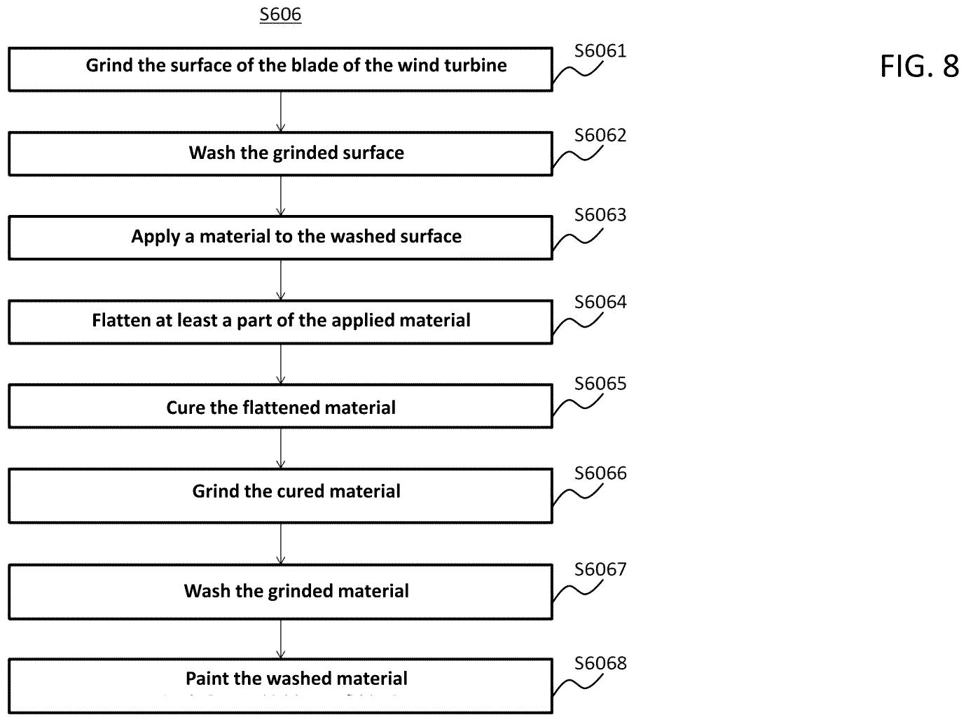

FIG. 8 shows one example of a maintenance method of when step S606 is performed by the maintenance device 100′. For example, the method shown in FIG. 8 is performed for a site requiring maintenance on a blade. For example, the maintenance device 100′ moves on the blade, and when the maintenance device reaches the site requiring maintenance, the maintenance device can perform each step shown in FIG. 8. Each of the plurality of maintenance means 120 and the mounting portion 140 can be controlled by the controlling means 130.

First, the controlling means 130 recognizes that grinding should be performed at step S6061 and selects the grinding means 121 among the plurality of maintenance means 120. The controlling means 130 controls the rotation mechanism of the mounting portion 140 to direct the grinding means 121 to the site requiring maintenance on the blade so that grinding by the selected grinding means 121 can be performed.

At step S6061, the grinding means 121 grinds the surface of the site requiring maintenance on the blade of the wind turbine. For example, the grinding means 121 can perform grinding by using a leutor. The leutor can grind the surface of the site requiring maintenance while the position of the leutor relative to the site requiring maintenance on the blade is being adjusted by the translation mechanism of the mounting portion 140. In doing so, the rotational axis of the grinding body of the leutor is preferably perpendicular to the surface of the site requiring maintenance. The grinding body of the leutor is pushed against the surface of the site requiring maintenance and moved along the surface of the site requiring maintenance in a state where the rotational axis of the grinding body of the leutor is perpendicular to the surface of the site requiring maintenance, whereby a desired range on the surface of the site requiring maintenance is grinded.

When grinding at step S6061 is complete, the controlling means 130 recognizes that washing should be performed next and selects the washing means 122 among the plurality of maintenance means 120. The controlling means 130 controls the rotation mechanism of the mounting portion 140 to direct the washing means 122 to the site requiring maintenance on the blade so that washing by the selected washing means 122 can be performed.

At step S6062, the washing means 122 washes the surface grinded at step S6061. For example, the washing means 122 can wipe off dirt by using washing liquid and rag.

When washing at step S6062 is complete, the controlling means 130 recognizes that application of a material should be performed next and selects the applying means 123 among the plurality of maintenance means 120. The controlling means 130 controls the rotation mechanism of the mounting portion 140 to direct the applying means 123 to the site requiring maintenance on the blade so that application of a material by the selected applying means 123 can be performed.

At step S6063, the applying means 123 applies a material to the surface washed at step S6062. In this case, the material can be putty for filling the portion which is hollow by grinding. For example, the applying means 123 can apply putty by using a caulking gun.

When application of the material at step S6063 is complete, the controlling means 130 recognizes that flattening of the material should be performed next and selects the flattening means 124 among the plurality of maintenance means 120. The controlling means 130 controls the rotation mechanism of the mounting portion 140 to direct the flattening means 124 to the site requiring maintenance on the blade so that flattening of the material by the selected flattening means 124 can be performed.

At step S6064, the flattening means 124 flattens the material applied at step S6063. For example, the flattening means 124 can flatten the applied material (putty) by using a spatula as shown in FIG. 8. For example, flattening by a spatula can be performed so that the material would not be flush with the surface of the blade (e.g., so that the material would rise from the surface of the blade).

When application of the material at step S6064 is complete, the controlling means 130 can control the flattening means 124 to clean the putty adhered to the spatula. For example, cleaning can be performed by rubbing the spatula against a wire net.

When application of the material at step S6064 is complete or cleaning of the spatula is complete, the controlling means 130 recognizes that curing of the material should be performed next and selects the curing means 125 among the plurality of maintenance means 120. The controlling means 130 can control the rotation mechanism of the mounting portion 140 to direct the curing means 125 to the site requiring maintenance on the blade so that curing of the material by the selected curing means 125 can be performed.

At step S6065, the curing means 125 cures the material flattened at step S6064. For example, the curing means 125 can cure the material by irradiating the material with UV using a UV light source.

When curing of the material at step S6065 is complete, the controlling means 130 recognizes that grinding of the cured material should be performed next and selects the grinding means 121 among the plurality of maintenance means 120. Since the material after flattening of the material at step S6064 is risen, grinding can be performed to make the material flush with the surface of the blade. The controlling means 130 can control the rotation mechanism of the mounting portion 140 to direct the grinding means 121 to the site requiring maintenance on the blade so that grinding of the material by the selected grinding means 121 can be performed.

At step S6066, the grinding means 121 grinds the material cured at step S6065. For example, the grinding means 121 can perform grinding by using a belt sander. The belt sander can grind the surface of the site requiring maintenance while the position of the belt sander relative to the site requiring maintenance on the blade is being adjusted by the translation mechanism of the mounting portion 140. In doing so, the moving direction of the grinding surface of the belt sander is preferably inclined relative to a direction in which the leading edge of the blade extends. This can release the grinding force of the belt sander well and prevent excessive grinding by the belt sander. The grinding surface of the belt sander is pushed against the surface of the site requiring maintenance and moved along the surface of the site requiring maintenance in a state where the moving direction of the grinding surface of the belt sander is inclined relative to the direction in which the leading edge of the blade extends, whereby a desired range on the surface of the site requiring maintenance is grinded.

When grinding at step S6066 is complete, the controlling means 130 recognizes that washing should be performed next and selects the washing means 122 among the plurality of maintenance means 120. The controlling means 130 controls the rotation mechanism of the mounting portion 140 to direct the washing means 122 to the site requiring maintenance on the blade so that washing by the selected washing means 122 can be performed.

At step S6067, the washing means 122 washes the material grinded at step S6066. For example, the washing means 122 can wipe off dirt by using washing liquid and rag.

When washing at step S6067 is complete, the controlling means 130 recognizes that application of paint should be performed next and selects the applying means 123 among the plurality of maintenance means 120. The controlling means 130 controls the rotation mechanism of the mounting portion 140 to direct the applying means 123 to the site requiring maintenance on the blade so that application of paint by the selected applying means 123 can be performed.

At step S6068, the applying means 123 applies paint to the material washed at step S6067. For example, the applying means 123 can apply paint by using a spraying device that is able to spray paint or a paint roller.

In this manner, the surface of the site requiring maintenance on the blade of the wind turbine can be repaired as step S606.

As described above, each step of the method for performing maintenance on a blade of a wind turbine may be initiatively performed by a worker, or may be automatically performed by a robot. When each step is performed by a robot, a worker does not need to be in a work site, which enables maintenance on a blade of a wind turbine to be safely performed.

### 4. Maintenance on a Blade of a Wind Turbine (Second Aspect)

The second aspect of the present invention is explained hereinafter.

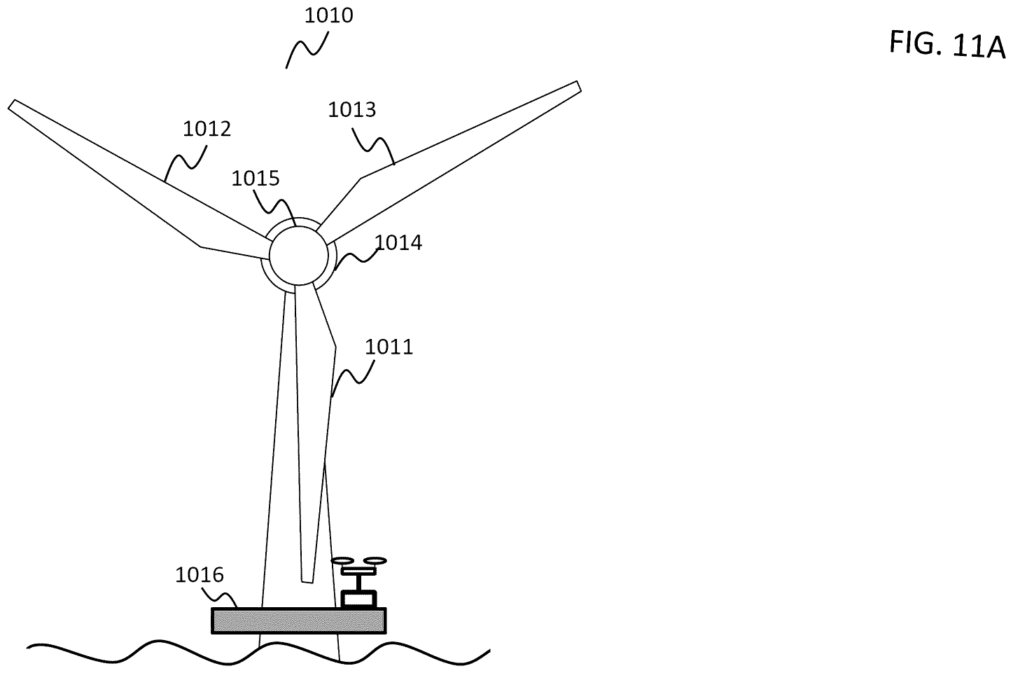

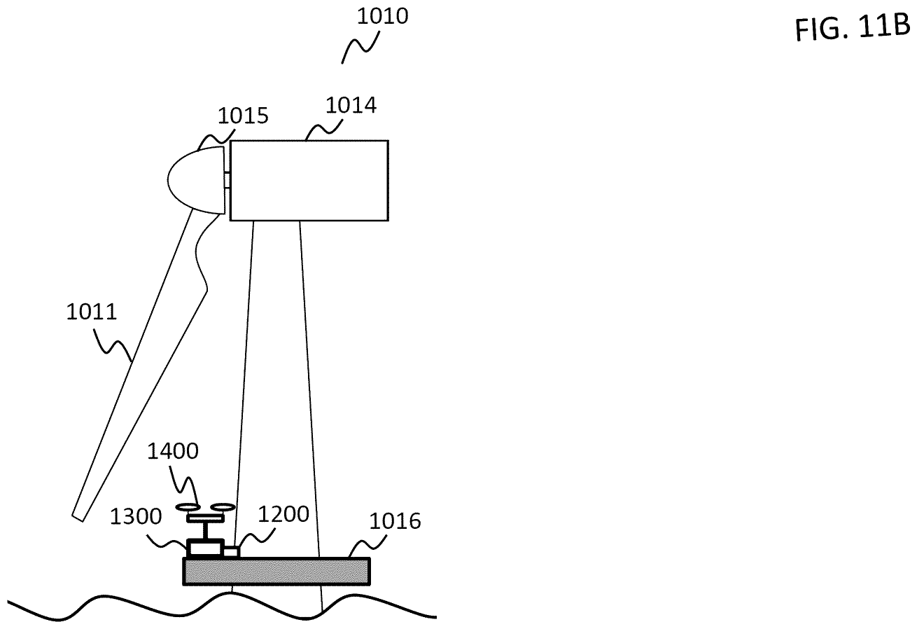

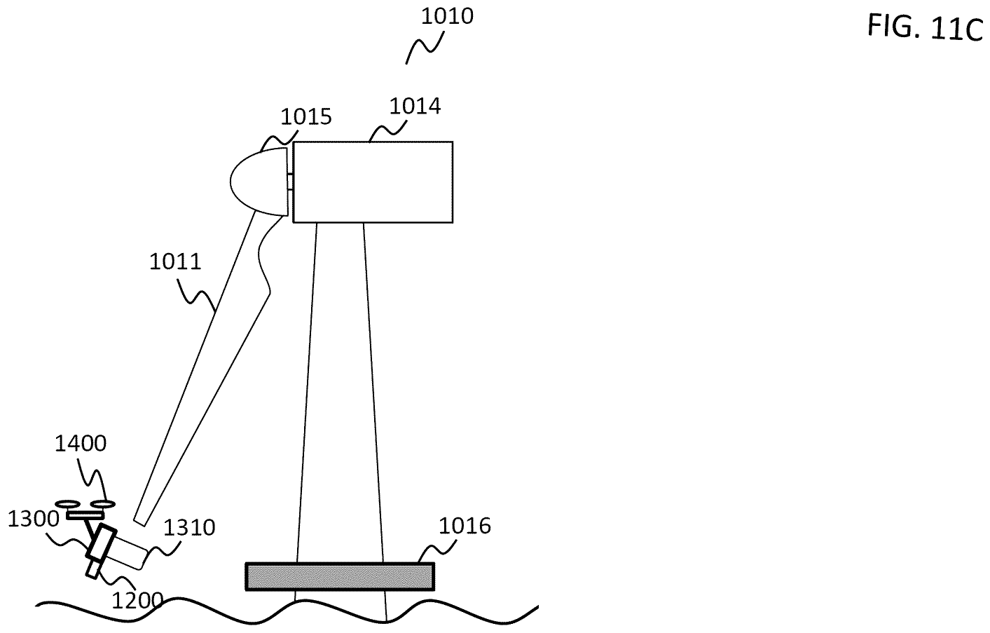

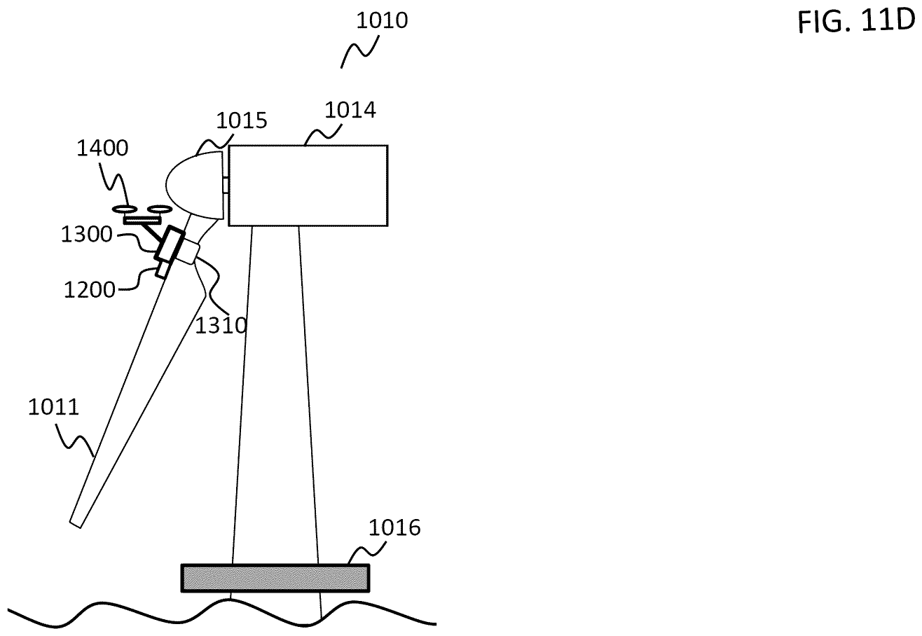

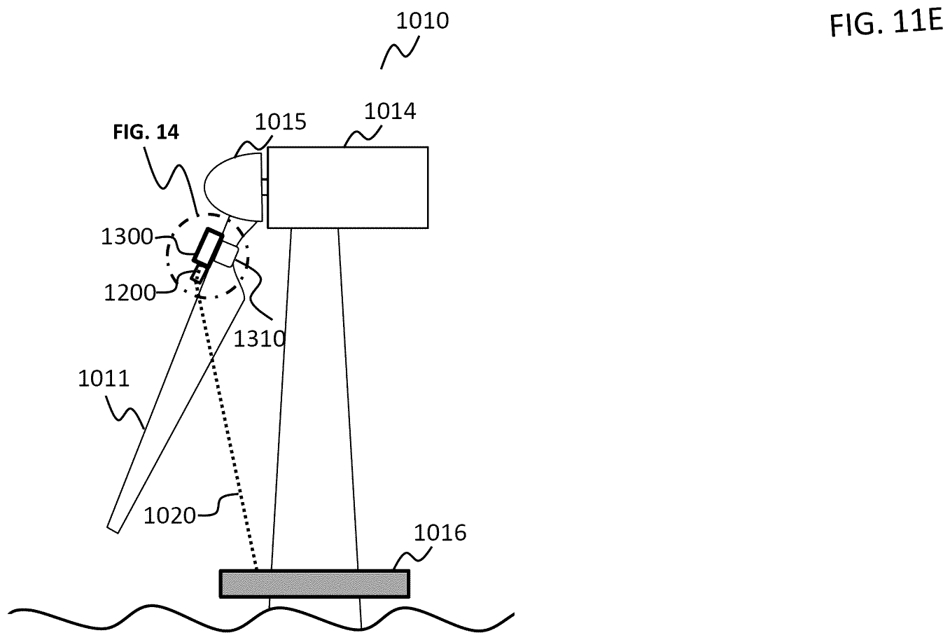

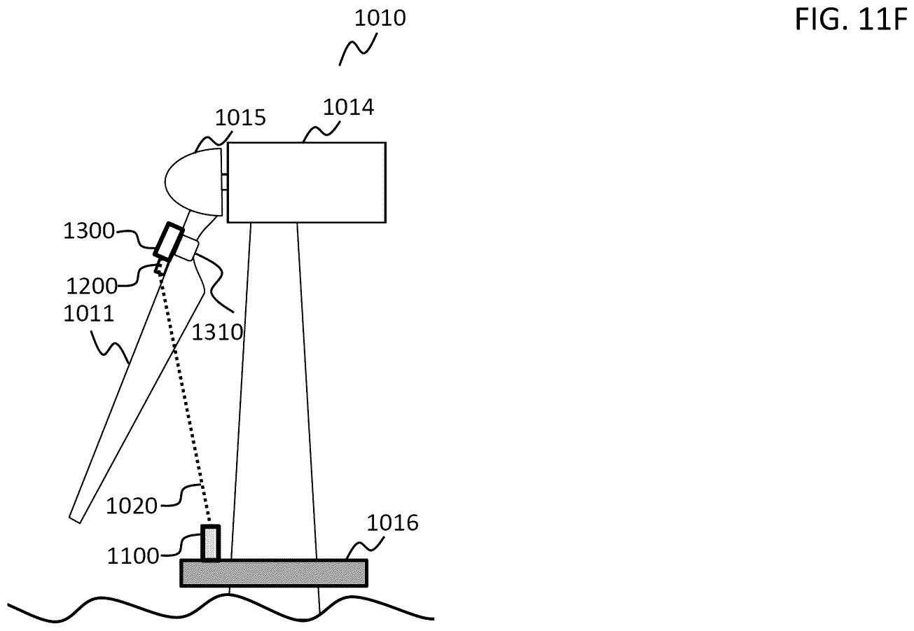

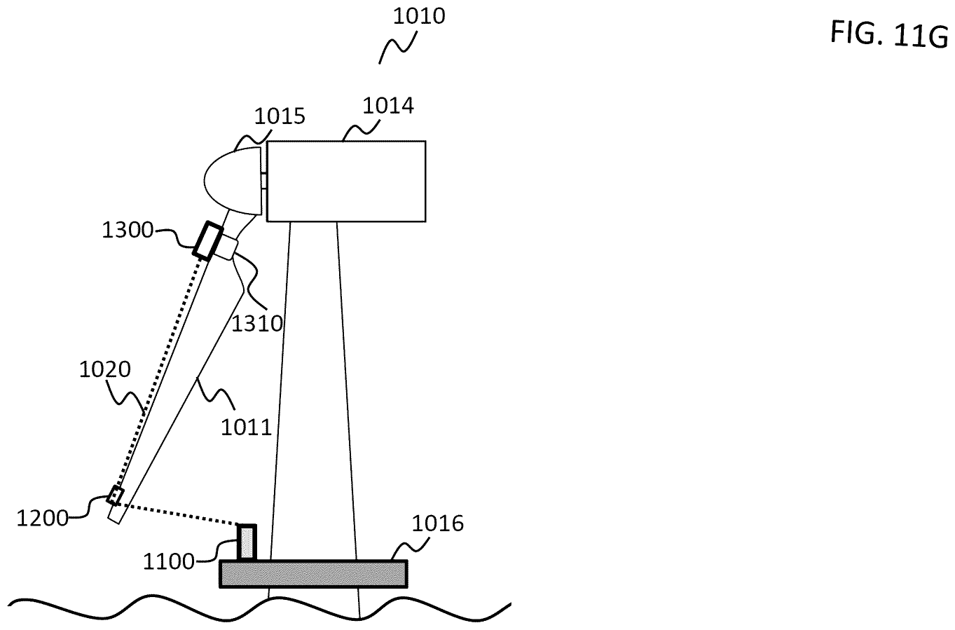

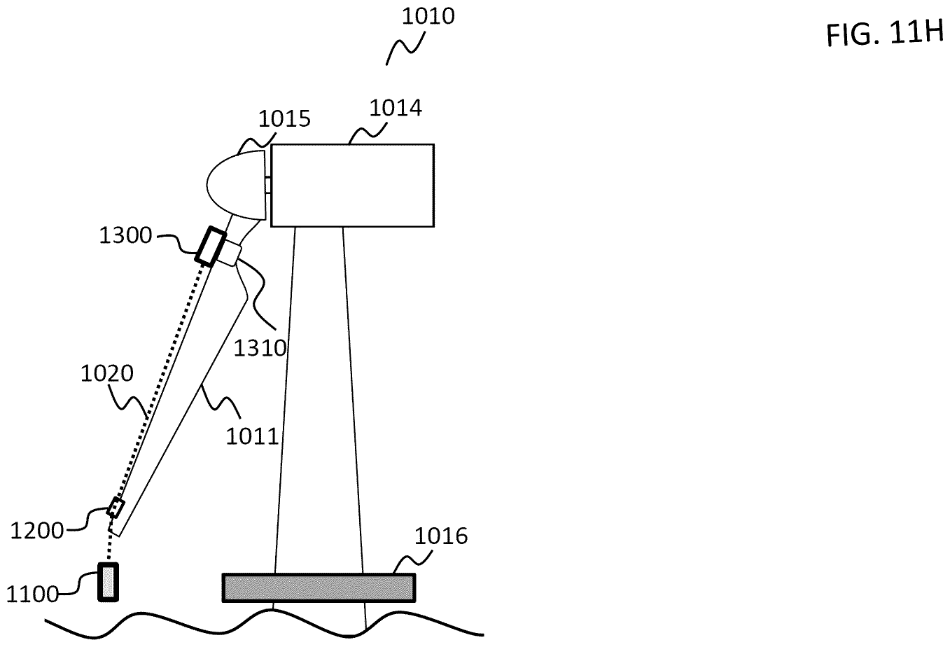

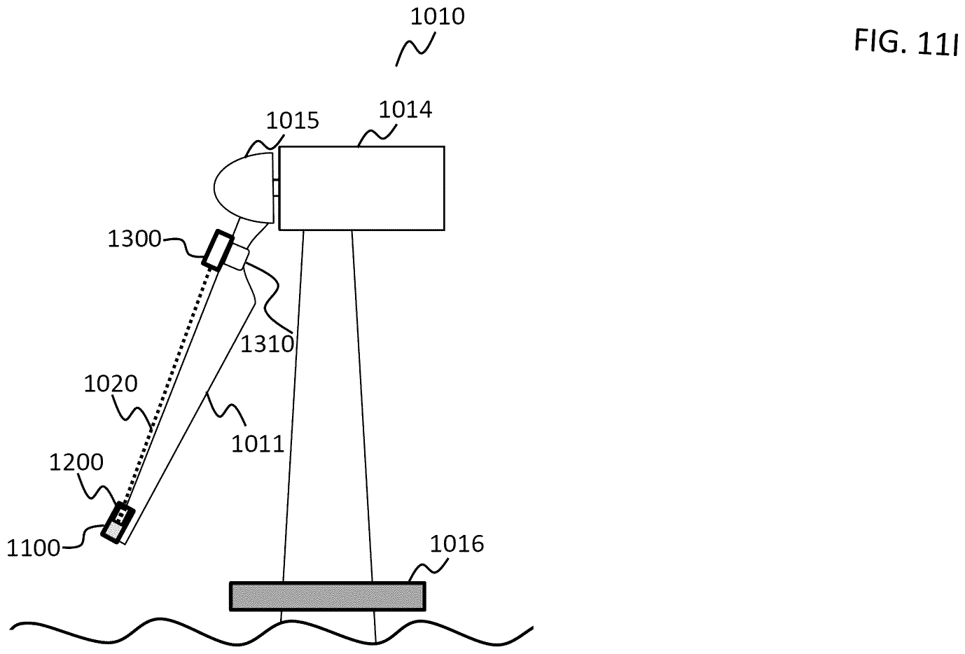

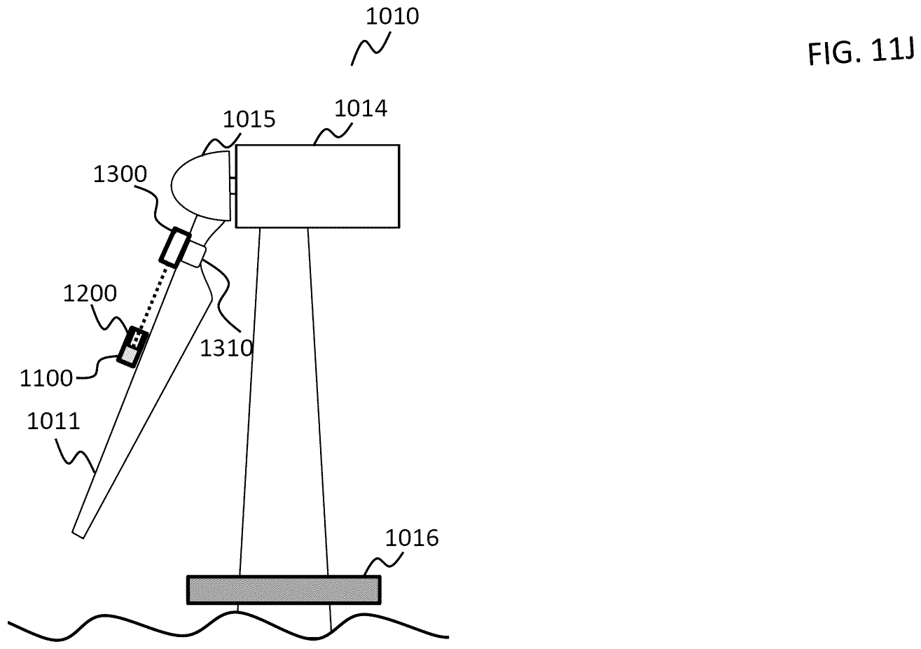

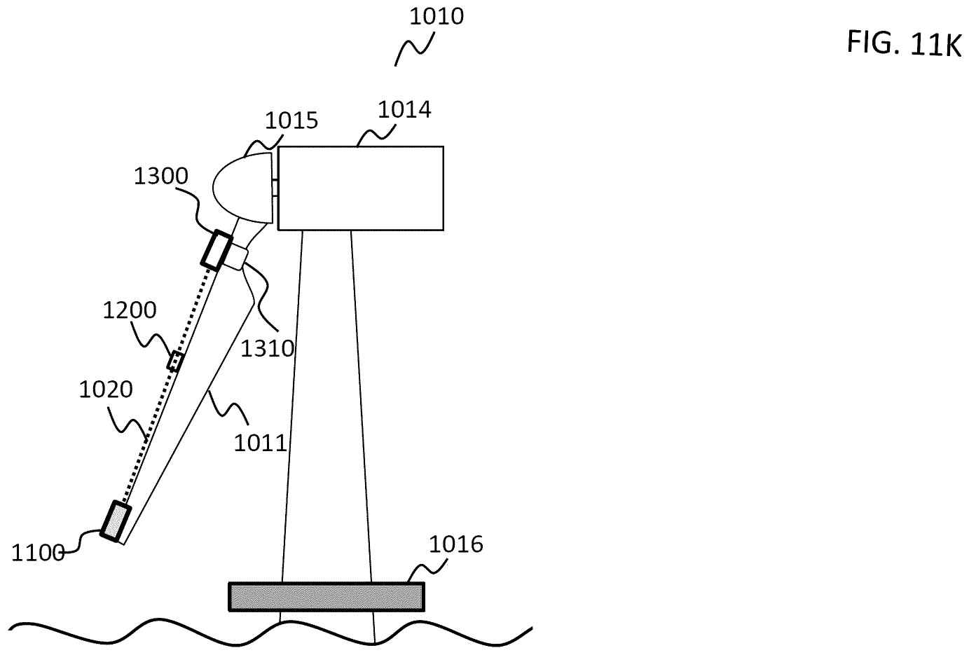

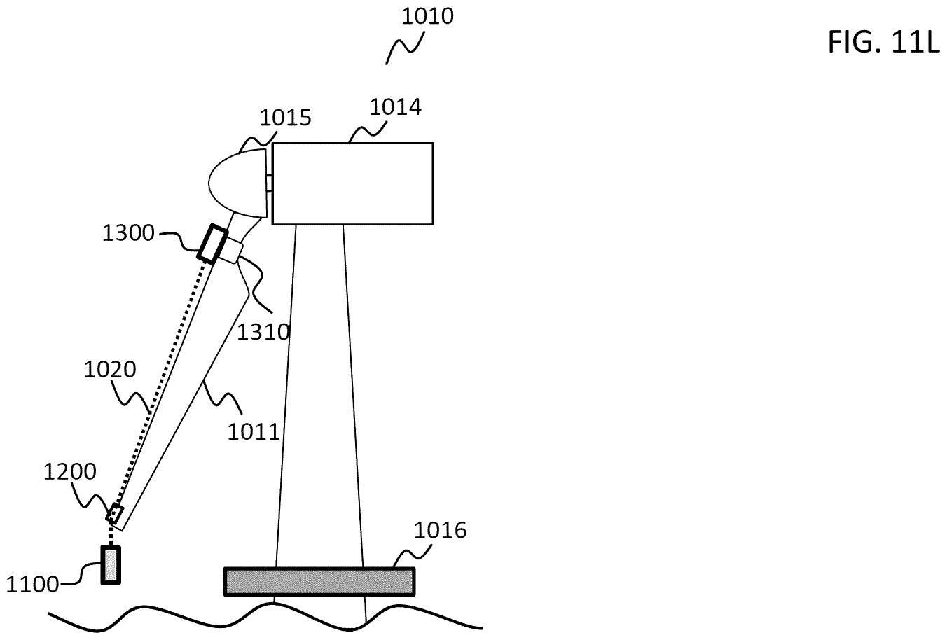

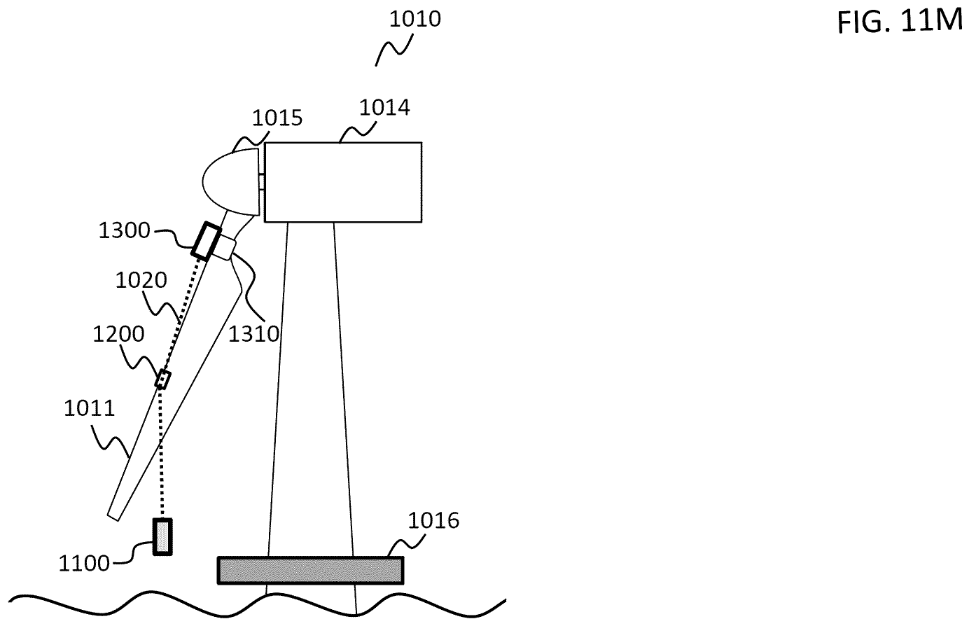

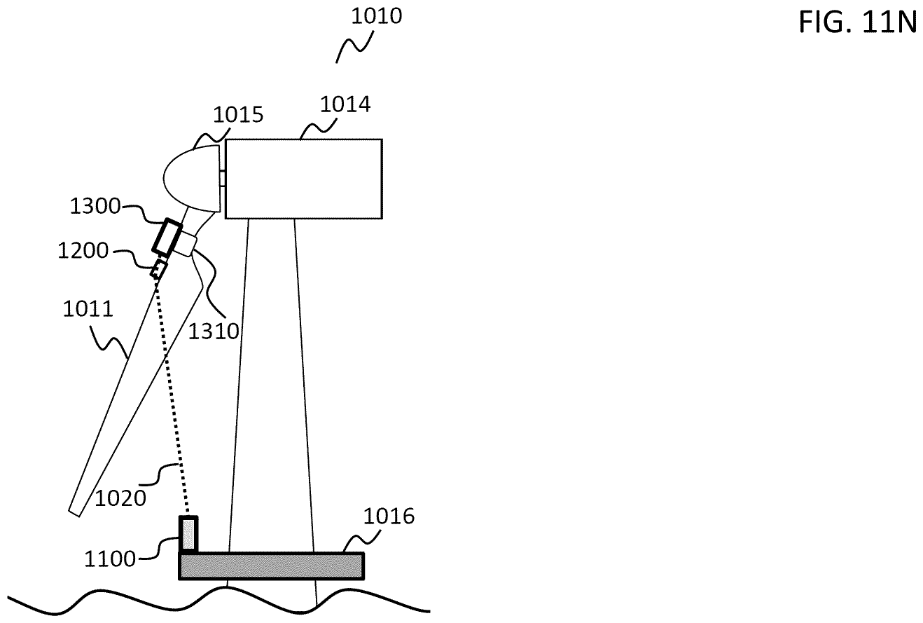

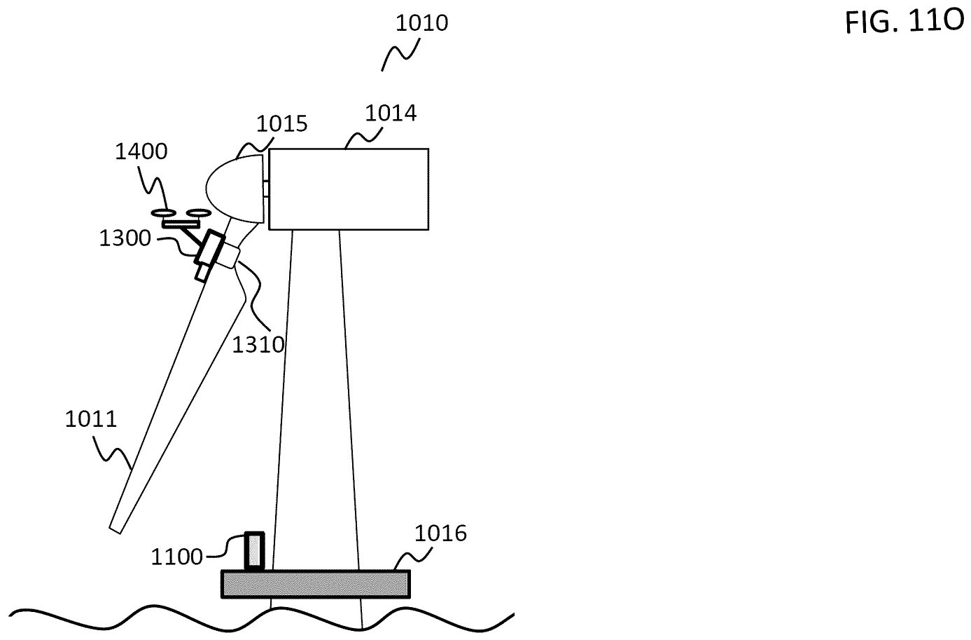

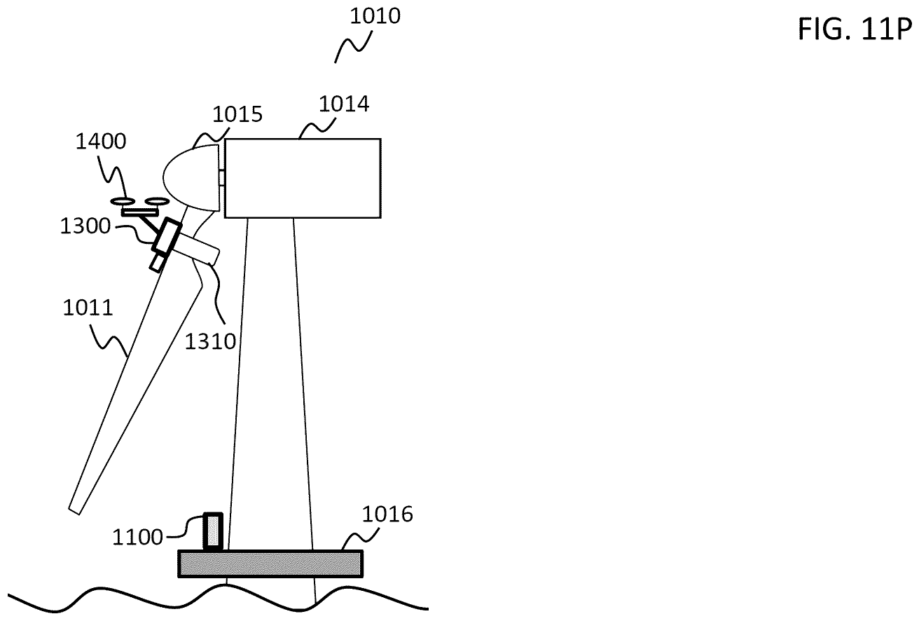

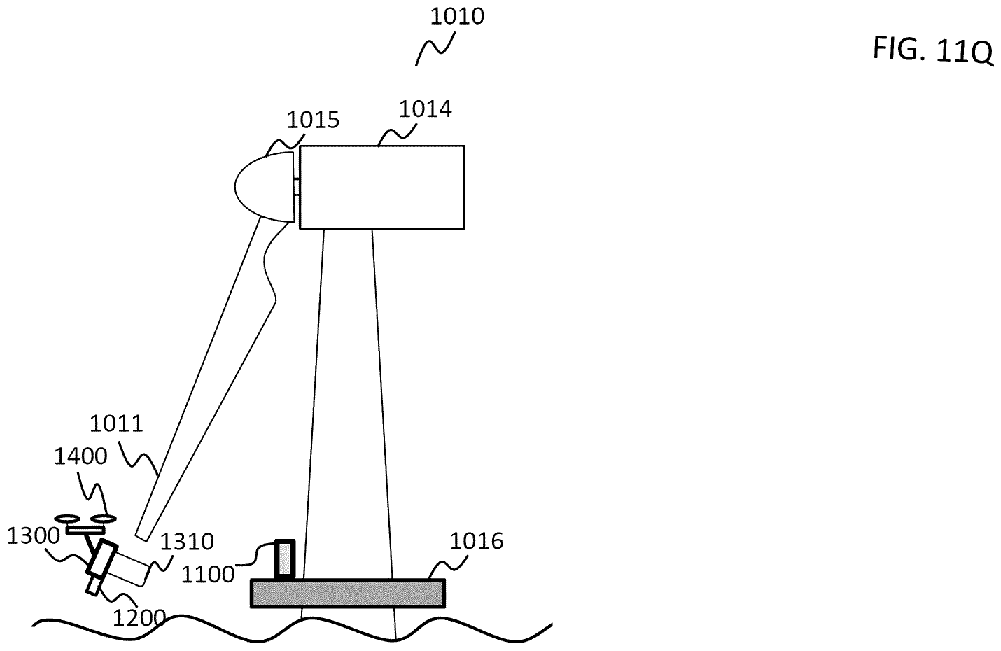

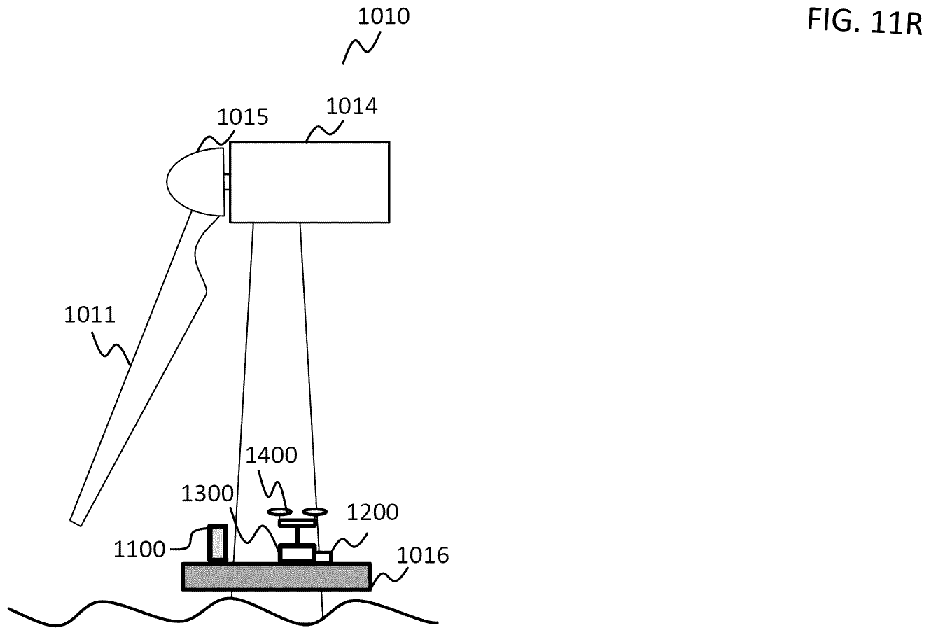

Referring to FIGS. 11A to 11R, a procedure of performing maintenance on a blade of a wind turbine by using the system of the present invention is explained. FIG. 11A shows the front of a wind turbine 1010 while FIGS. 11B to 11R show the right side view of the wind turbine 1010. FIGS. 11B to 11R show only a blade 1011 that is the subject of maintenance and omits the other two blades 1012 and 1013. The wind turbine shown in FIG. 11A is a wind turbine which rotates clockwise on the drawings, in which a linear edge of each blade is a leading edge (front edge).

The wind turbine 1010 comprises blades 1011, 1012 and 1013, a nacelle 1014, and a hub 1015. The nacelle 1014 is a case housing a generator, a gear box or the like. The hub 1015 is a member which rotatably couples the blades 1011, 1012 and 1013 and the nacelle 1014. The wind turbine 1010 shown in FIGS. 11A to 11R is a wind turbine built on the sea. The wind turbine 1010 further comprises a deck 1016. Workers, facilities for working and the like can use the deck 1016 as a scaffold on the sea.

The system of the present invention comprises a maintenance device 1100, a rope holding device 1200, and an attaching device 1300. The system of the present invention can also comprise a moving device 1400. The maintenance device 1100 is a device which performs maintenance on a blade. The rope holding device 1200 is a device which holds a rope extending from the attaching device 1300 on the blade. The attaching device 1300 is a device which attaches to the blade. The rope is fixed to the attaching device 1300. The attaching device 1300 attaches to the blade, whereby the rope would be fixed on the blade via the attaching device 1300. The moving device 1400 is a device which moves the attaching device 1300 and the rope holding device 1200 from the deck to the blade. The moving device 1400 can be, but is not limited to, a moving device which is able to fly such as a drone. The moving device can be any means as long as it can move the attaching device 1300 and the rope holding device 1200 to the blade.

FIGS. 11A and 11B show the state of an initial stage before attaching the system of the present invention to the blade 1011 of the wind turbine 1010. FIG. 11B shows the right side view of FIG. 11A.

Maintenance on the blade 1011 is performed while positioning the blade 1011 so that the blade 1011 extends vertically downwards. Since this is the same state as the state of a blade in a conventional method in which a worker moves on a blade along a rope stretched over the blade and performs maintenance, this state is readily accepted in existing work sites. When the blade 1011 is positioned to extend vertically downwards, the leading edge is inclined relative to the vertical direction as shown in FIG. 11B. The inclination angle can be about 5 degrees (about 1 degree to about 10 degrees in some cases). FIGS. 11B to 11R exaggeratedly depict the angle.

In a preparation stage before attaching the system of the present invention to the blade 1011 of the wind turbine 1010, each element of the system is prepared on the deck 1016. The example shown in FIG. 11B shows a state where the rope holding device 1200 and the attaching device 1300 are prepared on the deck 1016, and the moving device 1400 is coupled to the attaching device 1300 to which the rope holding device 1200 is attached. Although FIG. 11B omits the maintenance device 1100, the maintenance device 1100 can also be prepared on the deck 1016.

In this case, the rope holding device 1200 can be coupled to the attaching device 1300 by any means as long as the rope holding device 1200 is separatable from the attaching device 1300. For example, the rope holding device 1200 may be coupled to the attaching device 1300 by mechanical force, may be coupled to the attaching device 1300 by magnetic force, may be coupled to the attaching device 1300 by electric power, or may be coupled to the attaching device 1300 by pressure or suction force.

Further, the moving device 1400 can be coupled to the attaching device 1300 by any means as long as the moving device 1400 is separatable from the attaching device 1300. For example, the moving device 1400 may be coupled to the attaching device 1300 by mechanical force, may be coupled to the attaching device 1300 by magnetic force, may be coupled to the attaching device 1300 by electric power, or may be coupled to the attaching device 1300 by pressure or suction force.

At least one nylon string which can be used at a stage of fixing a part of at least one rope described below can pass inside the attaching device 1300 and the rope holding device 1200. For example, the nylon string can be removably fixed to the attaching device 1300 by passing through an eye bolt on the attaching device 1300 and winding around the eye bolt and extending. Both ends of the nylon string passing through the attaching device 1300 and the rope holding device 1200 are held on the deck 1016 by, for example, a worker. That is, the at least one nylon string would extend from one end on the deck 1016 to the other end on the deck 1016 after passing through the attaching device 1300 and the rope holding device 1200.

FIGS. 11C and 11D show the state of an attaching stage of attaching the attaching device 1300 to the blade 1011 of the wind turbine 1010.

FIG. 11C shows the state where the moving device 1400 carries the attaching device 1300 along with the rope holding device 1200. The attaching device 1300 comprises an attaching mechanism 1310 for attaching the attaching device 1300 to the blade 1011.

The attaching mechanism 1310 can be any mechanism as long as it enables the attaching device 1300 to attach to the blade 1011. For example, the attaching mechanism 1310 may be a mechanism which attaches the attaching device 1300 to the blade 1011 by mechanical force, may be a mechanism which attaches the attaching device 1300 to the blade 1011 by magnetic force, may be a mechanism which attaches the attaching device 1300 to the blade 1011 by electric power, or may be a mechanism which attaches the attaching device 1300 to the blade 1011 by pressure or suction force. Preferably, the attaching mechanism 1310 can be a mechanism which attaches the attaching device 1300 to the blade 1011 by mechanical force.

In one example, the attaching mechanism 1310 can be a band or a belt which is able to tighten.

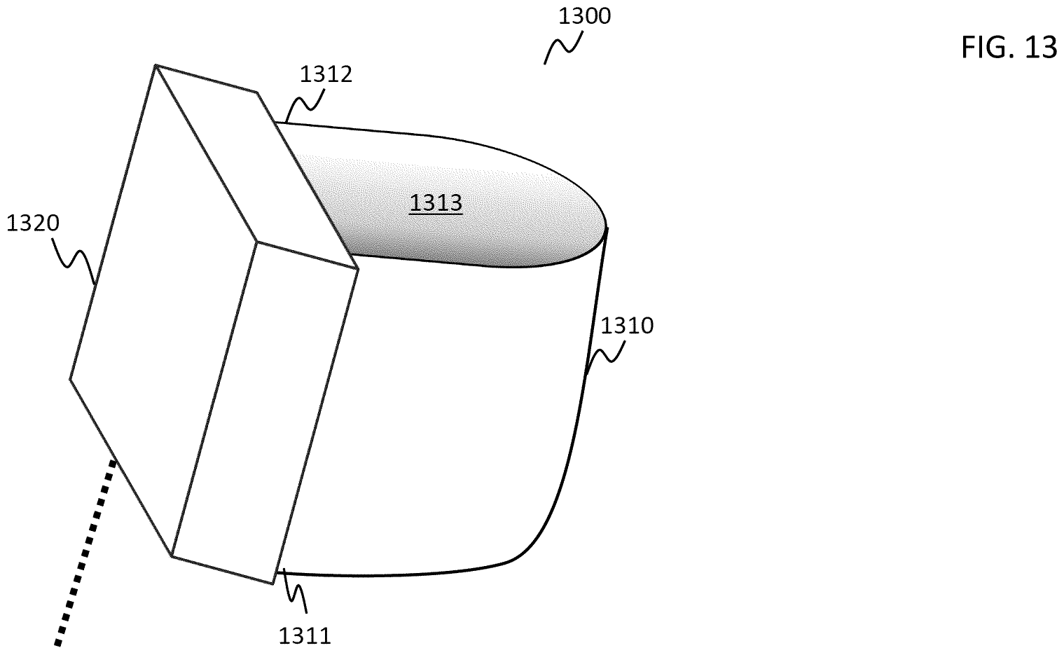

FIG. 13 schematically shows the configuration of the attaching device 1300 in this example. The attaching device 1300 comprises an attaching mechanism 1310 and a body 1320. The attaching mechanism 1310, which is a band or a belt, has a first end portion 1311 fixed to the body 1320 and a second end portion 1312 coupled to the body 1320 in a windable manner, whereby the body 1320 and the attaching mechanism 1310 form a space 1313.

For example, it is possible to tighten the blade 1011 by the attaching mechanism 1310 by winding the second end portion 1312 of the attaching mechanism 1310 in a state where the blade 1011 passes through the space 1313. In this case, a mechanism for winding the second end portion 1312 can be any mechanism. The attaching device 1300 can wind the second end portion 1312 by using any mechanism. For example, the attaching device 1300 can wind the second end portion 1312 by rotating a pulley or a roller to which the second end portion 1312 is fixed. In doing so, the pulley or the roller may be built in the body 1320 of the attaching device 1300, or may be externally attached to the body 1320.

Although it was explained that the first end portion 1311 is fixed to the body 1320 and the second end portion 1312 is windable in the above-described example, the manner of the attaching mechanism 1310 is not limited thereto. For example, both the first end portion 1311 and the second end portion 1312 may be windable. For example, the band or belt may be configured to be expandable and contractable so as to tighten the blade 1011 passing through the space 1313.

Referring to FIGS. 11C and 11D again, the attaching device 1300 is moved, along with the rope holding device 1200, to a predetermined position on the wind turbine 1010 by the moving device 1400. After the attaching device is moved to the predetermined position, the attaching device 1300 is attached to the predetermined position as shown in FIG. 11D.

In this example, the predetermined position is a narrowed portion at the root of the blade 1011 of the wind turbine 1010. It is preferable that the predetermined position is on the blade that is the subject of maintenance because a rope can be positioned near the surface of the blade 1011 when the rope is extended from the attaching device 1300 as shown in, for example, FIG. 11G and the like described below. Further, it is preferable that the predetermined position is a narrowed portion of the blade because the attaching device 1300 can be attached by an expanded portion adjacent to the narrowed portion so that the attaching device would not be shifted. Further, it is preferable that the predetermined position is at the root of the blade because a rope can be extended across the entire blade 1011 when the rope is extended from the attaching device 1300 as shown in, for example, FIG. 11G and the like described below.

The attaching device 1300 can be attached to a predetermined position by using the attaching mechanism 1310. For example, the attaching device 1300 can be attached to a predetermined position on the blade 1011 by tightening the blade 1011 by the above-described band or belt which is able to tighten.

The rope holding device 1200 is moved along with the attaching device 1300. Thus, when the attaching device 1300 is attached to a predetermined position on the blade 1011, the rope holding device 1200 would be also attached to the predetermined position on the blade.

FIG. 11E shows the state of a stage of fixing a part of at least one rope 1020 to the attaching device 1300. Although it is explained in this example that a part of the at least one rope 1020 is fixed to the attaching device 1300 after the attaching device 1300 is attached to a predetermined position on the blade 1011, the timing at which a part of the at least one rope 1020 is fixed to the attaching device 1300 is not limited thereto. For example, the attaching device 1300 may be attached to a predetermined position on the blade 1011 as shown in FIGS. 11B to 11D after a part of the at least one rope 1020 is fixed to the attaching device 1300. In this case, the above-described at least one nylon string can be omitted.

For example, one rope 1020 is attached to a first end of a nylon string extending from the attaching device 1300 and the rope holding device 1200 on the blade 1011 to the deck 1016, and a second end of the nylon string is pulled, whereby the rope 1020 would pass through the attaching device 1300 and the rope holding device 1200 on the blade 1011 instead of the nylon string. Both ends of the rope 1020 would be aligned on the deck 1016 by further pulling the second end of the nylon string so that the first end of the nylon string would return to the deck 1016. As a result, two rope portions (first portion and second portion of one rope) would extend from the attaching device 1300 to the deck 1016. An example where two rope portions 1020 extend to the deck 1016 is explained below. Of course, it is understood that the present invention is not limited to utilization of two rope portions, but one rope or two or more rope portions can be utilized.

For example, the at least one rope 1020 passes through an eye bolt on the attaching device 1300 in the same manner as a nylon string, whereby a part of the at least one rope would be fixed to the attaching device 1300. In this case, “fix” refers to a state where one element does not move relative to the other element. A part of the at least one rope being fixed to the attaching device 1300 refers to a state where a part of the at least one rope does not move relative to the attaching device 1300. “Fix” includes not only permanent fixation but also temporary fixation. For example, the at least one rope passes through an eye bolt on a first side of the attaching device 1300 and winds around the eye bolt, passes through an eye bolt on a second side and winds around the eye bolt, and extends, whereby a portion of the rope extending between the eye bolt on the first side and the eye bolt on the second side would be fixed to the attaching device 1300. The manner of fixing a part of the at least one rope to the attaching device 1300 is not limited thereto. A part of the at least one rope can be fixed to the attaching device 1300 in any manner.

For example, attaching the attaching device 1300 to a predetermined position on the blade 1011 in a state where a nylon string lighter than a rope is put through the attaching device 1300, followed by replacing the nylon string with the rope to fix at least one rope to the attaching device 1300 is more advantageous than fixing a part of at least one rope to the attaching device 1300, followed by attaching the attaching device 1300 to a predetermined position on the blade 1011 as shown in FIGS. 11B to 11D in that a weight which is carried by the moving device 1400 can be reduced.

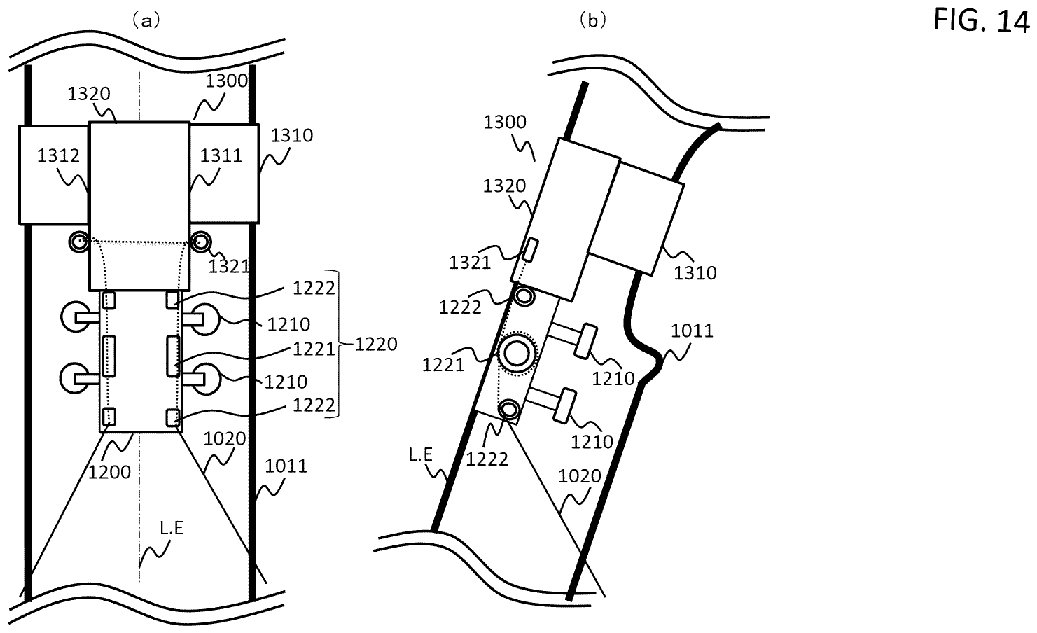

FIG. 14 shows a detail of the portion surrounded by a dashed-line circle in FIG. 11E. FIG. 14 shows a state where the attaching device 1300, to which the rope holding device 1200 is coupled, is attached to a narrowed portion of the blade 1011 on the leading edge L.E of the blade 1011. FIG. 14(a) is a figure of the leading edge L.E viewed from above while FIG. 14(b) is a figure of the leading edge L.E viewed from a side. For convenience sake, the right side of the L.E in FIG. 14(a) is referred to as the first side while the left side of the L.E is referred to as the second side.

The attaching device 1300 is attached to the narrowed portion of the blade 1011 via the attaching mechanism 1310. The attaching mechanism 1310 is a band which is able to tighten and fixed to the body 1320 at the first end portion 1311 and the second end portion 1312.

The attaching device 1300 comprises a rope fixing means 1321. The rope fixing means 1321 is shown as, but not limited to, a plurality of eye bolts. The rope fixing means 1321 can be any means as long as it can fix a part of at least one rope to the attaching device 1300. A plurality of eye bolts 1321 are disposed on both the first side and the second side of the attaching device 1300.

The rope holding device 1200 comprises a moving means 1210. The moving means 1210 is shown as, but not limited to, a wheel. The moving means 1210 can be any means as long as it enables the rope holding device 1200 to move on a blade. The wheel may be a non-driving wheel, or may be a driving wheel driven by a power source. For example, the rope holding device 1200 may be configured to move on the blade 1011 by utilizing a winch and a non-driving wheel, or may be configured to move on the blade 1011 by utilizing a driving wheel without utilizing a winch (and a rope). In the case of movement on the blade using a winch, the winch (not shown in FIG. 1) may be installed in the rope holding device 1200, or may be installed outside the rope holding device 1200 (e.g., attaching device 1300 or deck 1016). When the rope holding device 1200 is moved by utilizing a winch, for example, a rope or wire for movement which is separate from the rope 1020 can be utilized. For example, the rope or wire for movement may extend from the attaching device 1300 to the rope holding device 1200, or may extend from the deck 1016 to the rope holding device 1200 via the attaching device 1300. The winch may be an electric winch or may be a manual winch operated by a worker on the deck 1016.

The rope holding device 1200 comprises a rope connecting means 1220. The rope connecting means 1220 can comprise an engaging portion 1221 which engages with a rope and a guiding portion 1222 which guides the rope.

For example, the engaging portion 1221 can be an engaging roller driven by a driving portion. Force for delivering a rope forward or backward can be exerted on the rope by driving the engaging roller by the driving portion in a state where the rope is wound around the engaging roller. This enables the rope holding device 1200 to move along the rope. The engaging portion 1221 can be implemented by any other mechanism as long as it can achieve a similar function.

The guiding portion 1222 is any mechanism that guides a rope to the engaging portion 1221. For example, the guiding portion 1222 can be a guiding roller.

The moving means 1210 and the rope connecting means 1220 are disposed on both the first side and the second side of the attaching device 1300.

The rope 1020 enters the rope holding device 1200 from the first side of the rope holding device 1200, winds around the engaging portion 1221 through a first guiding portion 1222, and exits from the rope holding device 1200 through a second guiding portion 1222. The rope 1020 then enters the attaching device 1300 from the first side of the attaching device 1300, winds around a first eye bolt 1321, extends to a second eye bolt 1321 on the second side of the attaching device 1300, winds around the second eye bolt, and exits from the attaching device 1300. The rope 1020 then enters from the second side of the rope holding device 1200, winds around the engaging portion 1221 through the second guiding portion 1222, and exits from the rope holding device 1200 through the first guiding portion 1222. In this manner, a part of the rope 1020 is fixed by a plurality of eye bolts 1321, and the rope holding device 1200 receives the rope 1020 extending from the attaching device 1300. In FIG. 14, the portion of the rope passing inside the rope holding device 1200 and the attaching device 1300 is depicted in a broken line.

FIG. 11F shows the state of a stage of connecting two rope portions 1020 to the maintenance device 1100 on the deck 1016.

The maintenance device 1100 comprises a moving means for moving the maintenance device 1100 along the rope portions 1020. For example, the moving means is a winch. For example, the maintenance device 1100 comprises two winches, wherein one rope portion is connected to one of the two winches while the other rope portion is connected to the other of the two winches. The maintenance device 1100 can rise along the rope portions 1020 by winding the rope portions 1020 by using a winch.

Alternatively, the moving means for moving the maintenance device 1100 along the rope portions 1020 can be installed outside the maintenance device 1100. For example, the attaching device 1300 can comprise a moving means such as a winch and the attaching device 1300 winds the rope portions 1020 by using the winch, which enables the maintenance device 1100 to move along the rope portions 1020.

FIG. 11G shows the state of a stage of disposing the rope holding device 1200 in any position on the blade 1011 of a wind turbine.

Two rope portions 1020 extend from the attaching device 1300 to the rope holding device 1200. The rope holding device 1200 can receive these rope portions 1020. The two rope portions 1020 pass through the rope holding device 1200 and extend to the maintenance device 1100 on the deck 1016. The rope holding device 1200 can hold the rope portions 1020 by engaging with the rope portions 1020 passing through the rope holding device 1200.

In one example, it is preferable to move the rope holding device 1200 on the blade 1011 by utilizing a winch installed on the deck 1016 because the mechanism of the rope holding device 1200 can be simplified and the weight thereof can be reduced. This can facilitate the movement of the rope holding device 1200 by the moving device 1400. Further, the need for utilizing a large moving device 1400 is eliminated.

In another example, it is preferable to perform movement on the blade 1011 by utilizing an electric winch or by utilizing a driving wheel without utilizing a winch (and a rope) because this can eliminate the need for performing a manual winch by a worker on the deck 1016, which can reduce manpower. Further, the need for performing operation by a worker in a place which is not safe (e.g., on the sea) can also be reduced.

The rope holding device 1200 moves on the blade 1011 and stays in a position on the blade 1011, whereby the rope portions 1020 can be held in the position.

For example, the rope holding device 1200 can hold the rope portions 1020 on the blade 1011 so that the two rope portions 1020 are positioned on both sides of when the blade 1011 is divided into two by the leading edge. Specifically, the rope holding device 1200 can hold the rope portions 1020 on the blade 1011 so that a first rope portion 1020 is positioned on a first side on the blade while a second rope 1020 is positioned on a second side which is opposite to the first side across the leading edge of the blade. As a result, the two rope portions would extend from both sides of the blade 1011.

In this case, for example, when the rope holding device 1200 is positioned at the tip of the blade 1011, each of the two rope portions 1020 has a significant length by extending from the narrow portion to the tip of the wind turbine. Thus, the weight thereof is also significant. The weight of the rope holding device 1200 is reduced, whereby the rope holding device 1200 can be lighter than each of the rope portions. Thus, the rope holding device 1200 can be stably disposed on the blade 1011 by the weight of the two rope portions 1020 positioned on both sides across the leading edge of the blade 1011 and the friction between the rope holding device 1200 and the blade 1011.

After the rope holding device 1200 has moved to the right place on the blade 1011 of the wind turbine (e.g., the tip of the blade), the maintenance device 1100 is moved to the blade 1011.

FIG. 11H shows the state of a stage of moving the maintenance device 1100 onto the blade 1011 of the wind turbine 1010.

The maintenance device 1100 can move to the blade 1011 along the two rope portions 1020 extending from the rope holding device 1200 disposed on the blade 1011. As described above, for example, the maintenance device 1100 may be configured to move to the blade 1011 along the two rope portions 1020 by using a moving means such as a winch that the maintenance device 1100 comprises, or may be configured to move to the blade 1011 along the two rope portions 1020 by utilizing a moving means such as a winch that is installed outside the maintenance device 1100.

The rope holding device 1200 can move on the blade 1011 so that the spatial position of the maintenance device 1100 moving to the blade 1011 and the position of the rope holding device 1200 on the blade 1011 are in concert with each other, which can allow the position in which the two rope portions 1020 are held on the blade 1011 to be in concert with the spatial position of the maintenance device 1100. For example, the rope holding device 1200 can move on the blade so that the position of the rope holding device 1200 on the blade would be approximately right above the maintenance device 1100, thereby changing the position in which the two rope portions 1020 are held on the blade 1011. As a result, the rope portions 1020 would vertically extend from the rope holding device 1200 disposed on the blade 1011 to the maintenance device 1100, and the maintenance device 1100 can rise to the blade 1011 without the need for controlling the posture or spatial position of the maintenance device or without horizontally swinging. Further, the rope holding device 1200 holds the two rope portions in proximity to each other, whereby the rope portions along which the maintenance device 1100 rises would be also in proximity to each other. This enables the maintenance device 1100 to effectively utilize the two rope portions 1020 for rising. For example, rising along two or more rope portions enables safer and more stable rising as compared to rising along one rope.

The maintenance device 1100 rises along the rope 1020 to reach the blade 1011 as shown in FIG. 11I. This can dispose the maintenance device 1100 on the blade 1011.

The maintenance device 1100 which has reached the blade 1011 can attach to the blade 1011 by any mechanism. For example, the maintenance device 1100 may be configured to attach the blade 1011 by mechanical force, may be configured to attach to the blade 1011 by magnetic force, may be configured to attach to the blade 1011 by electric power, or may be configured to attach to the blade 1011 by pressure. A mechanism for attaching to the blade 1011 by mechanical force can be, for example, a pair of frames that are biased to hold the blade 1011 therebetween. A mechanism for attaching to the blade 1011 by pressure can be, for example, a mechanism which generates negative pressure to be stuck to the blade 1011.

When the maintenance device 1100 reaches the blade 1011, maintenance on the blade 1011 of the wind turbine is performed.

FIG. 11J shows a state where the maintenance device 1100 is moving on the leading edge of the blade 1011 along the rope portions 1020. The maintenance device 1100 can move on the blade 1011 along with the rope holding device 1200.

When the maintenance device 1100 moves along the leading edge, the maintenance device 1100 can maintain a state in which the maintenance device attaches to the blade 1011, whereby the maintenance device 1100 can move on the leading edge of the blade 1011 without floating up. Further, since the leading edge of the blade 1011 is inclined by about 5 degrees (inclined by about 1 degree to about 10 degrees in some cases) relative to the vertical direction as described above, the gravity exerted on the maintenance device 1100 acts so as to push the maintenance device 1100 against the leading edge of the blade 1011, thereby preventing the maintenance device 1100 from floating up.

The maintenance device 1100 performs maintenance on the blade 1011 while moving on the leading edge of the blade 1011. For example, the maintenance device 1100 images the surface of the leading edge by using a camera while moving on the leading edge of the blade 1011. For example, the maintenance device 1100 examines the conduction of a lightning receiving portion (receptor) by using a probe while moving on the leading edge of the blade 1011. For example, the maintenance device 1100 supplies a radio wave or a pulse signal to a lightning receiving portion (receptor) by using a probe to examine disconnection or a disconnected portion of a down conductor while moving on the leading edge of the blade 1011. For example, the maintenance device 1100 washes the surface of the leading edge by using a washing device while moving on the leading edge of the blade 1011. For example, the maintenance device 1100 polishes the surface of the leading edge by using a sander while moving on the leading edge of the blade 1011. For example, the maintenance device 1100 applies paint to the surface of the leading edge by using a paint applying device while moving on the leading edge of the blade 1011. For example, the maintenance device 1100 applies a material such as putty, adhesive, or sealant to the surface of the leading edge by using an electric gun while moving on the leading edge of the blade 1011. A hole made on the blade 1011 can be filled with an applied material. The objective of filling a hole is to cover the hole to prevent water from entering the blade 1011 and the like. Aesthetics or perfection do not need to be required.

By controlling winding and delivering by a winch, the maintenance device 1100 can move on the leading edge of the blade 1011 in a direction in which the rope 1020 extends, for example, in a direction from the tip of the blade toward the base of the blade and a direction from the base of the blade toward the tip of the blade. This enables the maintenance device 1100 to perform maintenance while reciprocatively moving on the leading edge of the blade 1011. Further, even if the maintenance device 1100 comes off the blade 1011, the rope 1020 to which the winch of the maintenance device 1100 is connected serves as a lifeline, which can prevent the maintenance device 1100 from falling down.

FIG. 11K shows a state where the rope holding device 1200 is moving on the leading edge of the blade 1011 along the rope portions 1020.

When the rope holding device 1200 moves along the leading edge, the rope holding device 1200 can maintain a state in which the rope holding device attaches to the blade 1011, whereby the rope holding device 1200 can move on the leading edge of the blade 1011 without floating up. Further, since the leading edge of the blade 1011 is inclined by about 5 degrees (inclined by about 1 degree to about 10 degrees in some cases) relative to the vertical direction as described above, the gravity exerted on the rope holding device 1200 acts so as to push the rope holding device 1200 against the leading edge of the blade 1011, thereby preventing the maintenance device 1100 from floating up.

The rope holding device 1200 performs maintenance on the blade 1011 in cooperation with the maintenance device 1100 while moving on the leading edge of the blade 1011. For example, the rope holding device 1200 images the surface of the leading edge by using a camera while moving on the leading edge of the blade 1011. For example, the rope holding device 1200 detects a signal depending on a radio wave of when a radio wave transmitted by the maintenance device 1100 is propagated in a down conductor in the blade 1011 to examine disconnection or a disconnected portion of the down conductor while moving on the leading edge of the blade 1011. For example, the maintenance device 1100 disposes a reference conductive wire approximately in parallel to a down conductor in the blade 1011 while moving on the leading edge of the blade 1011, which enables the maintenance device 1100 to examine disconnection or a disconnected portion of the down conductor.

By controlling winding and delivering by a winch, the rope holding device 1200 can move on the leading edge of the blade 1011 in a direction in which the rope 1020 extends, for example, in a direction from the tip of the blade toward the base of the blade and a direction from the base of the blade toward the tip of the blade. This enables the rope holding device 1200 to perform maintenance while reciprocatively moving on the leading edge of the blade 1011. Further, even if the rope holding device 1200 comes off the blade 1011, the rope 1020 to which the rope holding device 1200 is connected serves as a lifeline, which can prevent the rope holding device 1200 from falling down.

In this manner, maintenance on the blade 1011 of the wind turbine 1010 is performed by cooperation of the maintenance device 1100 and the rope holding device 1200. When the maintenance is complete, the system of the present invention would be retrieved from the blade 1011 of the wind turbine 1010.

FIGS. 11L to 11R show the state of a stage of retrieving the system of the present invention from the blade 1011 of the wind turbine 1010. FIGS. 11L to 11N show the state of a stage of moving the maintenance device 1100 from the blade 1011 while FIGS. 11O to 11R show the state of a stage of moving the rope holding device 1200 and the attaching device 1300 from the blade 1011.

As shown in FIG. 11L, when the rope holding device 1200 moves to the right place on the blade 1011 (e.g., the tip of the blade), the maintenance device 1100 would be moved from the blade 1011. The maintenance device 1100 can go down along the rope portions 1020 held by the rope holding device 1200. The maintenance device 1100 can be positioned vertically beneath the rope holding device 1200.

As shown in FIGS. 11L to 11N, the rope holding device 1200 can move on the blade 1011 so that the spatial position of the maintenance device 1100 moving from the blade 1011 and the position of the rope holding device 1200 on the blade 1011 are in concert with each other, which can allow the position in which the two rope portions 1020 are held on the blade 1011 to be in concert with the spatial position of the maintenance device 1100. For example, when the rope holding device 1200 moves on the blade 1011 in a direction towards the root (the diagonally upper right direction in the figures of FIGS. 11L and 11M), the maintenance device 1100 also moves in the diagonally upper right direction in FIGS. 11L and 11M so that the position of the maintenance device 1100 would be approximately right below the rope holding device 1200. This can maintain vertical alignment of the rope holding device 1200 disposed on the blade 1011 and the maintenance device 1100, which enables the maintenance device 1100 to go down from the blade 1011 without the need for controlling the posture or spatial position of the maintenance device or without horizontally swinging. Further, the rope holding device 1200 holds the two rope portions in proximity to each other, whereby the rope portions along which the maintenance device 1100 goes down would be also in proximity to each other. This enables the maintenance device 1100 to effectively utilize the two rope portions 1020 for going down. For example, going down along two or more rope portions enables safer and more stable rising as compared to going down along one rope.

By causing the maintenance device 1100 to go down while controlling the position of the rope holding device 1200 on the blade 1011, the maintenance device 1100 reaches the deck 1016 as shown in FIG. 11N. When the maintenance device 1100 reaches the deck 1016, the rope portions 1020 are removed from the maintenance device 1100. Furthermore, the rope portions 1020 are also removed from the rope holding device 1200 and the attaching device 1300. The rope portions 1020 are removed from the rope holding device 1200 and the attaching device 1300 in any manner. For example, the rope portions 1020 may be removed from the rope holding device 1200 and the attaching device 1300 by replacing the rope portions 1020 with a nylon string in the same manner as the above-described replacement of a nylon string with a rope (instead, a nylon string may be connected to the rope holding device 1200 and the attaching device 1300). Alternatively, for example, the rope holding device 1200 and the attaching device 1300 are coupled by any mechanism, followed by pulling one end of the rope portions 1020 (connected to the maintenance device 1100), whereby the other end of the rope portions 1020 (connected to the maintenance device 1100) passes through the rope holding device 1200 and the attaching device 1300 and comes off.

Next, the moving device 1400 is coupled to the attaching device 1300 as shown in FIG. 11O. The moving device 1400 can be coupled to the attaching device 1300 by any means. For example, the moving device 1400 may be coupled to the attaching device 1300 by mechanical force, may be coupled to the attaching device 1300 by magnetic force, may be coupled to the attaching device 1300 by electric power, or may be coupled to the attaching device 1300 by pressure or suction force. The moving device 1400 is a device which moves the attaching device 1300 and the rope holding device 1200 from the blade to the deck. The moving device 1400 can be, but is not limited to, a moving device which is able to fly such as a drone. The moving device can be any means as long as it can move the attaching device 1300 and the rope holding device 1200 from the blade. The moving device 1400 may be the same device as or a different device from the moving device used for moving the attaching device 1300 and the rope holding device 1200 to the blade. The moving device is preferably the same device because using the same device can prevent additional costs from being incurred.

Next, attachment to the blade 1011 by the attaching mechanism 1310 is released as shown in FIG. 11P. For example, attachment to the blade 1011 by the attaching mechanism 1310 is released by releasing tightening of the attaching mechanism 1310 which is a band or belt which is able to tighten. For example, the attaching device 1300 can release tightening of the attaching mechanism 1310 by rotating a pulley or roller to which the second end portion 1312 is fixed to deliver the second end portion 1312. Alternatively, for example, the attaching device 1300 can release tightening of the attaching mechanism 1310 by separating the first end portion 1311 or the second end portion 1312 from the body 1320. The attaching device 1300 can separate the first end portion 1311 or the second end portion 1312 from the body 1320 by any mechanism.

Next, the attaching device 1300 is moved, along with the rope holding device 1200, from a predetermined position on the blade 1011 by the moving device 1400 as shown in FIGS. 11Q and 11R. The attaching device 1300 is then moved to the deck 1016 along with the rope holding device 1200.

In this manner, the maintenance device 1100 and the rope holding device 1200 and the attaching device 1300 are retrieved from the blade 1011 of the wind turbine 1010. After the maintenance device 1100 and the rope holding device 1200 and the attaching device 1300 are retrieved from the blade 1011 of the wind turbine 1010, the blades 1011, 1012, and 1013 are rotated so that the blade 1012 or 1013 that is the next subject of maintenance is positioned to extend vertically downwards. In a state where the blade 1012 or 1013 that is the next subject of maintenance is positioned to extend vertically downwards, maintenance on the blade is performed in the same procedure as FIGS. 11B to 11R. This can be repeated until maintenance on every blade that is the subject of maintenance is complete.

By using the system of the present invention, it is possible to safely and easily perform maintenance on a blade of a wind turbine even when the wind turbine is a wind turbine without a sufficient scaffold such as the wind turbine 1010 on the sea. For example, since a rope can be placed on a wind turbine by the attaching device 1300, a worker does not need to attach a rope.

Although it was explained in this example that the rope 1020 is removed from the attaching device 1300 before moving the attaching device 1300 from a predetermined position on the blade 1011, the timing at which the rope 1020 is removed from the attaching device 1300 is not limited thereto. For example, the rope 1020 may be removed from the attaching device 1300 after moving the attaching device 1300 from a predetermined position on the blade 1011 to the deck 1016 as shown in FIGS. 11O to 11R. However, the rope 1020 is preferably removed from the attaching device 1300 before moving the attaching device 1300 from a predetermined position on the blade 1011 because the weight carried by the moving device 1400 can be reduced by removing the rope 1020 from the attaching device 1300, which eliminates the need for utilizing a large moving device 1400. This can lead to easy maintenance.

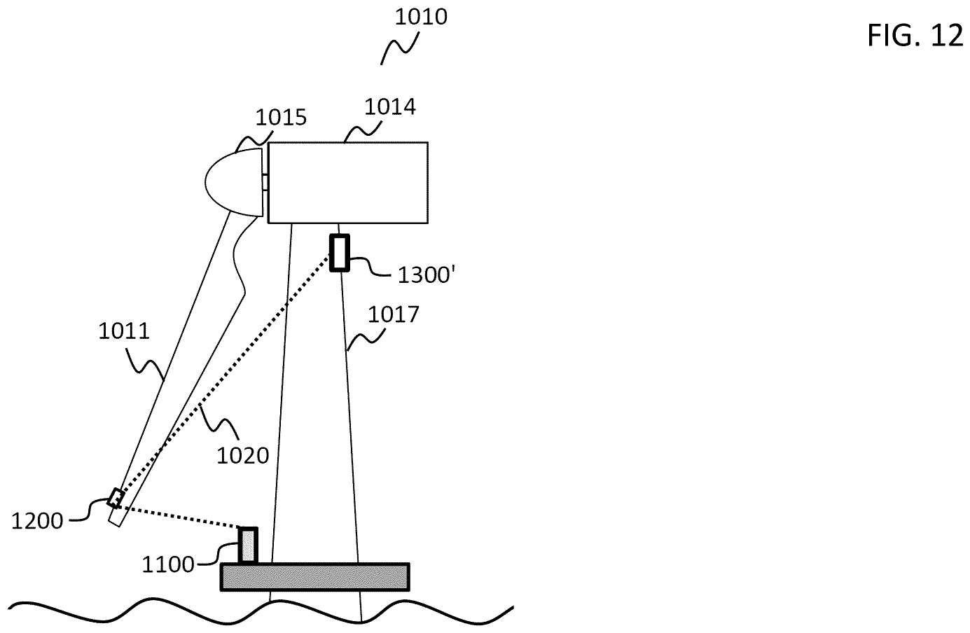

Although it was explained in the above example that the attaching device 1300 is moved to a predetermined position on the blade 1011 and the attaching device 1300 is attached to the predetermined position, the attaching device 1300 can be moved to any position on the wind turbine 1010 and attached to any position. For example, the attaching device can be attached to a predetermined position on a tower 1017 of the wind turbine 1010 as shown in FIG. 12.

FIG. 12 shows an example of attaching a rope to a predetermined position on the tower 1017 of the wind turbine 1010 by using an attaching device 1300′ in an alternative embodiment. As one example, FIG. 12 shows the state of a stage of disposing the same rope holding device 1200 as that in FIG. 11G in any position on the blade 1011 of the wind turbine.

In this example, the moving device 1400 can move the attaching device 1300′ to a predetermined position on the tower 1017, and the moving device 1400 can separately move the rope holding device 1200 to any position on the blade 1011, whereby at least one rope extending from the attaching device 1300′ is held on the blade by the rope holding device 1200.

The attaching device 1300′ can be attached to a predetermined position on the tower 1017 of the wind turbine 1010 by any means. For example, the attaching device 1300′ may be attached by mechanical force, may be attached by magnetic force, may be attached by electric power, or may be attached by pressure or suction force.

When at least one rope is held by the rope holding device 1200 in any position on the blade 1011, maintenance on the blade 1011 is performed in the same manner as FIGS. 11H to 11K.

After maintenance is performed, the attaching device 1300′ and the rope holding device 1200 would be separately retrieved.

The procedure that was explained while referring to FIGS. 11A to 11R is more advantageous than the procedure of the alternative embodiment that was explained while referring to FIG. 12 at least in terms of the following points.

First, in the procedure that was explained while referring to FIGS. 11A to 11R, both the rope holding device 1200 and the attaching device 1300 can be moved to a position on the blade 1011 of the wind turbine 1010 in one step, which can contribute to prompt positioning of the rope holding device 1200 and the attaching device 1300 on the blade 1011. For example, from the experience of the inventors of the present invention, it took at least one hour for a worker to perform an operation of attaching a rope onto a nacelle of a wind turbine. It took more time when the wind turbine was a wind turbine on the sea. On the other hand, the inventors of the present application found that the operation of attaching a rope can be completed in a very short period of time (e.g., about 5 minutes) by moving both the rope holding device 1200 and the attaching device 1300 to a position on a blade of a wind turbine by the moving device 1400, a device which is able to fly, and attaching the attaching device 1300 to the position.

Secondly, in the procedure that was explained while referring to FIGS. 11A to 11R, the operation of attaching a rope can be completed in a very short period of time even in a place without a sufficient scaffold such as a wind turbine on the sea in the same manner as a place with a sufficient scaffold because the moving device 1400, a device which is able to fly, is used. Furthermore, since a rope does not need to be manually attached by a human, maintenance on a wind turbine can be safely performed even in a place without a sufficient scaffold such as a wind turbine on the sea.

Thirdly, in the procedure that was explained while referring to FIGS. 11A to 11R, it is not necessary to cause the rope holding device 1200 alone to approach a blade because, if the attaching device 1300 is mounted on the blade, the rope holding device 1200 would be also simultaneously mounted on the blade. In particular, causing a relatively small rope holding device 1200 to approach a blade requires a skilled technique, which is difficult. However, the procedure that was explained while referring to FIGS. 11A to 11R does not require such a skilled technique and has a minimum risk that the rope holding device 1200 comes into contact with the blade while approaching the blade and breaks the blade.

Fourthly, in the procedure that was explained while referring to FIGS. 11A to 11R, both the rope holding device 1200 and the attaching device 1300 can be also retrieved from the blade 1011 of the wind turbine 1010 in one step, which can reduce the operation time for maintenance.

Although it was explained that maintenance is performed on a blade of a wind turbine by using one maintenance device 1100 in the above example, maintenance can be also performed on a blade of a wind turbine by using a plurality of maintenance devices 1100.

Although it was explained that one rope holding device 1200 is used in the above example, the number of rope holding devices 1200 can be any number of 1 or greater. For example, two rope holding devices 1200, three rope holding devices 1200, or four or more rope holding devices 1200 can be used. Furthermore, although it was explained that two rope portions 1020 are used in the above example, the present invention is not limited thereto. The present invention can perform maintenance on a blade of a wind turbine by using at least one rope.

According to the maintenance method that was explained while referring to FIGS. 11A to 11R and FIG. 12, the maintenance device 1100 can be easily disposed on the blade 1011. The maintenance device 1100 can reach the blade 1011 and land on the blade 1011 only by following a rope held by the rope holding device 1200. In this case, when landing on the blade 1011, the posture of the maintenance device 1100 does not need to be finely controlled. This is because the maintenance device 1100 can be guided to a suitable landing position on the blade 1011 by the rope held by the rope holding device 1200. This can simplify or omit a mechanism for landing that the maintenance device 1100 should have. Further, since landing is easy, manpower upon landing can be reduced. Furthermore, since it is not necessary to finely control the posture upon landing, even when the weight of the maintenance device is increased, the difficulty in landing would be less affected. Thus, it is possible to install many functions on the maintenance device to cause the maintenance device to perform many types of maintenance at once. This leads to more efficient maintenance.

### 5. Configuration of a System for Performing Maintenance on a Blade of a Wind Turbine

The system for performing maintenance on a blade of a wind turbine of the present invention comprises a maintenance device 1100, a rope holding device 1200, and an attaching device 1300. The system can comprise any number of maintenance devices 1100, any number of rope holding devices 1200, and any number of attaching devices 1300. The system can also comprise a moving means 1400.

The maintenance device 1100 can have any configuration as long as it is configured to perform maintenance on a blade of a wind turbine, move to the blade on a rope, and move on the blade.

The maintenance device 1100 can comprise any means for performing maintenance. For example, the means for performing maintenance can comprise at least one of an imaging means, a conduction examining means, a disconnection examining means, a washing means, a polishing means, a grinding means, and an applying means.

The imaging means can be any camera that is able to image a still picture or movie of an object.

The conduction examining means can be any means that is able to examine whether current flows in a conducting portion on the surface of an object. For example, the conduction examining means comprises a probe that is able to examine whether current flows in a lightning receiving portion provided to a blade of a wind turbine.

The disconnection examining means can be any means that is able to examine whether a conductive wire extending inside an object (e.g., a down conductor of a blade of a wind turbine) is disconnected, or where the disconnected portion is. For example, the disconnection examining means comprises a transceiver which is able to transmit a pulse signal to a receptor of a down conductor and detect a reflected waveform thereof. For example, the disconnection examining means comprises a probe which is able to supply a radio wave to a receptor of a down conductor. In doing so, a transmitter which actually generates a radio wave may be installed in the maintenance device 1100, or may be installed outside the maintenance device 1100 (e.g., a deck of a wind turbine). Further, the rope holding device 1200 can comprise a detector which detects a signal in response to a radio wave supplied via the disconnection examining means.

The washing means can be any means that is able to wash an object. For example, the washing means may be a mechanism that uses washing liquid and rag to wipe off dirt. When such a mechanism is used to wash the blade 1011 of the wind turbine 1010 while moving on the blade 1011 of the wind turbine 1010 as shown in FIG. 11J, washing is performed by the maintenance device 1100 moving on the blade while pushing the rag against the blade.

The polishing means can be any means that is able to polish an object. For example, the polishing means may be a mechanism that uses a sandpaper, a grinder, a disk grinder or the like to perform polishing. When a sandpaper, a grinder, or a disk grinder is used to polish the blade 1011 of the wind turbine 1010 while moving on the blade 1011 of the wind turbine 1010 as shown in FIG. 11J, polishing is performed by the maintenance device 1100 moving on the blade while pushing the sandpaper or rotating grinder against the blade.

The grinding means can be any means that is able to grind an object. For example, the grinding means may be a mechanism that uses a leutor (or hand grinder or precision grinder), a belt sander or the like to perform grinding. For example, the grinding means can grind the surface of the blade 1011 by pushing a leutor or a belt sander against the blade 1011 of the wind turbine 1010.

The applying means can be any means that is able to apply a material to an object. Examples of the material applied by the applying means include paint, putty, adhesive, and sealant. For example, the applying means may be a spraying device that is able to spray paint. When such a spraying device is used to apply paint to the blade 1011 of the wind turbine 1010 while moving on the blade 1011 of the wind turbine 1010 as shown in FIG. 11J, the paint is applied by the maintenance device 1100 moving on the blade while spraying the paint from the spraying device. For example, the applying means may be a caulking gun that is able to extrude putty, adhesive, sealant or the like. When such a caulking gun is used to apply a material such as putty, adhesive, or sealant to the blade 1011 of the wind turbine 1010 while moving on the blade 1011 of the wind turbine 1010 as shown in FIG. 11J, the material is applied by identifying a portion to which the material should be applied with the imaging means or the like in advance, moving the maintenance device 1100 on the blade 1011, and extruding the material when the maintenance device reaches the portion to which the material should be applied.

It should be noted that the means for performing maintenance is not limited to the imaging means, the conduction examining means, the disconnection examining means, the washing means, the polishing means, the grinding means, and the applying means. The maintenance device 1100 may comprise another means for performing maintenance instead of or in addition to the above-described means.

For example, the maintenance device 1100 can comprise a communicating means. It is thereby possible to receive a signal from the outside of the maintenance device 1100 and transmit a signal to the outside of the maintenance device 1100. The communication means may receive a signal from the outside of the maintenance device 1100 wirelessly or by wire. The communication means may transmit a signal to the outside of the maintenance device 1100 wirelessly or by wire. For example, the communicating means can receive a signal for controlling each action of the maintenance device 1100 from the outside of the maintenance device 1100 (e.g., a terminal for operation used by an operator). For example, the communicating means can transmit image data obtained by the imaging means to the outside of the maintenance device 1100 (e.g., a terminal for operation used by an operator). For example, the communicating means can transmit a signal indicating the spatial position of the maintenance device 1100 to the rope holding device 1200. For example, the communicating means can receive a signal indicating the position of the rope holding device 1200 on a blade from the rope holding device 1200.

Although it was explained that each action of the maintenance device 1100 is controlled in accordance with a signal from the outside of the maintenance device 1100, the present invention is not limited thereto. For example, a program for realizing a series of actions for performing maintenance on a blade may be stored in a memory of the maintenance device 1100. A processor of the maintenance device 1100 can read out and execute the program to cause the maintenance device 1100 to function as a device automatically performing maintenance on a blade.

The maintenance device 1100 comprises a moving means that enables the maintenance device 1100 to move along a rope. The moving means also enables the maintenance device 1100 to move on a blade. For example, the moving means comprises a winch that enables the maintenance device 1100 to move along a rope. For example, the moving means comprises a wheel that enables the maintenance device 1100 to move on a blade. While the wheel can be a non-driving wheel, the wheel may be a driving wheel driven by a power source. For example, the maintenance device 1100 may be configured to move on a blade by using a winch and a non-driving wheel, or may be configured to move on a blade by using a driving wheel without utilizing a winch (and a rope).

Although an example in which the maintenance device 1100 can comprise a means for performing maintenance, a communicating means, a memory, a processor, and a moving means was explained in the above-described examples, the present invention is not limited thereto. A system in which at least one of the components of the maintenance device 1100 is positioned outside the body of the maintenance device 1100 is also within the scope of the present invention. For example, the attaching device 1300 may comprise a winch instead of the maintenance device 1100 comprising a winch. In this case, the maintenance device 1100 may be configured so that a rope extending from the winch of the attaching device 1300 is fixed to the maintenance device 1100 and the winch of the attaching device 1300 winds or delivers the rope, whereby the maintenance device 1100 moves to the blade 1011 or on the blade 1011.

The rope holding device 1200 can have any configuration as long as it is configured to receive at least one rope extending from the attaching device 1300, hold the at least one rope in any position on a blade of a wind turbine, and be able to move on the blade.

As described above while referring to FIG. 14, the rope holding device 1200 comprises a moving means 1210 and a rope connecting means 1220.

The moving means 1210 can be any means as long as it enables the rope holding device 1200 to move on a blade. For example, the moving means 1210 may be a wheel or a continuous track or the like, or may be a combination of a winch and a wheel or a continuous track.

The rope connecting means 1220 can be any means as long as it enables a rope to be connected to the rope holding device 1200. The rope connecting means 1220 can comprise an engaging portion 1231 which engages with a rope and a guiding portion 1232 which guides the rope.

The engaging portion 1231 can be an engaging roller driven by a driving portion as shown in FIG. 14. Force for delivering a rope forward or backward can be exerted on the rope by driving the engaging roller by the driving portion in a state where the rope is wound around the engaging roller. This enables the rope holding device 1200 to move along the rope. The engaging portion 1231 can be implemented by any other mechanism as long as it can achieve a similar function.

The guiding portion 1232 is any mechanism that guides a rope to the engaging portion 1231. For example, the guiding portion 1232 can be a guiding roller.

For example, the rope holding device 1200 can further comprise a controlling unit and a communicating unit.

The controlling unit is configured to control the overall action of the rope holding device 1200. For example, the controlling unit can control the components of the rope holding device 1200 in accordance with a control signal received by the communicating unit. For example, the controlling unit can drive the rope connecting means 1220 and move along a connected rope in accordance with a control signal received by the communicating unit. For example, the controlling unit can drive the moving means 1210 and move on a blade in accordance with a control signal received by the communicating unit.

For example, a controlling unit 1210 can be implemented by any controlling means such as one or more processors.

Although it was explained that each component of the rope holding device 1200 is controlled in accordance with a signal from the outside of the rope holding device 1200, the present invention is not limited thereto. For example, a program for realizing a series of actions of each component of the rope holding device 1200 may be stored in a memory that the rope holding device 1200 can comprise. The controlling unit 1210 can read out and execute the program to cause the rope holding device 1200 to function as an autonomous device.

The communicating unit can receive a signal from the outside of the rope holding device 1200. In addition, the communicating unit may be also configured to transmit a signal to the outside of the rope holding device 1200. The communicating unit may receive a signal from the outside of the rope holding device 1200 wirelessly or by wire. The communicating unit may transmit a signal to the outside of the rope holding device 1200 wirelessly or by wire. For example, the communicating unit can receive a control signal for controlling each component of the rope holding device 1200 from the outside of the rope holding device 1200 (e.g., a terminal for operation used by an operator, the maintenance device 1100, or the attaching device 1300). For example, a signal indicating the position of the rope holding device 1200 on a blade can be transmitted to the maintenance device 1100. For example, the communicating means can receive a signal indicating the spatial position of the maintenance device 1100 from the maintenance device 1100. For example, the communicating unit can be implemented by any communicating means such as an antenna.

The rope holding device 1200 can further comprise a camera. A camera can be any camera that is able to image a still picture or movie of an object. A still picture or movie imaged by a camera can be utilized, for example, to examine the state of the surface of a blade, to identify the position of the rope holding device 1200 on a blade, or to identify the position of the maintenance device 1100 relative to the rope holding device 1200. Alternatively, a still picture or movie imaged by a camera can be utilized to confirm a display screen of a detector described below.

The rope holding device 1200 can further comprise a detector which detects a signal in response to a radio wave transmitted via the disconnection examining means of the maintenance device 1100. For example, a detector can detect a signal depending on a radio wave transmitted to a down conductor of a blade. Since a detected signal is different between a disconnected portion and a non-disconnected portion or a signal cannot be detected in a non-disconnected portion, it is possible to examine the presence or absence of disconnection or detect a disconnected portion based on an output from a detector. For example, a detector can detect disconnection in a down conductor by utilizing the same principle as that of a buried cable searcher which can search for a cable buried in the ground.

The rope holding device 1200 can further comprise a reference conductive wire which can be disposed on a blade. A reference conductive wire extends between the rope holding device 1200 and the attaching device 1300. The rope holding device 1200 moves from the attaching device 1300 toward the tip of a blade, which enables the rope holding device 1200 to dispose a reference conductive wire on the blade. In this case, a conductive wire extends inside the blade, and the disposed reference conductive wire can be approximately parallel to the conductive wire. In this case, “approximately parallel” refers to an angle formed by two straight lines being ±5°.

In this manner, the rope holding device 1200 can have a minimum configuration which can realize a function for receiving at least one rope extending from the attaching device 1300, holding the at least one rope in any position on a blade of a wind turbine, and moving on the blade. This can reduce the weight of the rope holding device 1200. For example, the rope holding device 1200 may have a weight of about 2 kg or less, may have a weight of about 1.5 kg or less, or may have a weight of about 1 kg or less. It is preferable to reduce the weight of the rope holding device 1200 as much as possible by mounting bare minimum components because it facilitates movement by the moving device 1400.

For example, the weight of the rope holding device 1200 is preferably less than at least one rope stretched over a blade. For example, since at least one rope stretched over a blade has a weight of about 5 kg, the rope holding device 1200 preferably has a weight of less than about 5 kg, for example, a weight of about 2 kg.

The weight of the rope holding device 1200 is less than the weight of the maintenance device 1100. For example, the ratio of the weight of the rope holding device 1200 to the weight of the maintenance device 1100 can be about 1:10, about 1:20, about 1:50, about 1:100 or the like. Preferably, the ratio of the weight of the rope holding device 1200 to the weight of the maintenance device 1100 can be about 1:20 to about 1:50.

For example, the rope holding device 1200 preferably has a small size. For example, the rope holding device 1200 can have a volume of less than about 30000 cm³, a volume of less than about 25000 cm³, a volume of less than about 20000 cm³, a volume of less than about 15000 cm³, a volume of less than about 10000 cm³, a volume of less than about 5000 cm³, a volume of less than about 3000 cm³, or a volume of less than about 1000 cm³. Preferably, the rope holding device 1200 can have a volume of about 2000 cm³ to about 4000 cm³.

For example, the ratio of the size (volume) of the rope holding device 1200 to the size (volume) of the maintenance device 1100 can be about 1:10, about 1:20, about 1:50, about 1:60, about 1:100, about 1:150, about 1:200, about 1:220 or the like. Preferably, the ratio of the size of the rope holding device 1200 to the size of the maintenance device 1100 can be about 1:60 to about 1:220.

The attaching device 1300 can have any configuration as long as it is attached to a predetermined position on a blade of a wind turbine and configured so that a part of at least one rope is fixed thereto.

As described above while referring to FIG. 13, the attaching device 1300 comprises an attaching mechanism 1310 and a body 1320.

The attaching mechanism 1310 can be any mechanism as long as it enables the attaching device 1300 to attach to the blade 1011. For example, the attaching mechanism 1310 may be a mechanism which attaches the attaching device 1300 to the blade 1011 by mechanical force, may be a mechanism which attaches the attaching device 1300 to the blade 1011 by magnetic force, may be a mechanism which attaches the attaching device 1300 to the blade 1011 by electric power, or may be a mechanism which attaches the attaching device 1300 to the blade 1011 by pressure or suction force. Preferably, the attaching mechanism 1310 can be a mechanism which attaches the attaching device 1300 to the blade 1011 by mechanical force.

In one example, the attaching mechanism 1310 can be a band or a belt which is able to tighten. For example, a first end portion of the attaching mechanism 1310 can be fixed to the body 1320 while a second end portion can be coupled to the body 1320 in a windable manner. Alternatively, for example, both the first end portion and the second end portion may be windable. A band or a belt which is able to tighten is preferable in that the attaching device 1300 can be attached onto a blade with an easy mechanism or structure.

The body 1320 can further comprise a controlling unit and a communicating unit.

The controlling unit is configured to control the overall action of the attaching device 1300. For example, the controlling unit can control the components of the attaching device 1300 in accordance with a control signal received by the communicating unit. For example, the controlling unit can drive the attaching mechanism 1310 and attach the attaching device 1300 to a predetermined position in accordance with a control signal received by the communicating unit. For example, the controlling unit can drive the attaching mechanism 1310 and release the attaching device 1300 from a predetermined position in accordance with a control signal received by the communicating unit.

For example, the controlling unit can be implemented by any controlling means such as one or more processors. The attaching device 1300 may be configured so that each component of the attaching device 1300 is controlled in accordance with a signal from the outside of the attaching device 1300, or a program for realizing a series of actions of each component of the attaching device 1300 may be stored in a memory that the attaching device 1300 can comprise. The controlling unit can read out and execute the program to cause the attaching device 1300 to function as an autonomous device.

The communicating unit can receive a signal from the outside of the attaching device 1300. In addition, the communicating unit may be also configured to transmit a signal to the outside of the attaching device 1300. The communicating unit may receive a signal from the outside of the attaching device 1300 wirelessly or by wire. The communicating unit may transmit a signal to the outside of the attaching device 1300 wirelessly or by wire. For example, the communicating unit can receive a control signal for controlling each component of the attaching device 1300 from the outside of the attaching device 1300 (e.g., a terminal for operation used by an operator, the maintenance device 1100, or the rope holding device 1200). For example, the communicating unit can be implemented by any communicating means such as an antenna.

The body 1320 comprises a fixing means for fixing a part of at least one rope. The fixing means can be any means as long as it can fix a part of at least one rope. For example, the fixing means is at least one eye bolt, and a part of at least one rope can be fixed by winding the rope around the at least one eye bolt.

The moving means 1400 can be any means as long as it can at least move the attaching device 1300 to a predetermined position on a wind turbine. For example, the moving means 1400 can be a device which is able to fly such as a drone. Alternatively, for example, the moving means 1400 can be a device having an expandable and contractable structure (e.g., crane or ladder truck). Alternatively, the moving means 1400 can be a moving means that the attaching device 1300 comprises (e.g., wheel, continuous track or the like). For example, the predetermined position can be a position on a blade of a wind turbine, preferably a position at the root of a blade of a wind turbine or a position on a narrowed portion, and further preferably a position on a narrowed portion at the root of a blade of a wind turbine. Alternatively, for example, the predetermined position can be a position on a tower of a wind turbine, preferably a top end of a tower of a wind turbine.

The moving means 1400 can preferably move the attaching device 1300 and the rope holding device 1200 together to a predetermined position. This is advantageous at least in terms of the following points.

First, both the at least one rope holding device 1200 and the at least one attaching device 1300 can be moved to a position on the blade 1011 of the wind turbine 1010 in one step, which can contribute to prompt positioning of the at least one rope holding device 1200 and the at least one attaching device 1300 on the blade 1011. For example, the operation of attaching a rope can be completed in a very short period of time by moving both the at least one rope holding device 1200 and the at least one attaching device 1300 to a position on a blade of a wind turbine by the moving means 1400, a device which is able to fly, and attaching the at least one attaching device 1300 to the position.

Secondly, it is not necessary to cause the at least one rope holding device 1200 alone to approach a blade because, if the at least one attaching device 1300 is mounted on the blade, the at least one rope holding device 1200 would be also simultaneously mounted on the blade. In particular, causing a relatively small rope holding device 1200 to approach a blade requires a skilled technique, which is difficult. However, moving the attaching device 1300 and the rope holding device 1200 together to a predetermined position does not require such a skilled technique and has a minimum risk that the at least one rope holding device 1200 comes into contact with the blade while approaching the blade and breaks the blade.

Thirdly, both the at least one rope holding device 1200 and the at least one attaching device 1300 can be also retrieved from the blade 1011 of the wind turbine 1010 in one step, which can reduce the operation time for maintenance.

Although it was explained in the above-described example that the system of the present invention comprises a maintenance device 1100, at least one rope holding device 1200, and at least one attaching device 1300 and can also comprise a moving means 1400, the system of the present invention may be composed of a part of these components, and a component other than these components may be added.

For example, in one embodiment, the system of the present invention can be composed of the maintenance device 1100 and the at least one attaching device 1300 among the above-described components. In this embodiment, the at least one attaching device 1300 would hold at least one rope on a blade.

For example, in one embodiment, the system of the present invention can be composed of the at least one rope holding device 1200 and the at least one attaching device 1300 among the above-described components. In this embodiment, the system of the present invention is considered as a system for supporting maintenance on a blade. In other words, in this embodiment, the system of the present invention can support maintenance on a blade by providing a rope for accessing the blade onto the blade for not only the maintenance device described herein but also other maintenance devices.

Alternatively, in this embodiment, a maintenance function can be imparted to at least one of the at least one rope holding device 1200 and the at least one attaching device 1300, which can perform maintenance on a blade by the at least one rope holding device 1200 and the at least one attaching device 1300.

### 6. Method for Performing Maintenance on a Blade of a Wind Turbine

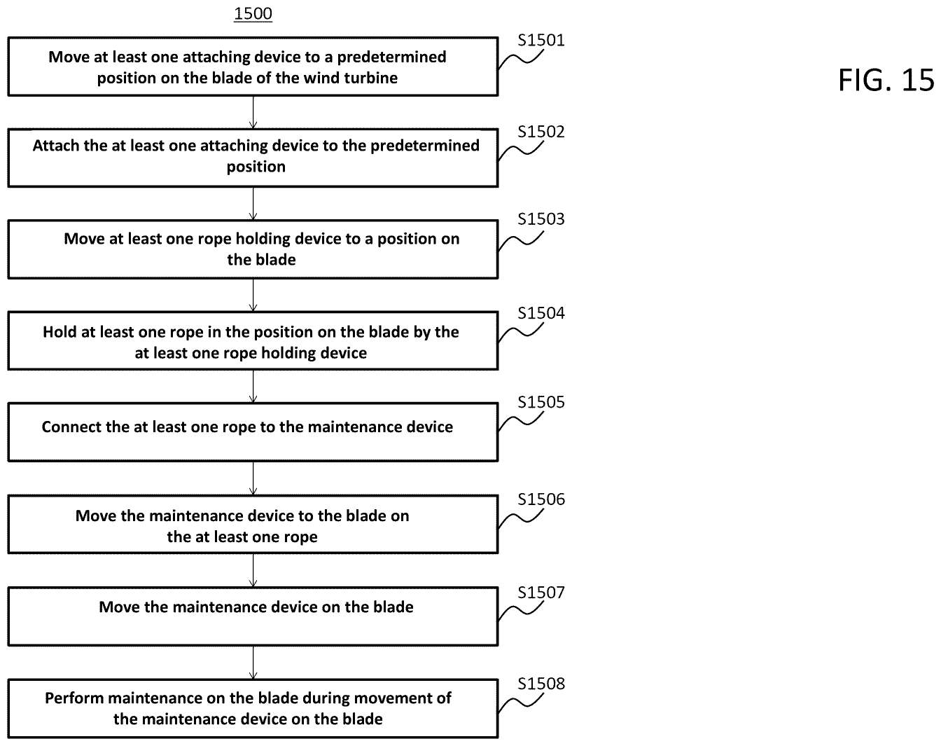

FIG. 15 shows one example of a procedure (procedure 1500) of a method for performing maintenance on a blade of a wind turbine by using the system of the present invention.

Step S1501 is a step of moving at least one attaching device 1300 to a predetermined position on the wind turbine 1010. In this case, the at least one attaching device 1300 is moved to a predetermined position in any manner. The movement may be active movement by the at least one attaching device 1300 or may be passive movement by the at least one attaching device 1300. Preferably, the moving means 1400 can move the at least one attaching device 1300.

For example, the predetermined position can be a position on the blade 1011 of the wind turbine 1010, preferably a position at the root of the blade 1011 of the wind turbine 1010 or a position on a narrowed portion, and further preferably a position on a narrowed portion at the root of the blade 1011 of the wind turbine 1010. Alternatively, for example, the predetermined position can be a position on the tower 1017 of the wind turbine 1010, preferably a top end of the tower 1017 of the wind turbine 1010.

Step S1502 is a step of attaching the at least one attaching device 1300 which has been moved to the predetermined position to the predetermined position. The at least one attaching device 1300 can be attached to the predetermined position by the attaching mechanism 1310. For example, a controlling unit of the at least one attaching device 1300 controls the attaching mechanism 1310, whereby the at least one attaching device 1300 can be attached to the predetermined position. For example, the controlling unit may be configured to control the attaching mechanism 1310 in accordance with an instruction stored in a memory or may be configured to control the attaching mechanism 1310 in accordance with an instruction from a worker.

A part of at least one rope only needs to be fixed to the at least one attaching device 1300 before step S1503. A part of the at least one rope is fixed to the at least one attaching device 1300 at any timing. For example, a part of the at least one rope may be fixed to the at least one attaching device 1300 before step S1501 or may be fixed to the at least one attaching device 1300 after step S1502. At least before step S1503, the at least one rope extends from the at least one attaching device 1300 to the at least one rope holding device 1200, and the at least one rope holding device 1200 would receive the rope. Attachment of the at least one rope to the wind turbine 1010 is complete by performing both fixation of a part of the at least one rope to the at least one attaching device 1300 and attachment of the at least one attaching device 1300 to a predetermined position of the wind turbine 1010.

In one embodiment, the moving means 1400 can move the at least one attaching device 1300 to a predetermined position along with the at least one rope holding device 1200 at step S1501 and attach the at least one attaching device 1300 to the predetermined position at step S1502. In this case, the predetermined position is a position on the blade 1011 of the wind turbine 1010. Further, the moving means 1400 can be a device which is able to fly. This can move both the at least one rope holding device 1200 and the at least one attaching device 1300 to a position on the blade 1011 of the wind turbine 1010 in one step and can attach the at least one attaching device 1300 to the position as shown in FIGS. 11B to 11D. This can contribute to prompt positioning of the at least one rope holding device 1200 and the at least one attaching device 1300 on the blade 1011. For example, from the experience of the inventors of the present invention, it took at least one hour for a human to perform an operation of manually attaching a rope onto a nacelle of a wind turbine. It took more time when the wind turbine was a wind turbine on the sea. On the other hand, the inventors of the present application found that the operation of attaching a rope can be completed in a very short period of time (e.g., about 5 minutes) by moving both the at least one rope holding device 1200 and the at least one attaching device 1300 to a position on a blade of a wind turbine by the moving means 1400, a device which is able to fly, and attaching the at least one attaching device 1300 to the position. The operation of attaching a rope can be completed in a very short period of time even in a place without a sufficient scaffold such as a wind turbine on the sea in the same manner as a place with a sufficient scaffold because the moving means 1400, a device which is able to fly, is used. The time required for maintenance on a wind turbine can be greatly reduced by reducing the operation time for the operation of attaching a rope. Furthermore, since a rope does not need to be manually attached by a human, maintenance on a wind turbine can be safely performed even in a place without a sufficient scaffold such as a wind turbine on the sea.

Step S1503 is a step of moving the at least one rope holding device 1200 to any position on the blade 1011. In this regard, the rope holding device 1200 is moved to any position on the blade 1011 in any manner. The movement may be active movement by the at least one rope holding device 1200 or may be passive movement by the at least one rope holding device 1200. For example, a controlling unit of the at least one rope holding device 1200 controls the rope connecting means 1220, which can move the at least one rope holding device 1200. For example, the controlling unit may be configured to control the rope connecting means 1220 in accordance with an instruction stored in a memory or may be configured to control the rope connecting means 1220 in accordance with an instruction from a worker.

For example, when only the at least one attaching device 1300 was moved to a predetermined position at step S1501, the at least one rope holding device 1200 needs to be moved to the blade 1011 at step S1503. For example, the at least one rope holding device 1200 can move to the blade 1011 along a rope which can extend from the attaching device 1300 and then move on the blade to any position on the blade.

For example, when the at least one rope holding device 1200 was moved to a predetermined position along with the at least one attaching device 1300 at step S1501, step S1503 comprises a step of moving the at least one rope holding device 1200 from the predetermined position to any position. For example, at step S1503, the at least one rope holding device 1200 is moved from the predetermined position to any position as shown in FIGS. 11F to 11G.

For example, any position on a blade can be a position at the tip of the blade. Alternatively, any position on a blade can be a position suitable for starting pulling up the maintenance device 1100 to the blade 1011. Alternatively, for example, any position on a blade can be a position in concert with the position of the maintenance device 1100. For example, the position in concert with the position of the maintenance device 1100 can be a position above the maintenance device 1100.

Step S1504 is a step of holding at least one rope in a position on the blade 1011 by the at least one rope holding device 1200. The position on the blade is a position to which the at least one rope holding device 1200 was moved at step S1503. The at least one rope held on the blade 1011 is a rope which extends from the at least one attaching device 1300 to the at least one rope holding device 1200.

For example, as shown in FIGS. 11F to 11G, as a result of moving the at least one rope holding device 1200 to any position on the blade 1011 (e.g., the tip of the blade 1011), the at least one rope received by the at least one rope holding device 1200 is held on the blade 1011. When at least two ropes are held on the blade 1011, a first rope group comprising at least one rope would extend from a first side of the blade while a second rope group comprising at least one rope would extend from a second side of the blade as shown in FIG. 13 as the at least two ropes held on the blade 1011.

Step S1505 is a step of connecting the at least one rope held on the blade 1011 by the at least one rope holding device 1200 at step S1504 to the maintenance device 1100. For example, the at least one rope is connected to the maintenance device 1100 by connecting the at least one rope to a winch of the maintenance device 1100.

For example, step S1505 can be manually performed by a worker on the deck 1016.

At step S1506, the maintenance device 1100 is moved to the blade 1011 on the at least one rope held by the at least one rope holding device 1200 in a state where the at least one rope holding device 1200 holds the at least one rope on the blade 1011. For example, the maintenance device 1100 is moved to the blade 1011 as shown in FIGS. 11G to 11I. The maintenance device 1100 can move to the blade along the at least one rope held by the at least one rope holding device 1200.

When the maintenance device 1100 is moved to the blade 1011 at step S1506, the position of the at least one rope holding device 1200 may be controlled so that the spatial position of the maintenance device 1100 of when the maintenance device 1100 moves to the blade 1011 on the at least one rope and the position of the at least one rope holding device 1200 are in concert with each other. This control can be dynamic control. For example, the at least one rope holding device 1200 is moved on the blade so that the position of the at least one rope holding device 1200 on the blade would be approximately right above the maintenance device 1100, and the position in which the at least one rope holding device 1200 holds at least one rope on the blade 1011 can be controlled. As a result, the at least one rope would vertically extend from the at least one rope holding device 1200 on the blade 1011 to the maintenance device 1100, and the maintenance device 1100 can move to the blade 1011 without the need for controlling the posture or spatial position of the maintenance device or without horizontally swinging. Furthermore, horizontal movement of the maintenance device 1100 can also be guided by moving the at least one rope holding device 1200 on the blade 1011 while utilizing the natural movement of the maintenance device 1100 to be approximately right below the at least one rope holding device 1200 by the action of gravity. This can eliminate or reduce the need for controlling the spatial position of the maintenance device 1100 by a worker from the deck 1016 or the like, which leads to reduced manpower.

Step S1507 is a step of moving the maintenance device 1100 on the blade 1011 after the maintenance device 1100 moves to the blade 1011. In this case, the maintenance device 1100 is moved on the blade 1011 in any manner.

For example, the maintenance device 1100 can be moved on the blade 1011 along the at least one rope 1020 extending from the attaching device 1300 as shown in FIGS. 11I and 11J. In another example, the maintenance device 1100 can be moved on the blade 1011 by utilizing a driving wheel that the maintenance device 1100 can comprise. In another example, the maintenance device 1100 can be moved on the blade 1011 by utilizing a different rope from the at least one rope 1020 extending from the attaching device 1300.

In doing so, the maintenance device 1100 can fixedly attach to the blade 1011 via any attaching means. This enables the maintenance device 1100 to move on the leading edge of the blade 1011 without floating up. Further, since the leading edge of the blade 1011 is inclined by about 5 degrees relative to the vertical direction, the gravity exerted on the maintenance device 1100 acts so as to push the maintenance device 1100 against the leading edge of the blade 1011, thereby preventing the maintenance device 1100 from floating up. For example, step S1507 may be performed in response to transmission of a control signal to the maintenance device 1100 by a worker using a terminal for operation, or may be performed in response to transmission of a control signal to the maintenance device 1100 by a robot. Alternatively, the maintenance device 1100 may be configured to autonomously perform step S1507.

The step of moving the maintenance device 1100 at step S1507 may comprise: moving the maintenance device 1100 on the blade 1011 in a first direction of the directions in which the at least one rope extends; and moving the maintenance device 1100 on the blade 1011 in a second direction of the directions in which the at least one rope extends. For example, the first direction is a direction from the tip of the blade to the root of the blade while the second direction is a direction from the root of the blade to the tip of the blade. The maintenance device 1100 can move in the first direction or the second direction by controlling the winding or delivery by a winch.

Step S1508 is a step of performing maintenance on the blade during movement of the maintenance device 1100 on the blade. For example, as shown in FIG. 11J, the maintenance device 1100 performs maintenance on the blade 1011 during movement of the maintenance device 1100 on the leading edge of the blade 1011. In doing so, the maintenance device 1100 fixedly attaches to the blade 1011 via any attaching means. This enables the maintenance device 1100 to push a maintenance means such as a washing means or polishing means against the leading edge of the blade 1011 without floating up. Further, since the leading edge of the blade 1011 is inclined by about 5 degrees relative to the vertical direction, the gravity exerted on the maintenance device 1100 acts so as to push the maintenance device 1100 against the leading edge of the blade 1011, thereby preventing the maintenance device 1100 from floating up. For example, step S1508 may be performed in response to transmission of a control signal to the maintenance device 1100 by a worker using a terminal for operation, or may be performed in response to transmission of a control signal to the maintenance device 1100 by a robot. Alternatively, the maintenance device 1100 may be configured to autonomously perform step S1508.

After performing maintenance at step S1508, the procedure 1500 may comprise a step of retrieving the system of the present invention. For example, the retrieving step comprises a step of retrieving the maintenance device 1100 from the blade 1011 by moving the maintenance device 1100 from the blade 1011 on the at least one rope. This is, for example, moving the maintenance device 1100 from the blade 1011 to the deck 1016 as shown in FIGS. 11L to 11N.

In doing so, the position of the at least one rope holding device 1200 may be controlled so that the spatial position of the maintenance device 1100 of when the maintenance device 1100 moves from the blade 1011 on the at least one rope and the position of the at least one rope holding device 1200 are in concert with each other. This control can be dynamic control. For example, the at least one rope holding device 1200 is moved on the blade so that the position of the at least one rope holding device 1200 on the blade would be approximately right above the maintenance device 1100, and the position in which the at least one rope holding device 1200 holds at least one rope on the blade 1011 can be controlled. As a result, the at least one rope would vertically extend from the at least one rope holding device 1200 on the blade 1011 to the maintenance device 1100, and the maintenance device 1100 can move from the blade 1011 (to, for example, the deck 1016) without the need for controlling the posture or spatial position of the maintenance device or without horizontally swinging. Furthermore, horizontal movement of the maintenance device 1100 can also be guided by moving the at least one rope holding device 1200 on the blade 1011 while utilizing the natural movement of the maintenance device 1100 to be approximately right below the at least one rope holding device 1200 by the action of gravity. This can eliminate or reduce the need for controlling the spatial position of the maintenance device 1100 by a worker from the deck 1016 or the like, which leads to reduced manpower.

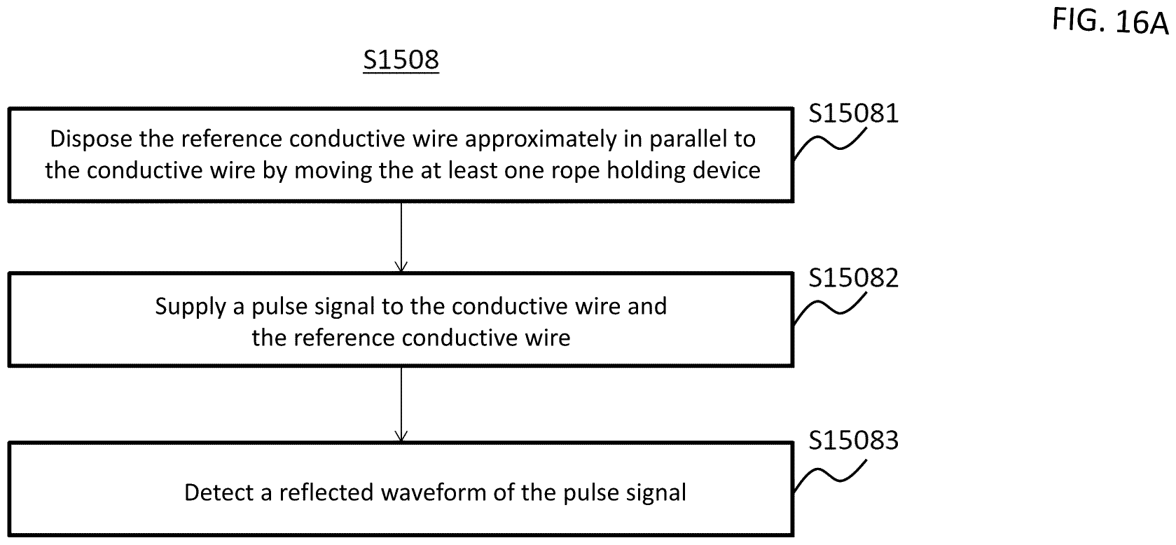

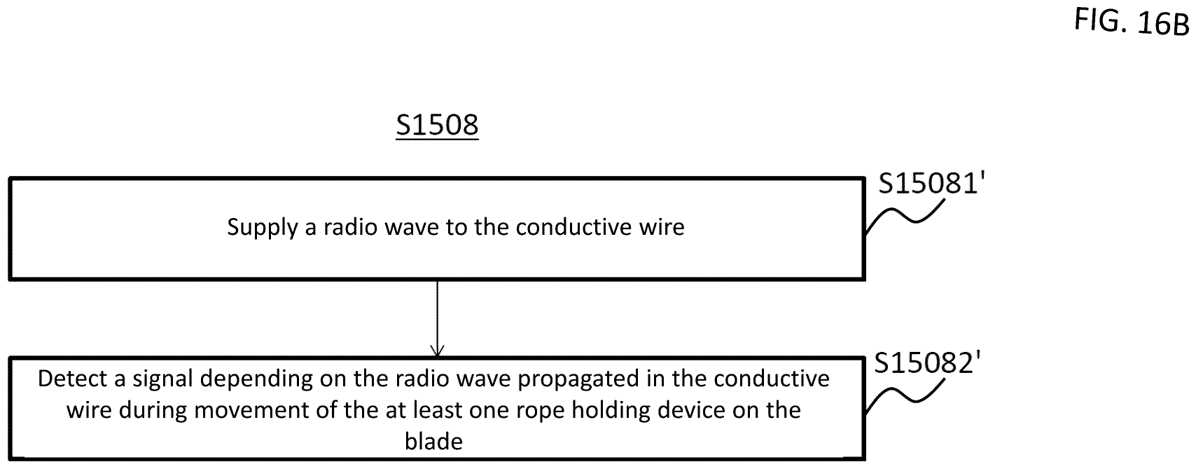

FIG. 16A shows one example of a specific flow which is performed in a step of performing maintenance on a blade at step S1508. The flow shown in FIG. 16A is a flow for the maintenance device 1100 to examine disconnection of a conductive wire (down conductor) extending inside a blade in cooperation with the rope holding device 1200, wherein disconnection examination based on a reflected pulse from the conductive wire is performed. It is assumed that the rope holding device 1200 comprises a reference conductive wire which is utilized for the disconnection examination. One end portion of the reference conductive wire is coupled to the rope holding device 1200 while the other end portion is coupled to the attaching device 1300, whereby the reference conductive wire extends between the rope holding device 1200 and the attaching device 1300.

Step S15081 is a step of disposing the reference conductive wire approximately in parallel to the conductive wire extending inside the blade by moving the at least one rope holding device 1200. Since one end portion of the reference conductive wire is coupled to the rope holding device 1200 while the other end portion is coupled to the at least one attaching device 1300, the reference conductive wire can be disposed on the blade by moving the at least one rope holding device 1200 to be away from the at least one attaching device 1300 on the blade. In doing so, the at least one attaching device 1300 is preferably attached onto the blade because the conductive wire disposed on the blade would be along the blade. Furthermore, the reference conductive wire disposed on the blade becomes approximately parallel to the conductive wire extending inside the blade by making the moving direction of the at least one rope holding device 1200 approximately parallel to the extending direction of the conductive wire extending inside the blade.

In general, the conductive wire (down conductor) extending inside the blade extends in a direction from a lightning receiving portion (receptor) at the tip of the blade of a wind turbine to the root, which is consistent with the moving direction of the rope holding device 1200 of the system of the present invention. Thus, it is not necessary to separately design and/or control the movement of the rope holding device 1200 to perform disconnection examination.

The at least one rope holding device 1200 preferably moves to the lightening receiving portion of the blade 1011 because it can align the lightening receiving portion of the blade 1011 and the end of the reference conductive wire.

Next, the maintenance device 1100 moves to the position of the lightening receiving portion of the blade 1011 and the end of the reference conductive wire, and the maintenance device 1100 supplies a pulse signal to the conductive wire and the reference conductive wire via the lightening receiving portion at step S15082.

At step S15083, the maintenance device detects a reflected waveform of the pulse signal supplied at step S15082. The presence or absence of disconnection and further a disconnected portion can be detected based on the detected reflected waveform. This can be achieved by analyzing a reflected waveform obtained from the conductive wire, with a reflected waveform obtained from the reference conductive wire (conductive wire which is not disconnected) as a reference. For example, the presence or absence of disconnection and further a disconnected portion can be identified by using TDR (Time Domain Reflectometry) method.

Identifying a disconnected portion in the conductive wire inside the blade enables the disconnected portion to be promptly repaired.

FIG. 16B shows another example of a specific flow which is performed in a step of performing maintenance on a blade at step S1508. The flow shown in FIG. 16A is a flow for the maintenance device 1100 to examine disconnection of a conductive wire (down conductor) extending inside a blade in cooperation with the rope holding device 1200, wherein disconnection examination based on a signal depending on a radio wave propagated in the conductive wire is performed.

Step S15081′ is a step wherein the maintenance device 1100 supplies a radio wave for examining disconnection of the conductive wire to the conductive wire. The maintenance device 1100 can supply a radio wave to the conductive wire via the lightning receiving portion. For example, the maintenance device 1100 may be configured to supply a radio wave generated by a transmitter that the maintenance device 1100 comprises to the conductive wire, or may be configured to supply a radio wave transmitted from the outside of the maintenance device 1100 (e.g., a transmitter on the deck 1016) to the conductive wire. Preferably, the maintenance device 1100 can supply a radio wave transmitted from the outside of the maintenance device 1100 (e.g., a transmitter on the deck 1016) to the conductive wire because it eliminates the need for the maintenance device 1100 to comprise a transmitter, which can prevent the weight of the maintenance device 1100 from increasing.

Step S15082′ is a step of detecting a signal depending on the radio wave propagated in the conductive wire during movement of the at least one rope holding device 1200 on the blade 1011. The at least one rope holding device 1200 can detect a signal depending on the radio wave by using a detector.

For example, the at least one rope holding device 1200 detects a signal in a place along the blade during movement along the blade 1011 from the tip to the root of the blade 1011. For example, the detected signal is recorded or monitored, and it can be determined that there is disconnection in a place in which a specific signal (e.g., no signal is detected, or a signal level is weak, or the like) was detected.

In general, the conductive wire (down conductor) extending inside the blade extends in a direction from a lightning receiving portion (receptor) at the tip of the blade of a wind turbine to the root, which is consistent with the moving direction of the rope holding device 1200 of the system of the present invention. Thus, in this disconnection examination as well, it is not necessary to separately design and/or control the movement of the rope holding device 1200 to perform disconnection examination.

The at least one attaching device 1300 is preferably attached onto the blade in this disconnection examination as well because the at least one rope holding device 1200 can move along the blade and along the conductive wire present inside the blade and the detector can be brought as close as possible to the conductive wire, which can improve the detection accuracy.

Such disconnection examination can detect the presence or absence of disconnection of the conductive wire and further a disconnected portion. Identifying a disconnected portion in the conductive wire inside the blade enables the disconnected portion to be promptly repaired.

As described above, each step of the method for performing maintenance on a blade of a wind turbine may be initiatively performed by a worker, or may be automatically performed by a robot. When each step is performed by a robot, a worker does not need to be in a work site, which enables maintenance on a blade of a wind turbine to be safely performed. This is particularly significant in a place without a sufficient scaffold such as a wind turbine on the sea.

As used herein, “during movement” refers to a period of moving from one position to another position. It is not necessarily required to keep moving. For example, a period during which the maintenance device 100 moves from the tip of a blade to the base of the blade and the maintenance device 100 moves by repeating advancing and stopping is also included in “during movement”.

Although a system and method for performing maintenance on a blade of a wind turbine were explained in the examples explained while referring to FIGS. 1 to 16B, the present invention is not limited thereto. The subject of maintenance by the system and method of the present invention can be at least a part of any object on which maintenance needs to be performed and which has a surface on which a rope can be held, wherein a maintenance device can be moved by utilizing the held rope. For example, the subject of maintenance may be the whole or a part of such an object. In the above-described examples, any object is a wind turbine and at least a part of any object is a blade of the wind turbine. For example, any object may be a building and at least a part of any object may be a wall surface of the building, and any object may be a plane and at least a part of any object may be a main wing of the plane. For example, in the case of a wall surface of a building, it is necessary to wash dirt due to rain. For example, in the case of a main wing of a plane, it is necessary to inspect and wash the wing in order to keep the surface of the wing smooth. For example, a rope is held on a rooftop or wall surface of a building and a maintenance device can move to the rooftop or wall surface of the building by utilizing the held rope. For example, a rope is held on a main wing or body of a plane and a maintenance device can move to the main wing or body by utilizing the held rope.

Although the movement of a maintenance utilizing a rope is movement with vertical movement (i.e., rising and going down) in the above-described examples, movement of a maintenance utilizing a rope may be movement without vertical movement. Movement of a maintenance utilizing a rope can also include movement only with movement on a horizontal plane. This is because, even in the case of movement only with movement on a horizontal plane, a rope holding device, which is lighter than a maintenance device and whose spatial position is easily controlled, can be disposed on a subject of maintenance in advance and the maintenance device can be moved to the subject of maintenance along a rope held by the rope holding device, thereby achieving easy maintenance. Further, even in the case of movement only with movement on a horizontal plane, an attaching device can be attached to a subject of maintenance in advance, a rope can be held on the subject of maintenance by a rope holding device, and the maintenance device can be moved to the subject of maintenance along the rope held by the rope holding device, thereby achieving easy maintenance. This is particularly useful for maintenance on a subject which is present in a place without a sufficient scaffold because a rope can be easily attached to the subject by utilizing an attaching device and a rope holding device even in a place without a sufficient scaffold.

Any object that is the subject of maintenance is preferably an object in a high place. A high place in this case refers to a place in a height that a worker on the ground cannot reach. A high place may be, for example, a place about 3 m or more high from the ground, a place about 5 m or more high from the ground, a place about 10 m or more high from the ground, or a place about 100 m or more high from the ground. A high place may be, for example, a place about 3 m to about 100 m high from the ground, a place about 5 m to about 100 m high from the ground, or a place about 10 m to about 100 m high from the ground. It should be noted that the ground may be an outdoor place, or may be an indoor place.

Further, although the surface on which the maintenance device 100, 100′, or 1100 attaches to at least a part of any object has any angle, the surface on which the maintenance device 100, 100′, or 1100 attaches to at least a part of any object is preferably inclined relative to the vertical direction. This is because, in addition to the holding force by an attaching means, the gravity exerted on the maintenance device 100, 100′, or 1100 acts so as to push the device 100, 100′, or 1100 against at least a part of the object due to attachment of the maintenance device 100, 100′, or 1100 to the inclined surface, and the maintenance device 100, 100′, or 1100 is thereby more stable on at least a part of the object.

Further, although a device for performing maintenance on at least a part of an object was explained in the examples explained while referring to FIGS. 1 to 16B, the present invention is not limited thereto. The system of the present invention may be a robot having a function to achieve any objective comprising performing maintenance. For example, any objective may be an objective to carry goods to a high place. It is possible to make it easy to carry goods to a high place by attaching a device mounted with goods to an object in a high place (e.g., an outer wall of a balcony of an apartment). For example, any objective may be an objective to decorate an object. It is possible to easily decorate an object in a high place by attaching a device with decoration to the object in a high place.

As used herein, an element of which number is not particularly mentioned or an element given an article corresponding to “a” or “the” in English is intended to express “at least one” element unless otherwise specified.

The present invention is not limited to the above-described embodiments. It is understood that the scope of the present invention should be interpreted only by the Claims. It is understood that those skilled in the art can practice an equivalent scope based on the descriptions of the present invention and common general knowledge from the descriptions of specific and preferable embodiments of the present invention. For example, at least one feature of the features explained in a first aspect can be incorporated into a second aspect. In the same manner, at least one feature of the features explained in the second aspect can be incorporated into the first aspect.

### INDUSTRIAL APPLICABILITY

The present invention is useful for providing a system and method for safely and easily performing maintenance on at least a part of an object.

### REFERENCE SIGNS LIST

10 and 1010 wind turbine
11, 12, 13, 1011, 1012, and 1013 blade
14 and 1014 nacelle
15 and 1015 hub
1016 deck
1017 tower
20 and 1020 rope
100, 100′, and 1100 maintenance device
110 moving means
120 a plurality of maintenance means
130 controlling means
140 mounting portion
200 and 1200 rope holding device
250 member
260 aperture
1300 attaching device
1400 moving device

1-35. (canceled)

36. A maintenance device for performing maintenance on at least a part of an object, the maintenance device comprising:
a moving means for moving on the at least a part of the object;
a plurality of maintenance means configured to perform mutually different maintenances, the plurality of maintenance means being mounted on a mounting portion; and
a controlling means which selects at least one maintenance means of the plurality of maintenance means and controls the plurality of maintenance means so that maintenance by the selected at least one maintenance means is executed.

37. The maintenance device of claim 36, wherein the mounting portion is configured to be rotatable around an axis, and
wherein the controlling means changes a position of the plurality of maintenance means by rotating the mounting portion around the axis.

38. The maintenance device of claim 36, wherein the mounting portion is configured to be translatable in a predetermined direction, and
wherein the controlling means changes a position of the plurality of maintenance means by translating the mounting portion.

39. The maintenance device of claim 36, wherein one of the plurality of maintenance means is an applying means for applying a material.

40. The maintenance device of claim 39, wherein one of the plurality of maintenance means is a flattening means, the flattening means comprising a spatula for flattening a material applied by the applying means and an abutting portion for abutting on the at least a part of the object to separate the spatula from the at least a part of the object.

41. The maintenance device of claim 40, wherein the flattening means further comprises a wire net for cleaning the spatula.

42. The maintenance device of claim 39, wherein the applying means comprises a caulking gun for ejecting a material, the caulking gun being configured so that an ejected amount of the material is adjusted by intermittent control of air pressure and/or control by an electropneumatic regulator.

43. The maintenance device of claim 39, wherein the applying means is configured to stick a sheet or a film on the at least a part of the object.

44. The maintenance device of claim 36, wherein one of the plurality of maintenance means is a grinding means for grinding a surface of the at least a part of the object.

45. The maintenance device of claim 44, wherein the grinding means comprises a leutor.

46. The maintenance device of claim 45, wherein the leutor is configured to be pushed against the surface so that a rotational axis of the leutor is perpendicular to the surface.

47. The maintenance device of claim 44, wherein the grinding means comprises a belt sander, the belt sander being configured so that a moving direction of a grinding surface of the belt sander is inclined relative to a direction in which the surface extends and the belt sander is pushed against the surface.

48. The maintenance device of claim 36, wherein the plurality of maintenance means are configured to:
grind a surface of the at least a part of the object;
wash the grinded surface;
apply a material to the washed surface;
flatten at least a part of the applied material;
cure the flattened material;
grind the cured material;
wash the grinded material; and
paint the washed material.

49. The maintenance device of claim 36, wherein the mounting portion comprises a mounting body with a rotational axis, a plurality of attaching portions on the mounting body, a translation mechanism, and a rotation mechanism, each of the plurality of maintenance means is attached to respective attaching portions of the plurality of attaching portions, the mounting body is connected to the rotation mechanism at the rotational axis, the rotation mechanism is configured to rotate the mounting body about the rotational axis, and the translation mechanism is configured to translate the mounting body along with the rotational axis in a predetermined direction,
wherein the controlling means controls the rotation mechanism to rotate the mounting body and controls the translation mechanism to translate the mounting body, such that the selected at least one maintenance means of the plurality of maintenance means approaches a site requiring maintenance.

50. The maintenance device of claim 49, wherein the predetermined direction comprises up and down, from side to side, and back and forward directions.
